(19) United States
(12) Patent Application Publication
(10) Pub. No.: US 2022/0353732 A1
(43) Pub. Date: Nov. 3, 2022

(54) EDGE COMPUTING TECHNOLOGIES FOR TRANSPORT LAYER CONGESTION CONTROL AND POINT-OF-PRESENCE OPTIMIZATIONS BASED ON EXTENDED INADVANCE QUALITY OF SERVICE NOTIFICATIONS

(71) Applicant: Intel Corporation, Santa Clara, CA (US)

(72) Inventors: Miltiadis FILIPPOU, Muenchen (DE); Dario SABELLA, Gassino Torinese (IT); Giovanni NARDINI, Pisa (IT); Giovanni STEA, Pisa (IT); Antonio VIRDIS, Pisa (IT); Leonardo GOMES BALTAR, Muenchen (DE)

(21) Appl. No.: 17/638,337

(22) PCT Filed: Sep. 25, 2020
(86) PCT No.: PCT/US2020/052888

§ 371 Date: Feb. 25, 2022

Related U.S. Application Data
(60) Provisional application No. 63/047,752, filed on Jul. 2, 2020.
(60) Provisional application No. 62/911,048, filed on Oct. 4, 2019.

(51) Int. Cl. H04W 28/02

(52) U.S. Cl. CPC H04W 28/0289; H04W 28/0236; H04W 28/0273; H04W 28/0284

(57) ABSTRACT

Disclosed embodiments provide edge computing mechanisms for network congestion identification and control, and for providing predicted QoS notifications. The network congestion control embodiments enable context-aware, location-aware, radio network information-aware congestion event identification and control at the transmitter/sender device, which provides a new category of congestion control algorithms exploiting the aforementioned information via edge computing services, where an edge computing framework acts as broker. The predicted QoS notifications include predictions of radio signal quality and conditions as well as predicted edge or cloud computation resources. Other embodiments may be described and/or claimed.

### CROSS REFERENCE TO RELATED APPLICATIONS

The present application claims priority to U.S. Provisional App. No. 62/911,048 filed on Oct. 4, 2019 and U.S. Provisional App. No. 63/047,752 filed on Jul. 2, 2020, the contents of each of which is incorporated by reference in their entireties.

### TECHNICAL FIELD

Embodiments described herein generally relate to edge computing, network communication, and communication system implementations, and in particular, to techniques for implementing Vehicle-to-Everything (V2X) communications in Multi-access Edge Computing (MEC) systems and networks.

### BACKGROUND

Internet of Things (IoT) devices are physical or virtualized objects that may communicate on a network, and may include sensors, actuators, and other input/output components, such as to collect data or perform actions from a real world environment. For example, IoT devices may include low-powered devices that are embedded or attached to everyday things, such as buildings, vehicles, packages, etc., to provide an additional level of artificial sensory perception of those things. Recently, IoT devices have become more popular and thus applications using these devices have proliferated. The deployment of IoT devices and Multi-access Edge Computing (MEC) services have introduced a number of advanced use cases and scenarios occurring at or otherwise involving the edge of the network.

Edge computing, at a general level, refers to the implementation, coordination, and use of computing and resources at locations closer to the “edge” or collection of “edges” of the network. The purpose of this arrangement is to improve total cost of ownership, reduce application and network latency, reduce network backhaul traffic and associated energy consumption, improve service capabilities, and improve compliance with security or data privacy requirements (especially as compared to conventional cloud computing). Components that can perform edge computing operations (“edge nodes”) can reside in whatever location needed by the system architecture or ad hoc service (e.g., in an high performance compute data center or cloud installation; a designated edge node server, an enterprise server, a roadside server, a telecom central office; or a local or peer at-the-edge device being served consuming edge services).

Applications that have been adapted for edge computing include but are not limited to virtualization of traditional network functions (e.g., to operate telecommunications or Internet services) and the introduction of next-generation features and services (e.g., to support 5G network services). Use-cases which are projected to extensively utilize edge computing include connected self-driving cars, surveillance, Internet of Things (IoT) device data analytics, video encoding and analytics, location aware services, device sensing in Smart Cities, among many other network and compute intensive services.

Edge computing may, in some scenarios, offer or host a cloud-like distributed service, to offer orchestration and management for applications and coordinated service instances among many types of storage and compute resources. Edge computing is also expected to be closely integrated with existing use cases and technology developed for IoT and Fog/distributed networking configurations, as endpoint devices, clients, and gateways attempt to access network resources and applications at locations closer to the edge of the network.

### BRIEF DESCRIPTION OF THE DRAWINGS

In the drawings, which are not necessarily drawn to scale, like numerals may describe similar components in different views. Like numerals having different letter suffixes may represent different instances of similar components. Some embodiments are illustrated by way of example, and not limitation, in the figures of the accompanying drawings in which:

FIGS. 1A and 1B depict an example V2X communication system utilizing MEC technology providing support for V2X applications, according to various embodiments.

FIG. 2 depicts an example V2X system including a MEC system architecture according to various embodiments.

FIG. 3 depicts an example architecture enabling communication between the V2X Information Service (VIS) and a V2X Control Function, according to various embodiments.

FIG. 4A depicts an example V2X procedure according to various embodiments. FIG. 4B illustrates a resource Universal Resource Indicator (URI) structure of the VIS API according to various embodiments.

FIG. 5 illustrates an example NetAssist architecture.

FIG. 6 illustrates example interactions between a server side Transport Protocol Runtime (TPR) entity and an edge computing service, according to various embodiments.

FIG. 7 shows an example congestion window scenario according to various embodiments.

FIG. 8 shows an example of a first TPR embodiment.

FIG. 9 shows an example of a second TPR embodiment.

FIG. 10 illustrates an example query/response procedure according to various embodiments.

FIG. 11 illustrates an example subscribe/notify procedure according to various embodiments.

FIG. 12 depicts an exemplary V2X system scenario where a MEC host is co-located with a network access node (NAN) providing V2X communication services to vehicular user equipment (UEs), according to various embodiments.

FIG. 13 depicts an example of high-definition (HD) map data collection, consolidation, and distribution according to various embodiments.

FIG. 14A depicts an example C-V2X application supported by predictive QoS. FIG. 14B depicts an example structure of a generic In-advance QoS Notification.

FIG. 15 depicts another exemplary scenario for practicing the embodiments herein.

FIG. 16 depicts an example interactions points among various entities for producing and consuming e-IQNs, according to various embodiments.

FIGS. 17, 18, 19, and 21 depict respective procedures for practicing aspects of the embodiments herein.

FIG. 20 depicts federation management reference point Mfm-fed connecting a MEC system's MEO with a Federation Manager.

FIG. 22 illustrates an overview of an edge cloud configuration for edge computing.

FIG. 23 illustrates operational layers among endpoints, an edge cloud, and cloud computing environments.

FIG. 24 illustrates an example approach for networking and services in an edge computing system.

FIG. 25 illustrates an example MEC system reference architecture.

FIG. 26 illustrates a MEC reference architecture in a Network Function Virtualization (NFV) environment, deployable from an example edge computing system.

FIGS. 27A, 27B, and 27C depict examples of edge computing hardware configurations.

FIGS. 28 and 29 depict example components of various compute nodes in edge computing system(s).

FIG. 30 depicts an example mobile computing device in an edge computing system.

FIG. 31 depicts an example of a configurable server rack in an edge computing system.

### DETAILED DESCRIPTION

The following embodiments generally relate to data processing, service management, resource allocation, compute management, network communication, application partitioning, and communication system implementations, and in particular, to techniques and configurations for adapting various edge computing devices and entities to dynamically support multiple entities (e.g., multiple tenants, users, stakeholders, service instances, applications, etc.) in a distributed edge computing environment.

The operation and control of vehicles is becoming more autonomous over time, and most vehicles will likely become fully autonomous in the future. Vehicles that include some form of autonomy or otherwise assist a human operator may be referred to as “computer-assisted or autonomous driving” vehicles. Computer-assisted or autonomous driving (CA/AD) vehicles may include Artificial Intelligence (AI), machine learning (ML), and/or other like self-learning systems to enable autonomous operation. Typically, these systems perceive their environment (e.g., using sensor data) and perform various actions to maximize the likelihood of successful vehicle operation.

The Vehicle-to-Everything (V2X) applications (referred to simply as “V2X”) include the following types of communications Vehicle-to-Vehicle (V2V), Vehicle-to-Infrastructure (V2I) and/or Infrastructure-to-Vehicle (I2V), Vehicle-to-Network (V2N) and/or network-to-vehicle (N2V), Vehicle-to-Pedestrian communications (V2P), and ITS station (ITS-S) to ITS-S communication (X2X). V2X applications can use co-operative awareness to provide more intelligent services for end-users. This means that entities, such as vehicle stations or vehicle user equipment (vUEs) including such as CA/AD vehicles, roadside infrastructure or roadside units (RSUs), application servers, and pedestrian devices (e.g., smartphones, tablets, etc.), collect knowledge of their local environment (e.g., information received from other vehicles or sensor equipment in proximity) to process and share that knowledge in order to provide more intelligent services, such as cooperative perception, maneuver coordination, and the like, which are used for collision warning systems, autonomous driving, and/or the like.

One such V2X application include Intelligent Transport Systems (ITS), which are systems to support transportation of goods and humans with information and communication technologies in order to efficiently and safely use the transport infrastructure and transport means (e.g., automobiles, trains, aircraft, watercraft, etc.). Elements of ITS are standardized in various standardization organizations, both on an international level and on regional levels.

Communications in ITS (ITSC) may utilize a variety of existing and new access technologies (or radio access technologies (RAT)) and ITS applications. Examples of these V2X RATs include Institute of Electrical and Electronics Engineers (IEEE) RATs and Third Generation Partnership (3GPP) RATs. The IEEE V2X RATs include, for example, Wireless Access in Vehicular Environments (WAVE), Dedicated Short Range Communication (DSRC), Intelligent Transport Systems in the 5 GHz frequency band (ITS-G5), the IEEE 802.11p protocol (which is the layer 1 (L1) and layer 2 (L2) part of WAVE, DSRC, and ITS-G5), and sometimes the IEEE 802.16 protocol referred to as Worldwide Interoperability for Microwave Access (WiMAX). The term “DSRC” refers to vehicular communications in the 5.9 GHz frequency band that is generally used in the United States, while “ITS-G5” refers to vehicular communications in the 5.9 GHz frequency band in Europe. Since the present embodiments are applicable to any number of different RATs (including IEEE 802.11p-based RATs) that may be used in any geographic or political region, the terms “DSRC” (used, among other regions, in the U.S.) and “ITS-G5” (used, among other regions, in Europe) may be used interchangeably throughout this disclosure. The 3GPP V2X RATs include, for example, cellular V2X (C-V2X) using Long Term Evolution (LTE) technologies (sometimes referred to as “LTE-V2X”) and/or using Fifth Generation (5G) technologies (sometimes referred to as “5G-V2X” or “NR-V2X”). Other RATs may be used for ITS and/or V2X applications such as RATs using UHF and VHF frequencies, Global System for Mobile Communications (GSM), and/or other wireless communication technologies.

Disclosed embodiments are related to techniques for implementing Vehicle-to-Everything (V2X) communications in Edge Computing systems/networks, such as Multi-access Edge Computing (MEC) systems. V2X system scenarios characterized by high mobility and dynamic topologies, where the accuracy and timeliness of radio network information, location information may be hampered by environmental conditions and deployment density of network infrastructure and/or density of vehicular stations.

Embodiments herein enhance predicted QoS notifications by also including predictions of edge cloud computation resources. This cross-domain set of information is proposed to be called enhanced In-advance QoS Notification (e-IQN) information, exploitable by multiple system actors, such as vehicles (e.g., V2X applications), car OEMs and MEC service providers. Embodiments also include a signaling framework ensuring that QoS predictions are accessible by Edge (e.g., MEC) automotive service providers in an interoperable manner, exploiting a V2X API. The embodiments also include a scheme for MEC PoPs optimization, taking as input predictive QoS information, involving Edge Orchestrators (e.g., MEC Orchestrators (MEOs)) across a geographical area. Other embodiments may be described and/or claimed.

### 1. MEC V2X Information Services (VIS)

The Vehicle-to-Everything (V2X) applications (referred to simply as “V2X”) include the following four types of communications Vehicle-to-Vehicle (V2V), Vehicle-to-Infrastructure (V2I); Vehicle-to-Network (V2N), and Vehicle-to-Pedestrian communications (V2P). V2X applications can use co-operative awareness to provide more intelligent services for end-users. This means that entities, such as vehicle stations or vehicle user equipment (vUEs), roadside infrastructure or roadside units (RSUs), application servers, and pedestrian devices (e.g., smartphones, tablets, etc.), collect knowledge of their local environment (e.g., information received from other vehicles or sensor equipment in proximity) to process and share that knowledge in order to provide more intelligent services, such as cooperative perception, maneuver coordination, and the like, which are used for collision warning systems, autonomous driving, and/or the like. V2X applications utilize an underlying access technology or radio access technology (RAT) to convey messages for co-operative awareness. These RATs may include, for example, IEEE 802.11p based protocols such as DSRC and ITS-G5, 3GPP cellular-based protocols such as 5G-V2X and/or LTE-V2X protocols. Although the embodiments herein are discussed in the context of automotive vehicles, the embodiments may also apply to other types of vehicles including, aircraft, watercraft, and/or the like.

Multi-access Edge Computing (MEC) is a technology that allows applications to be instantiated at the edge of an access network, and provides a low-latency and a close proximity environment to user equipment (UEs). As a result, vertical industries, such as the automotive industry, are expected to significantly benefit from the deployment of MEC infrastructure together with the deployment of Radio Access Networks (RANs). These RANs may be operated by different MNOs and/or operate different RATs.

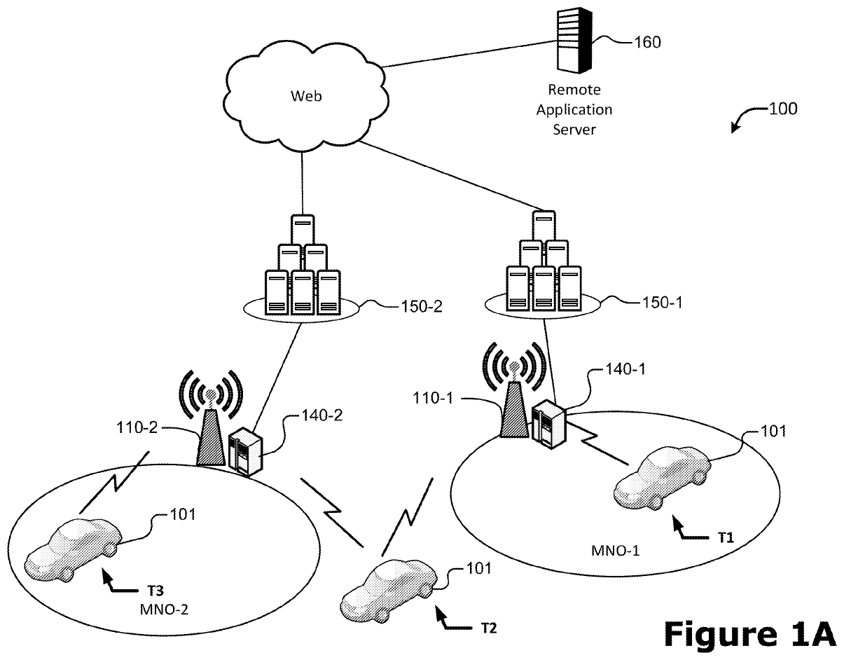

Wireless communication is a key enabling technology of co-operative intelligent transportation systems (ITS). Road users (e.g., vehicles, cyclists, and pedestrians) involved in V2X communication may use services provided by different operators providing different networks and/or using different Radio Access Technologies (RATs). Environments that include networks provided by different operations and that include different RATs are referred to as “multi-vendor, multi-network, and multi-access environments.” Examples of multi-vendor, multi-network, and multi-access environments are shown by FIGS. 1A and 1B.

FIG. 1A depicts an example V2X communication system 100 utilizing MEC technology providing support for V2X applications. Specifically, FIG. 1A depicts a V2X communication system 100 involving the use of a MEC system, where a Road Operator (or an ITS operator) is aiming at offering V2X services in a cross-country, cross-operator, cross-vendor environment. The MEC system supports and/or provides various services to endpoint devices (e.g., vehicle ITS stations (V-ITS-Ss) 101 in FIG. 1A), each of which may have different requirements or constraints. For example, some services may have priority or Quality of Service (QoS) constraints (e.g., traffic data for autonomous V-ITS-Ss 101 may have a higher priority than infotainment data), reliability and resiliency (e.g., traffic data may require mission-critical reliability, while infotainment data may be allowed some error variance), as well as power, cooling, and form-factor constraints. A variety of interfaces are used by a UE application (app) to request the MEC system to run an app (e.g., MEC app) in the MEC system, or to move an app in or out of the MEC system. Such interfaces include, for example, the Mp3 reference point used for internal MEC management, used for control communication between MEC platforms, and the Mx2 reference point used for external access.

In the typical multi-operator scenario, multiple operators (e.g., MNO-1 and MNO-2 in FIG. 1A) provide infrastructure to enable network connectivity for V-ITS-Ss 101 (also referred to as “vehicle stations,” “vehicle user equipment” or “vUEs”) including for example, Network Access Node (NAN) 110-1 and core network 150-1 provided by MNO-1 and NAN 110-2 and core network 150-2 provided by MNO-2. An “operator” refers to an entity or organization that owns or controls infrastructure equipment (including radio infrastructure, core network and/or back haul infrastructure, and the like) necessary to provide communications and/or network-related services, including radio spectrum allocation including one or more radio spectrum licenses from a regulatory agency, billing and subscription-related services, device provisioning, and/or other like services. An operator provides technical capabilities to access a mobile network or wireless environment using an Over-the-Air (OTA) or wireless communication channel. The term “operator” as used herein may be considered synonymous to and/or referred to as a network operator, mobile network operator (MNO), cellular network operator, wireless service provider, wireless carrier, mobile network carrier, virtual MNO, and/or the like.

Furthermore, the NANs 110-1 and 110-2 may be macro cell base stations, small and/or micro cell base stations, access points (APs), and/or other like network elements. The APs may be, for example, wireless routers, roadside ITS stations (R-ITS-Ss) or roadside units, gateway appliances, central hubs, and/or the like. The base stations may be, for example, 3GPP Long Term Evolution (LTE) evolved NodeBs (eNBs), 3GPP 5G/NR next generation eNBs (ng-eNBs) and/or next generation NodeBs (gNBs), and/or the like. A collection of NANs 110 may be referred to as an “access level edge network” or “access level edge.” The NANs 110 are configurable or operable to perform setup of transport resources, (e.g., for CDN services and/or other application level services) as well as scheduling signaling resources for providing network service of the underlying access network/RAT.

In the example of FIG. 1A, NAN 110-1 is co-located with an edge compute node 140-1 and NAN 110-2 is co-located with an edge compute node 140-2. In one example, the edge servers 140 or edge compute nodes 140 may be Multi-access Edge Computing (MEC) hosts or any other edge compute node, such as those discussed herein. The MEC hosts 140 are entities that contain a MEC platform and a virtualization infrastructure to provide compute, storage and network resources to MEC apps. A MEC platform is a collection of functionality (including hardware and software elements) that is required to run MEC apps on a specific MEC host's 140 virtualization infrastructure and to enable them to provide and consume MEC services, and that can provide itself a number of MEC services. MEC apps are applications that can be instantiated on a MEC host 140 within the MEC system 100 and can potentially provide or consume MEC services, and MEC services are services provided via a MEC platform either by the MEC platform itself or by a MEC app. The MEC hosts 140 may be provided by MNO-1 and MNO-2, respectively, or the MEC hosts 140 may be provided by a separate edge networking service provider. In this example, the V-ITS-S 101 at T1 is able to receive network connectivity from MNO-1 via the NAN 110-1 and core network 150-1, and is able to receive services from the remote application server 160 via the MNO-1 infrastructure. As the V-ITS-S 101 travels, a temporary absence of radio coverage is experienced by V-ITS-S 101 at T2 resulting in a roaming situation, and is then able to receive service via the MNO-2 infrastructure (e.g., the NAN 110-2 and core network 150-2). The core networks 150 may be, for example, LTE or 5G/NR core networks.

In a first implementation, the NANs 110 are RSUs or R-ITS-Ss. In a second implementation, the NANs 110 are RANs or a base stations/RAN nodes (e.g., eNB, ng-eNB, gNB, or the like) within a RAN.

In a third implementation, the NANs 110 include gNB-Central Unit (CUs) or ng-eNB-CUs (see e.g., 3GPP TS 38.401 v16.1.0 (2020-03)). The CUs may be implemented as a Base Band Unit (BBU), Radio Equipment Controller (REC), Radio Cloud Center (RCC), centralized RAN (C-RAN), virtualized RAN (vRAN), and/or the like (although these terms may refer to different implementation concepts). In this implementation, the gNB-CUs or ng-eNB-CUs is communicatively coupled with one or more gNB-Distributed Units (DUs) and/or one or more ng-eNB-DUs, and each DU may be communicatively coupled with one or more Radio Units (RUs) (also referred to as Remote Radio Heads (RRHs), Remote Radio Units (RRUs), or the like). In some implementations, the one or more RUs may be RSUs.

In a fourth implementation, the NANs 110 are one or more DUs and/or one or more RUs in a CU/DU/RU split architecture, and the gNB-CUs and/or ng-eNB-CUs are provided by (e.g., virtualized) by the edge compute nodes 140 co-located with (or communicatively coupled with) the NANs 110 (including the aforementioned CUs, DUs, and RUs). In one example, the edge compute nodes 140 may be Multi-access Edge Computing (MEC) hosts or any other edge compute node, such as those discussed herein. In these implementations, the edge compute nodes 140 may operate or include the aforementioned CUs, or may provide management applications/services separate from the CUs.

In a fifth implementation, the management applications/services are virtualized entities provided by a cloud computing service and/or one or more cloud compute nodes (collectively referred to as a “cloud” or the like). In one example, the CUs may run within virtual machine(s) (VMs) and/or software container(s) that are provided by the cloud's virtualization infrastructure. In this implementation, the cloud may operate or include the aforementioned CU, or may provide management applications/services separate from the CU. Additionally or alternatively, the cloud may operate a virtualized network switch (e.g., Open vSwitch or the like), to provide such services.

In a sixth implementations, the management applications/services are service(s) provided by one or more network functions (NFs) in a cellular core network such as a 5G core network (5GC) or the like. In this implementation, one or more existing NFs may provide the management applications/services, or a new NF may be defined to provide the management applications/services.

In a seventh implementation, the management applications/services is a service provided by an individual or new NF in a cellular core network, in a data network, or the like.

In an eighth implementation, the management applications/services is a specified or selected V-ITS-S 101 (e.g., a “master” ITS-S, a cluster or platoon leader, etc.), which is authorized to negotiate on behalf of the other ITS-Ss 101, and/or the like.

In many of the aforementioned implementations, the management applications/services is communicatively coupled with multiple RSUs, multiple base stations, and/or the like where the service area (e.g., the areas labeled MON-1 and MNO-2 in FIG. 1A) encompasses the some or all of the cells or service areas of each of the multiple RSUs and/or base stations.

One challenging situation is when ITS operators attempt to provide the same or continuous V2X service to V-ITS-Ss 101 connected to different operators (e.g., MNO-1 and MNO-2) even in temporary absence of radio coverage. This use case is also complicated by the presence of multiple MEC vendors, which leads to the need to enable communication between different MEC systems. This use case is further complicated when UE apps have relatively high QoS constraints. Furthermore, the allocation of sufficient radio resources within a cell coverage area of a NAN 110 does not necessarily guarantee a particular QoS (or QoS performance) in V2X communications. Poor QoS performance is also linked to poor signal reception due to lack of coverage, signal interference, inefficient handover mechanisms, and inadequate transmission power management and handover mechanisms at the NANs 110.

As shown by FIG. 1B, in a traditional V2X system (without VIS service) the interconnection between MNOs (e.g., MNO-1 and MNO-2) is terminated at the remote side (e.g., remote application server 160), with clear disadvantages in terms of high end-to-end (e2e) latency. On the other hand, exploitation of the VIS service, which enables a “horizontal communication” over interconnection 188 between MEC systems 140, the interconnection between MNOs can be realized with low e2e latency. VIS exposes information on PC5 configuration parameters along with information related to the Uu interface (e.g., unicast and Multimedia Broadcast Multicast Service (MBMS)), and manages multi-operator environments, which allows V-ITS-Ss 101 leaving the coverage area of one MNO-1 and entering the coverage area of another MNO-2 to continue to receive service without any service disruption and guaranteeing e2e performance.

V2X applications and services include, for example, safety apps/services, convenience apps/services, advanced driving assistance apps/services, and vulnerable road user (VRU) apps/services, among many others. Examples of the safety apps/services include Intersection Movement Assist (IMA) and Queue Warning (QW). IMA is designed to avoid intersection crossing crashes by warning drivers of vehicles approaching from a lateral direction at an intersection. Intersection crashes include intersection, intersection-related, driveway/alley, and driveway access related crashes. QW queue of vehicles on the road may pose a potential danger and cause delay of traffic (e.g., when a turning queue extends to other lanes). Using the V2X services, the queue information can be made available to other V-ITS-Ss 101 beforehand, which minimizes the likelihood of crashes and allows for mitigation actions.

Convenience apps/services include, for example, telematics, software updates, infotainment, and the like. Some of these apps/services can be implemented with existing access technology and are partly already supported by some car manufacturers. This group of V2X use cases requires cost effective communication to be enabled between the V-ITS-Ss 101 and backend servers/services.

Advanced driving assistance apps/services (also referred to as “advanced driver-assistance systems” or “ADAS”) are electronic systems (comprising hardware and software elements) that help a vehicle driver while driving or parking a vehicle, and typically employ various microcontrollers, electronic control units (ECUs), sensors, and/or power semiconductor devices/systems (collectively referred to herein as “driving control units” or “DCUs”) implemented in the vehicle. collect the most challenging requirements for V2X. These apps/services are also applicable to autonomous driving apps/services. These V2X apps/services can require distribution of a relative large amount of data with high reliability and low latency in parallel, and usually benefit from predictive reliability. This means that V-ITS-Ss 101 utilizing ADAS should have the possibility to receive a prediction of the network availability and/or QoS to plan ahead. Real time situational awareness is essential for autonomous vehicles especially at critical road segments in cases of changing road conditions (e.g., new objects/obstructions detected by another vehicle some time ago, changing weather and/or environmental conditions, and the like). For this and other purposes, the relevant high definition (local) maps need to be made available via downloading from a backend server/service (e.g., remote application server 160). The use case for real time situational awareness and High Definition (Local) Maps should not only be seen as a case to distribute information on relatively slow changing road conditions. The case should be extended to distribute and aggregate locally available information in real time to the traffic participants via road side units. Another ADAS app/service is See-Through (or High Definition Sensor Sharing). In this type of use cases vehicles such as trucks, minivans, cars, etc., in platoons are required to share sensor data such as images/video of road conditions ahead of them to vehicles behind them.

Additionally, ADAS and/or autonomous driving apps/services may involve the use of artificial intelligence (AI) agents and/or machine learning (ML) models operable to observe environmental conditions and determine actions to be taken in furtherance of a particular goal. The particular environmental conditions to be observed and the actions to take may be based on an operational design domain (ODD). An ODD includes the operating conditions under which a given AI agent/ML model or feature thereof is specifically designed to function. An ODD may include operational restrictions, such as environmental, geographical, and time-of-day restrictions, and/or the requisite presence or absence of certain traffic or roadway characteristics. In embodiments, individual AI agents and/or trained ML models/algorithms are configurable or operable to control respective control systems/DCUs of a host V-ITS-S 101. In these embodiments, the actions to be taken and the particular goals to be achieved may be specific or individualized based on the control system itself and/or DCUs involved. Additionally, some of the actions or goals may be dynamic driving tasks (DDT), object and event detection and response (OEDR) tasks, or other non-vehicle operation related tasks depending on the particular context in which an AI agent and/or trained ML models/algorithms is implemented. DDTs include all real-time operational and tactical functions required to operate a V-ITS-S 101 in on-road traffic, excluding the strategic functions (e.g., trip scheduling and selection of destinations and waypoints. DDTs include tactical and operational tasks such as lateral vehicle motion control via steering (operational); longitudinal vehicle motion control via acceleration and deceleration (operational); monitoring the driving environment via object and event detection, recognition, classification, and response preparation (operational and tactical); object and event response execution (operational and tactical); maneuver planning (tactical); and enhancing conspicuity via lighting, signaling and gesturing, etc. (tactical). OEDR tasks may be subtasks of DDTs that include monitoring the driving environment (e.g., detecting, recognizing, and classifying objects and events and preparing to respond as needed) and executing an appropriate response to such objects and events, for example, as needed to complete the DDT or fallback task. Some of these features may be triggered by the AI agent/ML model involved, or may be triggered by an external entity such as the remote application server 160 and/or MEC host(s) 140. The events/triggers may be AI agent/ML model specific, and may vary depending on the particular embodiment.

VRUs are non-motorized road users as well as users of VRU vehicles. A “VRU device” refers to a portable device used by a VRU integrating a standard ITS station (e.g. smartphone, tablets, wearables, etc.), although the term “VRU” by itself may refer to both a VRU and a VRU device. VRU-related V2X apps/services utilize information provided by VRUs for the purpose of traffic safety (e.g., collision avoidance, etc.) These apps/services usually require high accuracy of positioning information provided by these traffic participants. Additional means to use available information for better and reliable accuracy is crucial to allow a real-world usage of information shared from VRUs. Cooperation between vehicles and VRUs through their VRU devices is an important key element to improve traffic safety and to avoid accidents.

For these V2X apps/services the edge compute nodes 140 (or MEC hosts 140) provide feedback information from the network to the V-ITS-S 101 in support of V2X functions/apps/services, predicting whether a communication channel is currently reliable or not (e.g., in terms of latency requirements, packet arrival rates, QoS for data service/connectivity, and/or the like). The MEC system 100 also provides interoperability by supporting V2X information exchange among V-ITS-Ss 101 and/or other road users (e.g., VRUs, etc.) connected through different station/equipment types/platforms, access technologies, networks, or MNOs, and enabling multi-operator operation for V2X apps/services and/or individual V-ITS-Ss 101 to provide service continuity across access network coverage areas nationwide and across borders of different MNO networks. The MEC system 100 (or individual MEC hosts 140) may need to provide timely accurate positioning assisted by available positioning technologies including radio network functions, and/or predictive quality related information to the vehicle when the various connectivity parameters (like Latency, PER, signal-strength, etc.) are going to change.

The edge compute nodes 140 (e.g., MEC hosts 140) include a V2X Information Service (VIS) Application Programming Interface (API), which is designed to facilitate V2X interoperability in multi-vendor, multi-network, and multi-access environments for automotive use cases. These use cases may involve different vehicle manufacturers, Original Equipment Manufacturer (OEM) suppliers, network infrastructure vendors, MEC vendors, application/content providers, and other stakeholders.

MNOs are typically region specific or country specific, and provide services directly to their own customers (subscribers) while providing communications to other MNOs' customers at the core network level using interworking between the MNOs' networks. Each MNO operates its own Public Land Mobile Network (PLMN), which is often referred to as a home PLMN (HPLMN) from the perspective of a particular MNO's subscribers or a visiting PLMN (VPLMN) from the perspective of users that are not subscribers of the particular MNO. For vehicular applications, maintaining V2X service continuity (often with low latency requirement) for road users becomes challenging, especially when such road users move from one MNO's coverage area to another MNO's coverage area.

Mobile network level interworking among different PLMNs is used to enable service continuity in such use cases as specified in 3GPP specifications, such as ETSI GS MEC 003 v2.1.1 (2019-01) (“[MEC003]”), ETSI GS MEC 011 V1.1.1 (2017-07) (“[MEC011]”), ETSI GS MEC 013 v1.1.1 (2017-07) (“[MEC013]”), ETSI GS MEC 014 V1.1.1 (2018-02) (“[MEC014]”), and ETSI GS MEC 015 V1.1.1 (2017-10) (“[MEC015]”). Furthermore, inter-MEC system coordination is also required to prepare UEs in transit (e.g., based on the agreements among MNOs, roaming, and/or handover to a new PLMN) and reduce interruption time.

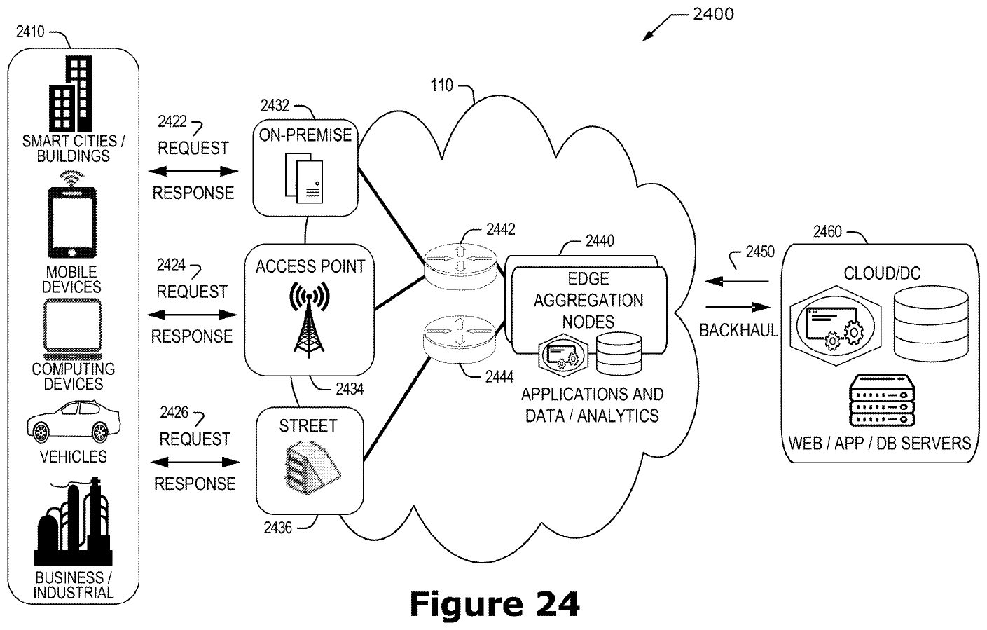

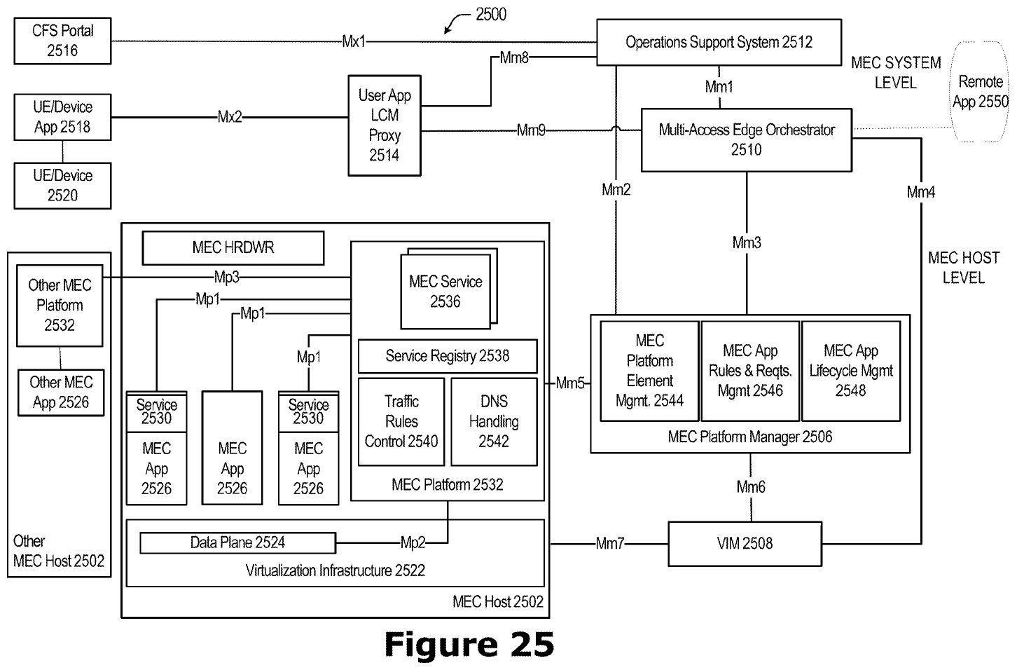

The service consumers communicate with the VIS 280 over the V2X API to get the necessary V2X service provisioning information for the visiting PLMN in support of inter-PLMN service continuity. Both MEC applications (apps) and MEC platforms may consume the VIS 280; and both MEC platforms and the MEC apps may be the providers of the V2X information. The V2X API may also be referred to as the “VIS API” or the like. MEC apps and MEC platforms are discussed in more detail infra with respect to FIGS. 25 and 26.

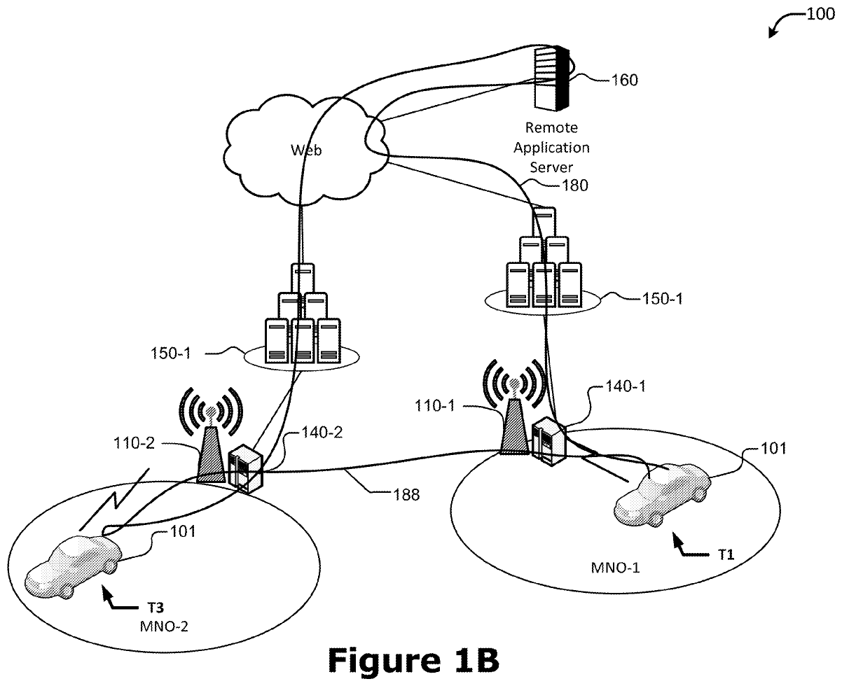

FIG. 2 illustrates an example MEC system architecture 200 for providing V2X, according to various embodiments. The MEC system 200 includes each of the multiple MEC hosts 240 (including MEC host 240-1 and MEC host 240-2), each of which may correspond to the MEC hosts 2502 in the MEC system 2500 of FIG. 25. As mentioned previously, MEC offers application developers and content providers cloud-computing capabilities and an IT service environment at the edge of the network. This environment is characterized by ultra-low latency and high bandwidth as well as real-time access to radio network information that can be leveraged by applications. MEC technology permits to flexible and rapid deployment of innovative applications and services towards mobile subscribers, enterprises and vertical segments. In particular, regarding the automotive sector, applications such as V2X applications need to exchange data, provide data to aggregation points and access to data in databases which provide an overview of the local situation derived from a multitude of sensors (by various cars, roadside units, etc.)

The V2X system 200 involves multiple MEC hosts 240 and the use of the MEC VIS 280. The V-ITS-S 201, NANs 210 (including NAN 210-1 and NAN 210-2 edge compute nodes 240, and remote cloud 260 may correspond to the V-ITS-S(s) 101, NANs 110, and MEC hosts 140 of FIGS. 1A and 1B, respectively. Each of the edge compute nodes 240 and NAN 210 pairs may make up a respective edge cloud, and the remote cloud 260 may include one or more remote application servers (e.g., remote application server 160 of FIGS. 1A and 1B).

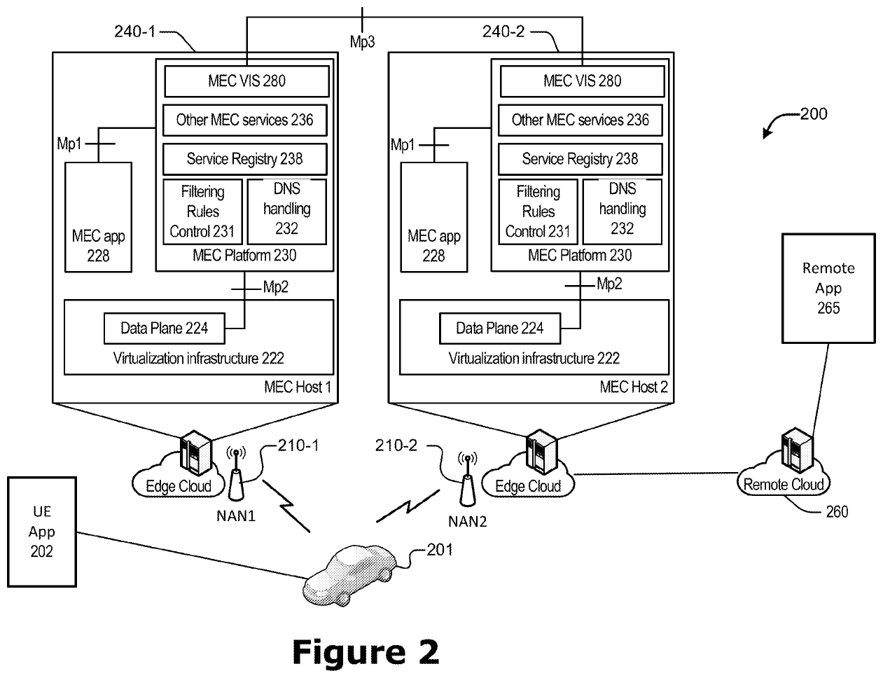

In various embodiments, the MEC system 200 (and individual MEC hosts 240) may support the feature V2Xservice. When the MEC system 200 supports the feature V2XService, the MEC system 200 includes the capability to provide feedback information from the network (e.g., the MNO networks in FIGS. 1A-1B and/or the edge clouds in FIG. 2) to the V-ITS-S 201 in support of V2X functions, which helps with predicting whether a communication channel is currently reliable or not (e.g. in terms of fulfilling latency requirements and/or a threshold packet arrival). The MEC system 200 supporting V2XService includes the capability to provide quality related information from the network to the vehicle about when the various connectivity parameters (like Latency, PER, signal-strength, etc.) are going to change. The MEC system 200 supporting V2XService includes the capability to provide interoperability by supporting V2X information exchange among road users connected through different access technologies, networks, and/or MNOs. The MEC system 200 supporting V2XService enables multi-operator operation for V2X stations/equipment to provide service continuity across access network coverage nationwide and across borders of different operators' networks. The MEC system 200 supporting V2XService includes the capability to provide interoperability in a multi-operator scenarios, enabling MEC apps in different systems to communicate securely with each other, in order to enable synchronization in multi-operator systems also in absence of cellular coverage (outside of 3GPP domain). The MEC system 200 supporting V2XService includes the capability to provide interoperability in multi-operator scenarios, enabling MEC apps to communicate securely with the V2X-related 3GPP core network logical functions (e.g., V2X control function 350 of FIG. 3 and/or other core network functions) and gathering PC5 V2X relevant information (e.g. PC5 configuration parameters) from the 3GPP network.

In the framework of V2X services, the V-ITS-S 201 is hosting a client app (UE app 202 in FIG. 2), and is connected to a certain MEC host 240 (and a related MEC app 228). In presence of multiple MEC hosts 240, the VIS 280 permits exposure of information between MEC apps 228 running on different MEC hosts 240. Each of the MEC hosts 240 can be owned/managed by a different operator or service provider (e.g., a MEC vendor or a third party). MEC apps 228 instantiated on MEC Host 240-1 and MEC Host 240-2 can be used to provide V2X-related services, and can be operated by the mobile services operator, by a MEC vendor, or by a third party (e.g., OEM, or OEM supplier, or system integrator). In addition, other remote application server instances can be located elsewhere, such as in remote cloud 260. Remote cloud 260 may be any type of cloud infrastructure, for example, one or more private clouds owned by an operator or by an OEM. The remote cloud 260 also operates one or more remote apps 265. The VIS 280 may be produced by the MEC platform 230 or by the MEC app 228.

In some aspects, the MEC platform 230 (corresponding to MEC platform 2532 and/or MEC Platform VNF 2602 of FIG. 26) can include a MEC V2X API that provides MEC VIS 280. The VIS 280/V2X API supports both queries and subscriptions (e.g., pub/sub mechanism) that are used over a Representational State Transfer (“REST” or “RESTful”) API or over alternative transports such as a message bus. For RESTful architectural style, HTTP protocol bindings may be defined for the VIS API. In particular, the VIS 280 permits information exposure, pertinent to the support of automotive use cases, to MEC app instances. The VIS 280 also permits a single ITS operator to offer V2X applications/services over a region that may span different countries and involve multiple network operators, MEC systems, and MEC app providers. For that purpose, the VIS 280 can include the following functionalities: (a) gathering of PC5 V2X relevant information from the 3GPP network for purposes of performing UE authorization for V2X communications (e.g., obtaining a list of V2X authorized UEs, obtaining relevant information about the authorization based on UE subscription, and obtaining V2X configuration parameters such as a common set of V2X configuration parameters which can include PC5 configuration parameters); (b) exposure of the information obtained in (a) to MEC apps 228 in the same MEC host 240 or MEC apps 228 in other MEC hosts 240; (c) enablement of MEC apps 228 to communicate securely with the V2X-related 3GPP core network logical functions (e.g., enabling communication between a MEC host 240 and a V2X control function in the core network); (d) enablement of MEC apps 228 in different MEC systems 240 to communicate securely with each other; and (e) gathering and processing information available in other MEC hosts/systems using suitable MEC APIs (e.g., gathering and processing information obtained via the V2X/VIS API (see e.g., ETSI GS MEC 030 v2.1.1 (2020-04) (hereinafter “[MEC030]”)), Radio Network Information (RNI) API (see e.g., ETSI GS MEC 012 V1.1.1 (2017-07) (“[MEC012]”)), Location API [MEC011], UE Identity (UE_ID) API [MEC014], Bandwidth Management (BWM) API [MEC015], WLAN Access Information (WAI) API (see e.g., ETSI GS MEC 028 V2.1.1 (2020-06) (“[MEC028]”), Fixed Access Information (FAI) API ETSI GS MEC 029 v2.1.1 (2019-07) (“[MEC029]”), and other like APIs for accessing other MEC services 236 that may be implemented within the MEC platform 230) in order to predict radio network congestion, and provide suitable notifications to the ITS-S 201. The service registry 238, filtering rules control 231, DNS handling 232, data plane 224, and virtualization infrastructure 222 are discussed in more detail infra with respect to FIGS. 25 and 26.

From that perspective, the VIS 280 is relevant to Mp1 and Mp3 reference points in the MEC architecture (see e.g., FIGS. 25 and 26). In particular, relevant information is exposed from various services 228 and 236 to MEC apps 228 via the Mp1 reference point. The Mp3 reference point enables the transfer of this information between different MEC platforms 230. For example, the second MEC host 240-2 can also implement a MEC V2X API, which can provide an interface to one or more of the MEC apps 228 instantiated within MEC host 240-2. In this regard, MEC host 240-2 and MEC host 240-1 can communicate with each other via the Mp3 interface as well as the MEC V2X APIs. Additionally, one or more of the apps 228 instantiated within MEC Host 240-1 can communicate with one or more of the MEC apps 228 instantiated within MEC Host 240-2 via the MEC V2X APIs as well as the interface between the MEC Host 240-1 and MEC Host 240-2.

The MEC VIS API provides information to MEC apps 228 in a standardized way, which provides interoperability in multi-vendor scenarios. Nevertheless, MEC apps 228 may communicate in a direct way (e.g., without the use of MEC platform 230). In some embodiments, inter-system communication may be realized between MEC Orchestrators (MEOs). Additionally or alternatively, possible Mp3 enhancements (or new reference points between MEC systems 240) may be defined for MEC app 228 communication.

The MEC V2X APIs (e.g., to expose VIS 280) can be provided as a general middleware service, providing information gathered from vehicles 201 and other V2X elements, and exposed as a service within the hosts (e.g., as a RESTful API) for the higher layers (e.g., the MEC apps 228 instantiated within the hosts). In some aspects, the MEC V2X APIs can be configured to gather information and data from various sensors. In this regard, the deployment of the MEC V2X APIs is ensuring continuity of the service across different mobile networks, for the same OEM (e.g., automobile manufacturer). If a standard implementation of a V2X API is introduced (e.g., by ETSI MEC), this functionality can ensure the same basic V2X service characteristics for all OEMs in a 5G communication system with MEC functionalities.

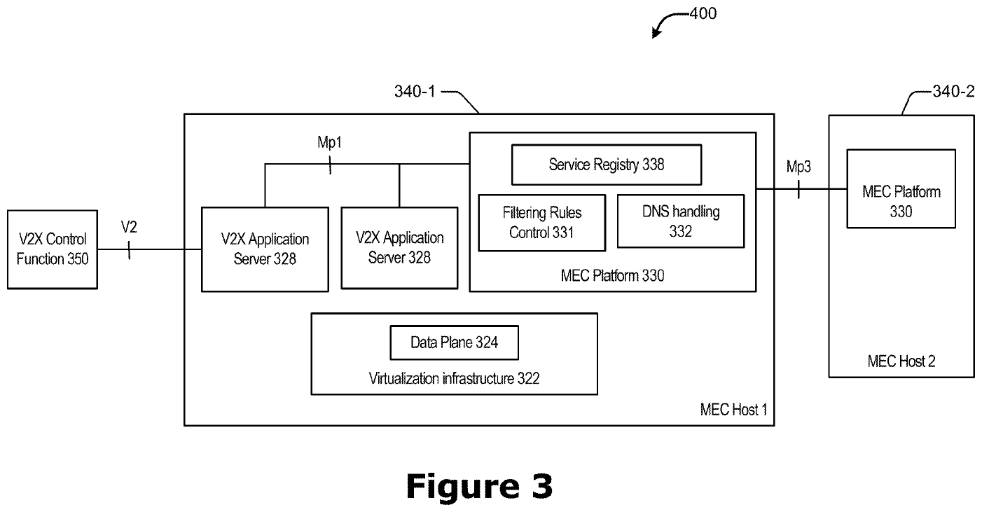

The VIS API/V2X API includes resources and operations. A “resource” is an object with a type, associated data, a set of methods that operate on it, and relationships to other resources if applicable. A resource is a fundamental concept in a RESTful API. Resources are acted upon by the RESTful API using HTTP methods (e.g. POST, GET, PUT, DELETE, etc.). Operations on Resources affect the state of the corresponding managed entities. Some procedures/operations of the VIS API are depicted by FIG. 4A.

FIG. 4A illustrates example V2X/VIS API procedure 400A, according to various embodiments. In the procedures of FIG. 4, a service consumer (e.g., a VIS consumer such as a MEC app or a MEC platform) sends a request for information of a particular V-ITS-S (e.g., V-ITS-Ss 101, 201, 1201, etc., discussed previously). In response to the request, a service provider, which is a VIS (e.g., VIS 280 of FIG. 2, VIS provided by V2X APIs discussed previously) generates a response including the requested information, and sends the response to the service consumer. The service consumer receives the response including the requested information from the VIS.

In procedure 400, where the service consumer requests the planned route information of a particular V-ITS-S. Procedure 400 is a scenario where, the service consumer (e.g., a V2X application, MEC app, etc.) sends a request to the VIS to receive predicted QoS corresponding to potential routes of a V-ITS-S, and receives a response containing the required/requested information (e.g., the predicted QoS information).

Procedure 400 begins at operation 401 where the service consumer (e.g., VIS consumer) sends a request message to the VIS, which is the service producer (or “VIS producer”). In this embodiment, the VIS is a resource representing the planned route information and/or predicted QoS for the relevant V-ITS-S. The (request) message body contains the data structure for the predicted QoS relevant to potential routes of the vehicular UE (discussed infra). The request message may be an HTTP POST message with the request line “POST ../provide_predicted_qos”. Here, the resource URI is “{apiRoot}/vis/v1/provide_predicted_qos”. In some embodiments, the request may also include a service consumer instance ID as an input parameter, which may be included in a message body of the request message.

At operation 402, the service producer (e.g., the VIS) responds with a response/reply message including a message body containing the predicted QoS information data structure (PredictedQoS). In this embodiment, the response message is an HTTP response message including the status code “200 OK” in the header of the HTTP message, which indicates that the service consumer's request succeeded. Additionally, the requested PredictedQoS is included in the body of the HTTP response message. In some embodiments, the response message may include a PredictedQoS IE, field, data field, data element, or the like to include the PredictedQoS data structure.

In this embodiment, the POST method is used to request the predicted QoS correspondent to potential routes of a V-ITS-S. This method supports the URI query parameters, request and response data structures, and response codes, as specified in Table A.

TABLE A
Data structures supported by the PredictedQoS POST request/response

| | Data type | Cardinality | Remarks | |
|---|---|---|---|---|
| Request | PredictedQos | 1 | Entity body in the request contains the predicted QoS as | |
| body | | | requested by the VIS consumer. | |
| | | | Response | |
| | Data type | Cardinality | Codes | Remarks |
| Response | PredictedQos | 1 | 200 OK | The response body contains the predicted QoS |
| body | | | | corresponding to potential routes of a vehicular |
| | | | | UE. |
| | ProblemDetails | 0 . . . 1 | 400 Bad | Used to indicate that incorrect parameters were |
| | | | Request | passed to the request. In the returned |
| | | | | ProblemDetails structure, the “detail” attribute |
| | | | | should convey more information about the |
| | | | | error. |
| | ProblemDetails | 0 . . . 1 | 401 | Used when the client did not submit |
| | | | Unauthorized | credentials. In the returned ProblemDetails |
| | | | | structure, the “detail” attribute should convey |
| | | | | more information about the error. |
| | ProblemDetails | 1 | 403 Forbidden | Indicates that the operation is not allowed given |
| | | | | the current status of the resource. More |
| | | | | information is to be provided in the “detail” |
| | | | | attribute of the “ProblemDetails” structure. |
| | ProblemDetails | 0 . . . 1 | 404 Not Found | Used when a client provided a URI that cannot |
| | | | | be mapped to a valid resource URI. In the |
| | | | | returned ProblemDetails structure, the “detail” |
| | | | | attribute should convey more information about |
| | | | | the error. |

The PredictedQos is a resource data type. The PredictedQos type represents the predicted QoS of a vehicular UE. This information is per UE potential route based. The attributes of the PredictedQos may follow the notations provided in Table 6.2.5-1x. The rsrp and rsrq attributes in Table 6.2.5-Tx, are only included in the response message. In other embodiments, the rsrp and rsrq attributes could also be included in the request message and the RSRP and RSRQ values contained therein could be used for journey-specific QoS predictions. As mentioned previously, other types of measurements could be additionally or alternatively included in the request or response messages in other embodiments.

In some embodiments, the time attribute may be included to indicate an actual time of visiting a particular location indicated by the LocationInfo, or a predicted time that the V-ITS-S is expected to visit the particular location. For example, the first routeInfo structure relating to the route origin may include an actual time that the V-ITS-S was at the route origin point, and the last routeInfo structure relating to the route destination point may be a predicted or expected time that the V-ITS-S is to arrive at the destination point. Intermediate routeInfo structures corresponding to waypoint locations can include actual times that the V-ITS-S visits those waypoint locations, predicted/expect times for arriving at the waypoint locations, or some combination thereof.

As mentioned previously, the PredictedQos is a resource data type. A resource is an object with a type, associated data, relationships to other resources, and a set of methods that operate on the resource. The above tables define the data types and attributes that can be used for each of the resource representations. A data type is a particular kind of data item defined by the values it can take and/or the operations that can be performed on it. As shown by the above tables, some of these attributes have simple data types where each data item can only store one value at a time (e.g., strings, unsigned integers (“Uint”), etc.), and structured data types where each data item is a collection of other data items. Some of the structured data types are defined by attributes listed in the same table (denoted as “Structured (inline)”). For example, in table 9 the routes attribute is a structured data type that includes one or more routeInfo attributes, and each routeInfo attribute includes location and time attributes, and rsrp and rsrq attributes if included in a response message. Some of the structured data types are common to each resource data type, such as the TimeStamp data type and the LocationInfo data type. The attributes of the TimeStamp data type and the LocationInfo data type may follow the notations provided in Table B and Table C, respectively.

TABLE B
Attributes of the TimeStamp

| Attribute | Data | | |
|---|---|---|---|
| name | type | Cardinality | Description |
| seconds | Uint32 | 1 | The seconds part of the time. |
| | | | Time is defined as Unix-time |
| | | | since Jan. 1, 1970, 00:00:00 UTC. |
| nanoSeconds | Uint32 | 1 | The nanoseconds part of the time. |
| | | | Time is defined as Unix-time |
| | | | since Jan. 1, 1970, 00:00:00 UTC. |

NOTE:
The data type of Uint32 is an unsigned integer of 32 bits

TABLE C
Attributes of the LocationInfo

| Attribute | Data | | |
|---|---|---|---|
| name | type | Cardinality | Description |
| ecgi | ECGI | 0 . . . 1 | E-UTRAN Cell Global Identifier |
| | | | of the serving cell. |
| ncgi | NCGI | 0 . . . 1 | 5G/NR Cell Global Identity of |
| | | | the serving cell. |
| geoArea | Structure | 0 . . . 1 | Information of a geographical |
| | (inlined) | | area. |
| >latitude | Float | 1 | Latitude (DATUM = |
| | | | WGS84) −90 to 90 in decimal |
| | | | degree format DDD.ddd |
| >longitude | Float | 1 | Longitude (DATUM = |
| | | | WGS84) −180 to 180 in decimal |
| | | | degree format DDD.ddd |

NOTE:
Either ecgi/ncgi or geoArea shall be present, but not both.

In Table C, the “ECGI” refers to an E-UTRAN Cell Global Identifier, which is used to identify cells globally. The ECGI is constructed from a Mobile Country Code (MCC), Mobile Network Code (MNC), and the E-UTRAN Cell Identifier (ECI). The “NCGI” refers to an NR/5G Cell Global Identifier, which is used to identify cells globally, although a gNB may include multiple NCGI's. The NCGI is a concatenation of the PLMN Identifier (PLMN-Id) and the 36 bit NR Cell Identity (NCI).

Each Hypertext Transfer Protocol (HTTP) message is either a request or a response. A server listens on a connection for a request, parses each message received, interprets the message semantics in relation to the identified request target, and responds to that request with one or more response messages. A client constructs request messages to communicate specific intentions, examines received responses to see if the intentions were carried out, and determines how to interpret the results. The target of an HTTP request is called a “resource.” Additionally or alternatively, a “resource” is an object with a type, associated data, a set of methods that operate on it, and relationships to other resources if applicable. Each resource is identified by at least one Uniform Resource Identifier (URI), and a resource URI identifies at most one resource. Resources are acted upon by the RESTful API using HTTP methods (e.g., POST, GET, PUT, DELETE, etc.). With every HTTP method, one resource URI is passed in the request to address one particular resource. Operations on resources affect the state of the corresponding managed entities.

Considering that a resource could be anything, and that the uniform interface provided by HTTP is similar to a window through which one can observe and act upon such a thing only through the communication of messages to some independent actor on the other side, an abstraction is needed to represent (“take the place of”) the current or desired state of that thing in our communications. That abstraction is called a representation. For the purposes of HTTP, a “representation” is information that is intended to reflect a past, current, or desired state of a given resource, in a format that can be readily communicated via the protocol. A representation comprises a set of representation metadata and a potentially unbounded stream of representation data. Additionally or alternatively, a resource representation is a serialization of a resource state in a particular content format.

An origin server might be provided with, or be capable of generating, multiple representations that are each intended to reflect the current state of a target resource. In such cases, some algorithm is used by the origin server to select one of those representations as most applicable to a given request, usually based on content negotiation. This “selected representation” is used to provide the data and metadata for evaluating conditional requests constructing the payload for response messages (e.g., 200 OK, 304 Not Modified responses to GET, and the like). A resource representation is included in the payload body of an HTTP request or response message. Whether a representation is required or not allowed in a request depends on the HTTP method used (see e.g., IETF RFC 7231 (2014-06)).

In procedure 400 of FIG. 4, when the request is unsuccessful, fails, or includes error(s), the HTTP response message may include other HTTP status codes, such as a bad request status code (400) (e.g., when incorrect parameters are passed in the request), a not found status code (404) (e.g., when a URI provided in the request cannot be mapped to a valid resource URI), a forbidden status code (403) (e.g., when the operation is not allowed given the current status of the resource), and/or other like HTTP status codes. In the aforementioned examples, the response body may include a ProblemDetails IE, field, data element, or other like data structure indicating/including information about the particular error. Other message formats may be used in other embodiments, and the request/response data may be located in the header or body portion of such messages.

FIG. 4B illustrates a resource Universal Resource Indicator (URI) structure 400B of the VIS API according to various embodiments. Table D provides an overview of the resources and the applicable HTTP methods defined by the VIS API. The VIS API supports additional application-related error information to be provided in the HTTP response when an error occurs (see e.g., clause 6.15 of ETSI GS MEC 009 V2.1.1 (2019-01) (“[MEC009]”)).

TABLE D
example VIS API Resources and Methods

| | | HTTP | |
|---|---|---|---|
| Resource name | Resource URI | method | Meaning |
| Uu unicast provisioning | /queries/uu_unicast_provisioning_info | GET | Retrieve provisioning |
| information | | | information required for V2X |
| | | | communication over Uu |
| | | | unicast. |
| Uu MBMS provisioning | /queries/uu_mbms_provisioning_info | GET | Retrieve provisioning |
| information | | | information required for V2X |
| | | | communication over Uu |
| | | | MBMS. |
| PC5 provisioning | /queries/pc5_provisioning_info | GET | Retrieve provisioning |
| information | | | information required for V2X |
| | | | communication over PC5. |
| provide predicted QoS | /provide_predicted_qos | POST | Provide predicted QoS based |
| task | | | on route information. |
| Publish V2X message | /publish_v2x_message | POST | Publish a V2X message to |
| task | | | VIS. |
| all subscriptions for a | /subscriptions | GET | Retrieve a list of active |
| subscriber | | | subscriptions for this |
| | | | subscriber. |
| | | POST | Create a new subscription. |
| existing subscription | /subscriptions/{subscriptionId} | GET | Retrieve information on |
| | | | current specific subscription. |
| | | PUT | Modify existing subscription |
| | | | by sending a new data |
| | | | structure. |
| | | DELETE | Cancel the existing |
| | | | subscription. |
| notification callback | Client provided callback reference | POST | Send a notification. |

The syntax of each resource URI follows [MEC009], as well as IETF RFC 3986 (2005-01) or IETF RFC 7320 (2014-07). In the RESTful MEC service APIs, including the VIS API, the resource URI structure for each API has the following structure:
{apiRoot}/{apiName}/{apiVersion}/{apiSpecificSuffixes}

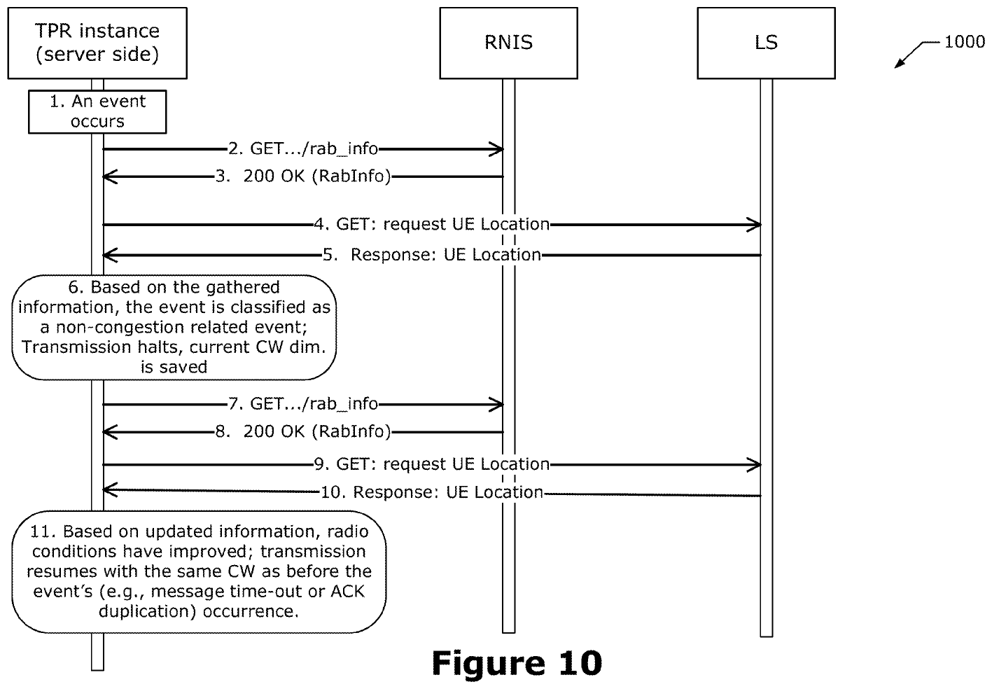

Here, “apiRoot” includes the scheme (“https”), host and optional port, and an optional prefix string. The “apiName” defines the name of the API (e.g., VIS/V2X API, RNI API, etc.). The “apiVersion” represents the version of the API, and the “apiSpecificSuffixes” define the tree of resource URIs in a particular API. The combination of “apiRoot”, “apiName” and “apiVersion” is called the root URI. The “apiRoot” is under control of the deployment, whereas the remaining parts of the URI are under control of the API specification. In the above root, “apiRoot” and “apiName” are discovered using the service registry 238. It includes the scheme (“http” or “https”), host and optional port, and an optional prefix string. For the VIS API, the “apiName” may be set to “vis” and “apiVersion” may be set to a suitable version number (e.g., “v1” for version 1). The MEC APIs support HTTP over TLS (also known as HTTPS). All resource URIs in the VIS procedures (see e.g., FIG. 11) are defined relative to the above root URI.

The JSON content format may also be supported. The JSON format is signaled by the content type “application/json”. The VIS API may use the OAuth 2.0 client credentials grant type with bearer tokens (see e.g., [MEC009]). The token endpoint can be discovered as part of the service availability query procedure defined in [MEC011]. The client credentials may be provisioned into the MEC app using known provisioning mechanisms.

In some embodiments, the MEC apps 228 in their respective MEC hosts 240 can use the corresponding MEC V2X APIs to retrieve information from the 3GPP network. In some embodiments, the MEC apps 228 in their respective MEC hosts 240 can be configured to host V2X configuration parameters such as PC5 configuration parameters (or a common set of V2X configuration parameters that can be available within a multi-PLMN communication environment). The availability of these V2X configuration parameters also in absence of network coverage is ensured by the usage of an Mp3 interface (or another type of interface) between the hosts. In some aspects, MEC app 228 in MEC host 240-1 can be configured to connect to MEC Host 240-2 (through V2X MEC API in MEC Host 240-2), and MEC app 228 in MEC host 240-2 can be configured to connect to MEC Host 240-1 (through V2X MEC API in MEC Host 240-1). In case of a multi-operator architecture, multiple MEC hosts 240 can be configured to communicate with each other via the MEC V2X APIs and synchronize in order to transfer the relevant V2X configuration parameters, so that they can be available across the multi-operator architecture in absence of cellular coverage (e.g., outside of the 3GPP domain). In this way, a UE (e.g., V-ITS-S 201) can have access to V2X configuration parameters even when the UE is not under coverage of its 3GPP network.

In some embodiments, one or more MEC apps 228 within a MEC host 240 can be instantiated to perform functionalities of a V2X application function, which may include providing VIS 280. Additionally, MEC hosts 240 can use MEC V2X APIs to perform various V2X or VIS 280 functions. In particular, one or more MEC apps 228 can be instantiated within a MEC host 240 to perform functionalities associated with a V2X application function, as is shown by FIG. 3. These MEC apps 228 can be configured to perform one or more of the following V2X application functions: obtaining V2X subscription information for a V-ITS-S 201, determining whether the V-ITS-S 201 is authorized to perform V2X communications in response to a request for V2X services, communicating V2X configuration parameters such as a common set of V2X configuration parameters, and so forth.

In various embodiments, individual vUEs 201 provide radio information to one or more MEC Hosts 240 in response to a trigger event and/or on a periodic basis. In some embodiments, individual vUEs 201 report radio information either at a low periodicity or a high periodicity depending on a data transfer that is to take place, and/or other information about the data transfer. The radio information may be in the form of one or more measurement reports, and/or may include, for example, signal strength measurements, signal quality measurements, and/or the like. Each measurement report is tagged with a timestamp and the location of the measurement (e.g., the vUE's 201 current location). As examples, the measurements collected by the vUEs and/or included in the measurement reports may include one or more of the following: bandwidth (BW), network or cell load, latency, jitter, round trip time (RTT), number of interrupts, out-of-order delivery of data packets, transmission power, bit error rate, bit error ratio (BER), Block Error Rate (BLER), packet loss rate, packet reception rate (PRR), e2e delay, signal-to-noise ratio (SNR), signal-to-noise and interference ratio (SINR), signal-plus-noise-plus-distortion to noise-plus-distortion (SINAD) ratio, carrier-to-interference plus noise ratio (CINR), Additive White Gaussian Noise (AWGN), energy per bit to noise power density ratio (Eb/NO), energy per bit to interference power density ratio (Ec/IO), peak-to-average power ratio (PAPR), Reference Signal Received Power (RSRP), Received Signal Strength Indicator (RSSI), Reference Signal Received Quality (RSRQ), GNSS timing of cell frames for UE positioning for E-UTRAN or 5G/NR (e.g., a timing between an AP or RAN node reference time and a GNSS-specific reference time for a given GNSS), GNSS code measurements (e.g., The GNSS code phase (integer and fractional parts) of the spreading code of the i^{th} GNSS satellite signal), GNSS carrier phase measurements (e.g., the number of carrier-phase cycles (integer and fractional parts) of the i^{th} GNSS satellite signal, measured since locking onto the signal; also called Accumulated Delta Range (ADR)), channel interference measurement, thermal noise power measurement, received interference power measurement, and/or other like measurements. The RSRP, RSSI, and/or RSRQ measurements may include RSRP, RSSI, and/or RSRQ measurements of cell-specific reference signals, channel state information reference signals (CSI-RS), and/or synchronization signals (SS) or SS blocks for 3GPP networks (e.g., LTE or 5G/NR) and RSRP, RSSI, and/or RSRQ measurements of various beacon, Fast Initial Link Setup (FILS) discovery frames, or probe response frames for IEEE 802.11 WLAN/WiFi networks. Other measurements may be additionally or alternatively used, such as those discussed in 3GPP TS 36.214 v15.3.0 (2018 Sep. 27) (“[TS36214]”), 3GPP TS 38.215 v15.4.0 (2019 Jan. 11) (“[TS38215]”), IEEE 802.11, Part 11: “Wireless LAN Medium Access Control (MAC) and Physical Layer (PHY) specifications, IEEE Std.” (“[IEEE80211]”), and/or the like. Additionally or alternatively, any of the aforementioned measurements (or combination of measurements) may be collected by one or more NANs and provided to the MEC Host. In these embodiments, the MEC Host may request the measurements from the NANs at low or high periodicity, or the NANs may provide the measurements to the MEC Host at low or high periodicity. Additionally or alternatively, the MEC host may obtain other relevant data from other MEC Hosts, core network functions, and/or other vUEs, for determining the QoS predictions and/or generating the composite information. For example, other Key Performance Indicators (KPIs) may be collected from other MEC hosts via suitable MEC APIs and/or from core network functions via network exposure functions, and used for predicting the QoS along the planned route and/or generating composite information (discussed infra). Additionally or alternatively, the vUEs may obtain the other relevant information, and provide this information to the MEC Host with the measurement reports or separately from the measurement reports.

FIG. 3 shows an example architecture 300 enabling communication between the VIS (e.g., VIS 280 of FIG. 2) and the V2X Control Function 350. In this example, the VIS is deployed in the MEC platform 322 of MEC host 340-1 and/or MEC host 340-2. In a 3GPP network, V2X applications can be deployed on one or more V2X Application Servers (V2X AS) 328. In 3GPP-V2X, there are two modes of operation for V2X communication, namely over the PC5 interface and over the LTE/5G Uu interface. The Uu interface can be unicast and/or MBMS. These two operation modes may be used by a UE (e.g., V-ITS-Ss 101 and 201 in FIGS. 1A, 1B, and 2) independently for transmission and reception. For example, a UE can use MBMS for reception without using the Uu interface for transmission. The UE may also receive V2X messages via the Uu interface unicast DL.

The V2X AS 328 may receive UL data from one or more UEs over unicast, and deliver data to the UE(s) in a target area using Unicast Delivery and/or MBMS Delivery. The V2X AS 328 may map from geographic location information to appropriate target MBMS SAI(s) for broadcast, map from geographic location information to appropriate target 3GPP identities such as E-UTRAN Cell Global Identifier(s) (ECGI) and/or NR Cell Global Identifier(s) (NCGI) for the broadcast; and map from UE provided ECGI/NCGI to appropriate target MBMS Service Area Identifier(s) (SAI(s)) for the broadcast. The V2X AS 328 may also provide the appropriate ECGI(s)/NCGI(s) and/or MBMS SAI(s) to the Broadcast Multicast Service Center (BM-SC) for scheduling and transmission of broadcast/multicast content, billing, service announcements, security and content synchronization.

The V2X Control Function 350 is a network function (NF) in core network that is used for network-related actions required for V2X. The V2X Control Function 350 is used to provision a UE (e.g., V-ITS-Ss 101 and 201) with necessary parameters in order to use V2X communication such as PLMN specific parameters that allow the UE to use V2X in a specific PLMN. The V2X Control Function 350 is also used to provision the UE with parameters that are needed when the UE is “not served by E-UTRAN” or “not served by NG-RAN”. The V2X Control Function 350 may also be used to obtain V2X USDs for UEs to receive MBMS based V2X traffic via the V2 reference point from the V2X AS 328. The V2X Control Function 350 may also obtain the parameters required for V2X communications over the PC5 reference point from the V2X AS 328 via the V2 reference point. The V2 reference point is a reference point between the V2X AS 328 and the V2X Control Function 350 in the operator's network.

The V2X Control Function 350 of an HPLMN is discovered through interaction with a Domain Name Service (DNS) function. The Fully Qualified Domain Name (FQDN) of a V2X Control Function 350 in the HPLMN may either be pre-configured in the UE, provisioned by the network, or self-constructed by the UE (e.g., derived from the PLMN ID of the HPLMN or the like). The IP address of a V2X Control Function 350 in the HPLMN may also be provisioned in or to the UE. The Home Subscriber Server (HSS) in an LTE core network and/or a Unified Data Management (UDM) NF in a 5G core network (5GC) provides a list of the PLMNs where a UE (e.g., V-ITS-Ss 101 and 201 of FIGS. 1A, 1B, and 2) is authorized to perform V2X communication over the PC5 reference point to the V2X Control Function 350 (see e.g., 3GPP TS 23.285 v16.0.0 (2019 Mar. 25) and ETSI TS 123 285 V14.2.0 (2017-05) (collectively “[TS123285]”)).

In some implementations, an V2X AS 328 (or V2X AS logic) may be co-located with an RSU. The VIS 280 defined in MEC is used to facilitate V2X interoperability in a multi-vendor, multi-network, and multi-access environment. The VIS 280, or generic parts of it, can be deployed in the MEC platform 330 (the filtering rules control 331, DNS handling 332, and service registry 338 may correspond to the filtering rules control 231, DNS handling 232, and service registry 238 of FIG. 2, respectively). Therefore, the VIS 280 may be used to obtain a UE's subscription data (e.g., PC5 based V2X communication allowed PLMN), from the V2X Control Function 350. Because the V2X AS 328 bears (or serves) multiple V2X applications, it can be deployed in MEC platform 330 as one or more MEC apps 228 (see e.g., FIG. 2). The VIS 280 can communicate with the V2X AS 328 through the Mp1 interface, and it can obtain the UE's V2X subscription data from the V2X Control Function 350 through the V2X AS 328. In some embodiments, the V2 and Mp1 reference points may be enhanced to support the secure transfer of subscription data between the V2X Control Function 350 and the VIS 280. Additionally, current 3GPP specifications do not define an interface between two or more V2X AS 328 or the methods for message exchange between V2X AS 328. In some embodiments, the Mp1 reference point may be enhanced to support the secure transfer of data between two or more V2X AS 328 implemented by a same MEC host 340, and the Mp3 reference point may be enhanced to support the secure transfer of data between two or more V2X AS 328 implemented by different MEC hosts 340. In these embodiments, the V2X API and/or the VIS 280 may provide a means for exchanging such information among V2X AS 328.

A V2X MEC app (e.g., MEC app 228 and/or V2X AS 328) may be required to communicate with its peer applications in other MEC systems in order to fulfil the intended purpose of the application use case. The involved MEC systems enable the authorized applications in one MEC system to communicate with their peers in another MEC system. The discovery of the application peers may be facilitated by the VIS 280 and/or V2X API (or VIS API) by exposing the available communication end point information for peer to peer connectivity. Alternatively, the configured traffic rules (e.g., filtering rules control 231/331) for the V2X MEC app, together with the underlying inter-MEC system connectivity arrangements, may support the application peers' communication. Additionally or alternatively, the V2X MEC app may rely on non-MEC-specific means for its peer discovery and then rely on its authorized access to external interface for the communication. The required arrangements between the involved MEC systems for realizing secure connectivity with the application specific requirements may be application and/or deployment specific, and may vary from embodiment to embodiment.

Additionally, a V2X MEC app (e.g., MEC app 228 and/or V2X AS 328) in one MEC system may be required to consume a service in another MEC system in order to fulfil the intended purpose of the application use case. In this case, the V2X MEC app discovers the service in question in the service registry in its local MEC host 240/340. The required arrangements between the involved MEC systems for mapping a service produced in one MEC system to an endpoint in another MEC system may be application and/or deployment specific, and may vary from embodiment to embodiment.

As alluded to previously, the MEC hosts 240/340 also provide an RNI Service (RNIS). The RNIS is a service that provides radio network related information to MEC apps (e.g., MEC app 228 and/or V2X AS 328) and to MEC platforms 230/330. The RNIS is available for authorized MEC apps and is discovered over the Mp1 reference point. The granularity of the radio network information may be adjusted based on parameters such as information per cell, per UE, per QoS class (or QoS class identifier (QCI)) or it may be requested over period of time. The RNI may be used by the MEC apps 228 and MEC platforms 230/330 to optimize the existing services and to provide new type of services that are based on up to date information on radio conditions. The RNI that may be provided may include, for example, up-to-date radio network information regarding radio network conditions; measurement information related to the user plane based on 3GPP specifications; WLAN measurements; information about UEs connected to the radio node(s) associated with the MEC host (e.g., NANs 110, 210) their UE context and the related radio access bearers; changes on information related to UEs connected to the radio node(s) associated with the MEC host, their UE context and the related radio access bearers.

In the various embodiments herein (e.g., the first embodiment and second embodiments discussed infra), since the RNIS provides information on the V-ITS-Ss 101/201 connected to a given NAN 110/210, the type of information provided by multiple NANs 110/210 “en route” can result in achieving real-time traffic flow predictions for a given V-ITS-S 101/201. Such information can then be taken into account for route planning/updates.

Furthermore, cellular handovers should not create the need to trigger the V-ITS-S journey-aware QoS prediction procedure from the beginning (e.g., Step 1 supra), because the planned journey and the data transfers (e.g., installed SW package versions, etc.) can be passed over or transferred from (master) MEC host 140/240 to (master) MEC host 140/240 along the planned journey (e.g., over an X2 or Xn interface between RAN nodes or the like). Such “data passing” is feasible as the MEC Orchestrator (discussed infra) of the MEC system is aware of MEC host deployment specifics. The communications between MEC hosts 140/240 and V-ITS-Ss 101/201, and/or between multiple MEC hosts 140/240 may use security procedures/protocols such as, for example, OAuth 2.0 authorization framework, which enables a third-party application to obtain limited access to an HTTP service (https://restfulapi.net/security-essentials/); Transport Layer Security (TLS), which is cryptographic protocol that provide communications security over a computer network (https://blog.restcase.com/introduction-torest-api-security/); HTTPS, which secures the transmission of the message over the network and provides some assurance to the client about the identity of the server; and/or any other suitable communication mechanisms.

### 2. Transport Layer Congestion Control Embodiments

Embodiments discussed herein solve inefficiencies of layer-4 (transport) protocols, such as Transport Control Protocol (TCP). Transport protocols run on end systems only, and usually need to infer the bandwidth along the path between the endpoints in order to adapt their transmission rate and avoid network congestion.

TCP is a connection-oriented, byte-oriented, two-way protocol, with built-in reliability mechanisms. The sending application sends an uninterrupted stream of bytes, and TCP delivers it in order to the receiving application. After a TCP session is opened, the bytestream is segmented into TCP segments, which flow from the sender to the receiver and are acknowledged from the receiver, which sends back an ACK carrying the number of the next byte that it expects to receive from the sender. Out-of-sequence parts of the bitstream (notably, those after a missing segment) are kept in the receiver's buffer, but they are not sent to the application. The receiver acknowledges them only when the correct sequence has been recovered. The sender protects segments with timeouts, and repeats transmission when the timeout expires.

TCP has a built-in congestion control mechanism, which allows a sender to discover the maximum bandwidth that the network path can support, by probing. Congestion control is regulated by a congestion window (CW), which caps the number of outstanding (unacknowledged) segments that a sender can have at any time. Typically, the CW is increased at some pace whenever ACKs are received. When a time out expires, the CW is reset to a minimum value, and the whole process restarts. Timeouts or duplicated ACKs (which only occur if a segment has been lost, as the receiver keeps acknowledging the last in-sequence byte at each subsequent arrival) are interpreted by the sender as congestion signals, and the sender reacts accordingly by decreasing the CW. There are plethora of TCP congestion-control algorithms (e.g., TCP Tahoe, TCP Reno, TCP Tahoe and Reno, TCP Vegas, TCP NewReno, TCP Cubic, TCP JetMax, and the like), which differ from each other according to when exactly, and by how much, they modify the CW following one of the above-mentioned events.

In a MEC environment, TCP may be used to transport traffic between an application running on the MEC host (the MEC app, henceforth) and the one running on the end-user device. The path between the two TCP endpoints consists of a (short) wired subpath, and (quite often) a radio link (e.g., a 4G/5G radio link) usually acting as the bottleneck.

TCP interprets timeouts and duplicated ACKs as signals of congestion, and reduces the CW accordingly, often in a drastic way. In a radio environment, timeouts could be due to other causes than congestion (e.g., temporary poor radio conditions for a user). Reacting to these causes in the way that TCP does leads to inefficiencies (e.g., unnecessary throughput drops for long periods of times (in the order of seconds)). Using MEC services can help TCP congestion control to ascertain the real cause of a timeout or duplicated ACK, improve the efficiency of congestion control, and increase the user throughput. In the following, the software running on a TCP sender making congestion control decisions is referred to herein as Transport Protocol Runtime (TPR).

FIGS. 25-26 show example MEC architectures that may be used for various embodiments herein. MEC is a technology that may exploit 3GPP Fifth Generation (5G) networks, and most of the innovative services and scenarios are expected to exploit this technology. In the MEC framework, a user equipment (UE) application can communicate with an edge application (e.g., MEC app) and a remote application, which is traditionally instantiated far from the client/UE side. Most network traffic uses TCP, whose performance suffers from several issues. Embodiments herein utilize the MEC framework to support performance enhancements for TCP-based networks that can be perceived (e.g., at the application level) with real benefits for the end-user.

Embodiments herein exploit the MEC system/architecture to support and overcome TCP network limitations, in order to improve network performance perceived at the application level. Embodiments herein provide MEC-based enhancements to ascertain causes of timeouts, duplicated acknowledgements (ACK), and/or other performance-related issues to improve network efficiency and/or reducing network congestion, and increasing throughput. In embodiments, a Transport Protocol Runtime (TPR) entity runs on a TCP sender, making congestion control decisions. The TPR acts as a client for MEC services. The interaction between the TPR and the MEC services can occur either following a request/response pattern or following a publish/subscribe (pub/sub) pattern. The request/response pattern is triggered by specific trigger events/conditions, or when application traffic is light, scarce, or irregular. The pub/sub pattern is used for periodic updates, and may be used when high traffic rates are experienced.

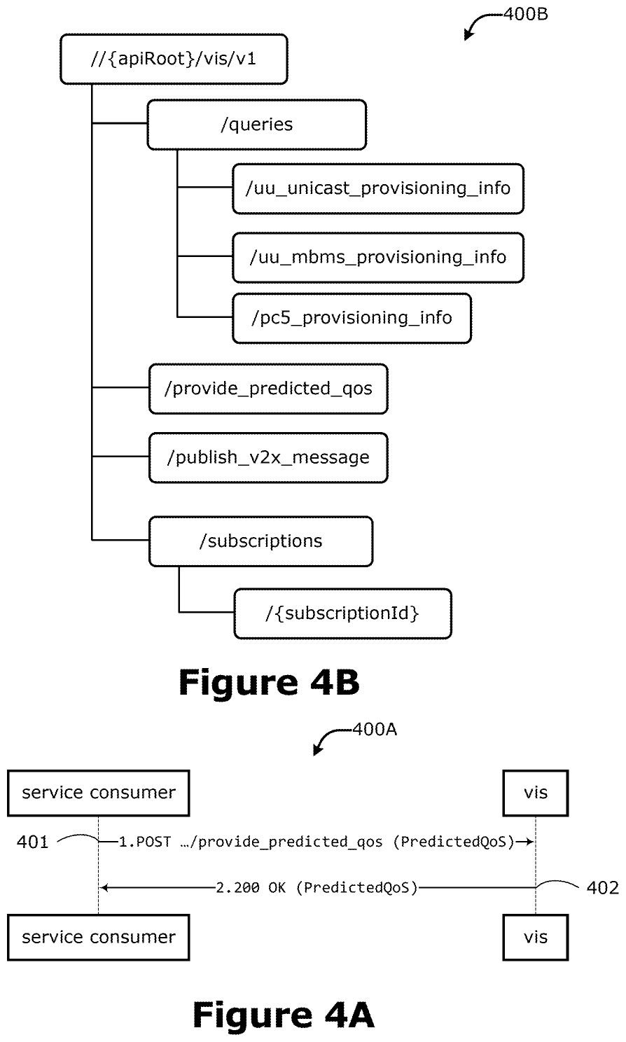

The solution in Abbasloo et al., “Toward Optimal Performance with Network Assisted TCP at Mobile Edge”, 2nd USENIX Workshop on Hot Topics in Edge Computing (HotEdge 19) (2019) (hereinafter “[Abbasloo]”) proposes to introduce a new entity called Network Assistance (NetAssist) in the network which periodically collects information regarding the bottleneck's bandwidth and the minimum delay for each UE (steps 2 and 3 in FIG. 5), and sends digested feedback (step 4 in FIG. 5) to the servers, that have registered to get congestion assistance service from the CN, in OoB (Out of Band) manner. This feedback will be used by servers to set Cwnd and pacing rate and send data accordingly. In other words, it assumes a new, different component, which is logically and physically separated from the TPR that sends some well-defined information to the edge servers, hence to the MEC Apps themselves. While the intent of [Abbasloo] is similar to ours, and—besides—[Abbasloo] shows that remarkable improvements in the TCP performance can be harvested by using radio information, the solution is different. This work does not foresee any interaction between TPR and MEC services.

The solution in Wang et al., “Experimental Evaluation of Modern TCP Variants in MEC-enabled Cellular Networks”, 2018 10th International Conference on Wireless Communications and Signal Processing (WCSP), Hangzhou, pg. 1-5 (2018) evaluates TCP variants in a MEC-enabled environments without making any design proposal. The solutions in Jain, et al., “Mobile Throughput Guidance Inband Signaling Protocol”, draft-flinck-mobile-throughput-guidance-04.txt, IETF (Feb. 20, 2015) (herein after “[Jain1]”) and Jain, et al., “Requirements and reference architecture for Mobile Throughput Guidance Exposure”, draft-sprecher-mobile-tg-exposure-req-arch-03.txt, IETF (Mar. 13, 2017) (hereinafter “[Jain2]”) propose Mobile Throughput Guidance (MTG), which inserts into TCP ACKs coming from the UE information on the throughput that the TCP sender (typically, a video server) should keep. The TCP Guidance Provider inserts information on the available DL bandwidth and the TCP server adapts the throughput accordingly.

The embodiments herein are different than those discussed in [Jain1] and [Jain2] in that: (a) it does not require a TCP guidance provider, or intercepting TCP ACKs. Instead, it uses registered MEC services (possibly of any type); (b) it can use any information that can be available in the form of a MEC service (e.g., not only the available downlink bandwidth, but possibly subscription information, location, radio network information, further contextual information, originating from the respective MEC APIs, etc.); and (c) it can query MEC services, in a proactive approach, rather than just receiving information passively (please refer to the red arrow going to the right in FIG. 2). Moreover, MTG only comes with ACKs. Unless you get an ACK, you do not get any MTG information. Our solution allows you to have information any time. Specifically, it allows you to understand what is happening when the receiver is not sending ACKs.

The embodiments herein can also implement MTG, but it also enables different behaviors and solutions that MTG cannot support. Furthermore, it can be used with any TPR, not only TCP. Embodiments herein are different than the solutions in [Jain1] and [Jain2] in the following ways: applicability to transport protocols beyond TCP; exploitation of any information coming from MEC services deemed as useful to identify events as congestion/non-congestion caused ones beyond RNI (e.g., location, BW, user context information); the embodiments herein model the TPR entity and the MEC (Server) App as either a single MEC App or separate ones; the embodiments herein may use both pub/sub and query/response mechanisms to obtain MEC service information, depending on the scenario; and the embodiments herein specifies a TPR exposure interface to the MEC App.

The solution in Goyal et al., “Rethinking Congestion Control for Cellular Networks”, Proceedings of the 16th ACM Workshop on Hot Topics in Networks (HotNets-XVI). ACM, New York, N.Y., USA, 29-35 (Nov. 30, 2017) (hereinafter “[Goyal]”) introduces Accel-Brake Control (ABC), a new transport protocol which uses one header bit to signal to the server that the transmission rate can be increased or decreased. That bit is set by routers in transit based on their perception of congestion in the network. The server reacts by sending two packets on receipt of an “Accelerate” ACK, and no packet at all on receipt of a “Brake” ACK, thus adjusting its sending rate around an optimal average. The solution in [Goyal] differs from the present embodiments in that it does not foresee any interaction between a TPR and a MEC service, and does not utilize the MEC framework at all.

Finally, the ETSI Group Specification on the Radio Network Information (RNI) API [MEC012] illustrates the benefit of MEC service consumption to optimize the existing services and to provide new type of services that are based on up to date information on radio conditions. Video throughput guidance is presented as an indicative example, however, no specific implementation/operation proposal is provided.

The embodiments herein enable context-aware, location-aware, radio-network-information-aware congestion control at the sender, which, in turn, enables a whole new category of congestion control algorithms exploiting the above information exploitable via the consumption of MEC services. The embodiments herein realize cross-layer interaction using MEC services as broker, in a standardized, secure, and portable way (see e.g., Raisinghani et al., “Cross-layer design optimizations in wireless protocol stacks”, Computer Communications, Volume 27, Issue 8, pp. 720-724 (May 2004) (hereinafter “[RAIS]”); and Carneiro et al., “Cross-layer design in 4G wireless terminals,” in IEEE Wireless Communications, vol. 11, no. 2, pp. 7-13 (April 2004) (hereinafter “[CARN]”)).

### 2.1. Transport Protocol Runtime Framework

MEC is designed so that the software that runs on a MEC host can access information on the radio link and the user through well-defined, standardized interfaces to MEC services such as the Radio Network, the Location and the Bandwidth Manager information. The TCP runtime support of an instantiated MEC app, which runs on the MEC host itself, can therefore access that information too. In various embodiments, this information can be used to throttle the TCP traffic, by acting on its congestion control, in a finer and more refined manner than existing solutions, so as to maximize user experience, avoid congestion, and achieve a higher throughput.

For instance, including MEC service-originating information in TCP congestion control allows: discriminating losses due to congestion events from those due to transient conditions (e.g., temporary loss of line-of-sight, deep fading events); anticipating the worsening of the radio conditions for a user, or handovers by consuming MEC services which expose radio network, location, bandwidth etc. information previously provided by other users under radio coverage; and adding a proactive approach to congestion mitigation on the radio link.

According to various embodiments, it is possible for the Transport Protocol Runtime (TPR) entity at the MEC host side to consume MEC services either directly or indirectly via respective MEC applications (apps). Exposure of the TPR entity to the requested MEC service should be feasible when the TPR entity and the MEC app are instantiated either at the same MEC host or at different MEC hosts.

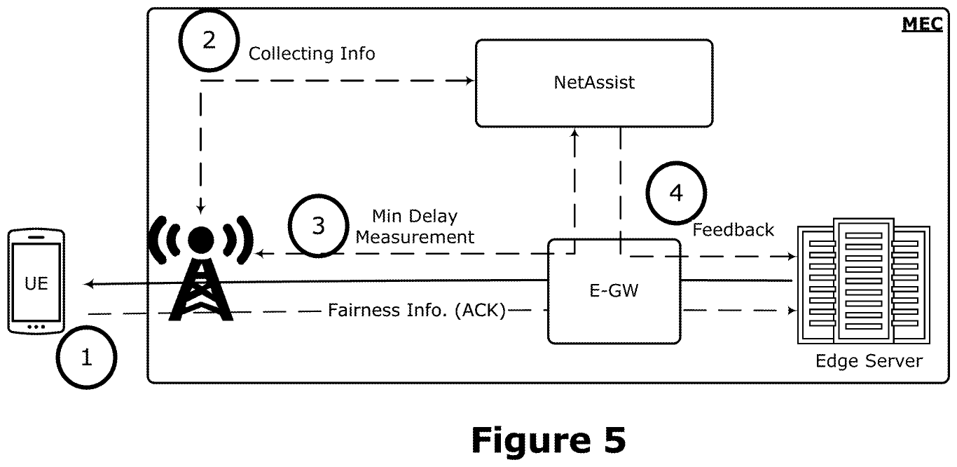

The term “Transport Protocol Runtime” or “TPR” a used herein refers to a runtime, session, and/or execution environment for a transport protocol, such as Cyclic UDP (CUDP), Datagram Congestion Control Protocol (DCCP), Fibre Channel Protocol (FCP), Multi-Path TCP (MPTCP), Multi-Path UDP (MPUDP), QUIC, Reliable Data Protocol (RDP), Reliable UDP (RUDP), SCTP, Sequenced Packet Exchange (SPX), Structure Stream Transport (SST), TCP, UDP, UDP-Lite, Micro Transport Protocol (pTP), and/or the like. When the underlying transport layer protocol is TCP, the TPR may be referred to as a “TCP runtime” or the like. In embodiments, the TPRs at the server side (e.g., running on MEC servers), query MEC services, either periodically (e.g., by subscribing to RNI event notifications, especially if the application-related traffic is intensive), or triggered by specific events (e.g., a message timeout, a duplicated ACK, etc.), in order to gain a better understanding of the capacity available to their connection, adapting their behavior accordingly, as shown by FIG. 6.

FIG. 6 shows the interactions 601 between a server side TPR and a MEC service, standard MEC interactions 602, and data-path interactions 603 within the protocol stack according to various embodiments. The interactions between the MEC server/host side TPR and the MEC service can occur either following a request/response pattern (e.g., when triggered by specific events) or following a publish/subscribe pattern (e.g., for periodic updates). The choice of the interaction pattern may depend on the performance requirements posed by the end user app (e.g., regarding service reliability, end-to-end latency, and/or other metrics, together with the traffic rate (activity profile), and the like), as some end-user applications may require that output is provided at a frequent rate (e.g., high-resolution video segments), while others may only require scarce output rates (e.g., IoT/machine type communication devices).

The algorithms/mechanisms used by the TPR to adapt the behavior of the underlying transport protocol based on the above information are outside the scope of the present disclosure. The following discussion describes examples of a MEC app using TCP as a transport protocol for sending data to a UE App in a mobile terminal/UE in a cellular network. However, the embodiments herein are applicable to any other transport layer protocol in addition to TCP such as those discussed elsewhere herein.

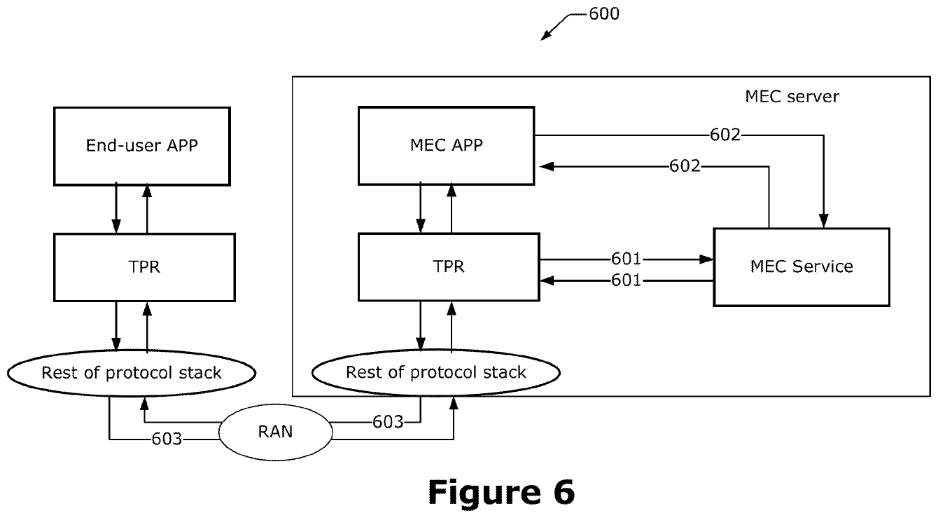

FIG. 7 shows an example congestion window (CW) scenario (qualitative) 700 according to various embodiments. With reference to FIG. 7, assume the UE enjoys a high CQI, hence has a high throughput, and the TCP has a large CW accordingly. The downlink of the radio access is not congested. Suddenly, the UE enters an area with poor reception (e.g., a tunnel), where it will stay for some seconds. CQIs (in both the DL and the UL) drop down, hence traffic (including ACKs) is stalled for some seconds. Some TCP segments time out. Standard TCP would react by assuming congestion in the network. This has several consequences. First of all, the dropped segment(s) are retransmitted, using an exponentially increasing backoff window (see e.g., the vertical arrows in FIG. 7). This implies that, when the radio conditions allow the traffic to flow again, the TCP sender may still wait a non-negligible delay (in the order of seconds, or tens thereof, marked by EB in the FIG. 7) just because it is waiting for the backoff timer to expire before the next retransmission attempt. Moreover, when the UE exits the tunnel, and traffic transmission resumes, the connection will be in slow start, and the CW will increase until half its former value, and then switch to Congestion Avoidance (CA). All things considered, a remarkable amount of time will elapse until the former throughput level is achieved again, without any compelling network reason (there is in fact no congestion).

A TCP runtime may instead exploit the consumption of instantiated MEC services to be (regularly) informed of: RNI from an RNIS, BW information from a BWMS, and/or UE location information from a Location Service.

The RNI may include, for example, up-to-date radio network information regarding radio network conditions; measurement information (e.g., RSRP, RSRQ, SINR, etc.) related to the user plane based on 3GPP specifications; information about UEs connected to one or more RAN nodes associated with a particular MEC host, their UE context and the related RABs; changes to the information related to the UEs connected to the RAN node(s) associated with the particular MEC host, their UE context and the related RABs; a user CQI; and/or the amount of occupied resources as occupied or reserved for a specific UE, or resources scheduled by one or more RAN nodes.

The BW information may include, for example, fixed BW allocation size (e.g., in bps), fixed BW priority (e.g., indicates the allocation priority when dealing with several applications or sessions in parallel), and a fixed BW allocation direction (e.g., DL or UL) at a particular timestamp or for a change in BW (e.g., a delta).

The Location Service (LS) supports the following location information: location information of specific UEs currently served by the radio node(s) associated with a particular MEC host; location information of all UEs currently served by RAN node(s) associated with the MEC host; the distance between specified UEs currently served by the RAN node(s) associated with the MEC host; the distance between a specified location and a UE currently served by the RAN node(s) associated with the MEC host; the location information of a certain category of UEs currently served by the RAN node(s) associated with the MEC host; a list of UEs in a particular location area; the specific UEs which move in or out of a particular location area; information about the location of all RAN node(s) currently associated with the MEC host; periodic location information updates, updates on changes in distance and location updates relating to UEs in a particular location area. The UE location information (e.g., position) may also include UE mobility information (e.g., speed/velocity), which can be proved useful (e.g., when added to a geo-location/map service consumed by a vehicle UE) so as to identify low-signal location(s) and the expected visited time(s) by the UE.

The above MEC service consumption by the TPR entity is to infer that the problem is not due to congestion, but to temporarily poor channel quality. This way, when the mobile exits an area of low signal quality, the protocol (e.g., TCP) can react faster. First of all, it can detect that the radio conditions for the UE are good again, and therefore, dispense with unnecessary waiting times due to the exponential backoff window (marked by the EB arrow in FIG. 7). Moreover, it may assist in reverting the CW to its maximum (see e.g., the line 701 in FIG. 7) in a timely manner. This allows the end user to reach its target throughput sooner.

For instance, when the timeout occurs, the TCP runtime can use information via consuming the following MEC services:
UE measurement report notifications from the Radio Network Information Service (RNIS). This allows it to understand if the channel quality of the UE has dropped (e.g., if the CQI of the UE has dropped w.r.t. the previous measurements);
The amount of allocated RBs in the serving cell from the Bandwidth Management Service (BWMS). This allows it to understand the level of congestion of the radio frame (or, equivalently, the number of UEs competing for the same resource); and/or
the positioning information of the UE from the Location Service, to be compared against a layout of the area.

From a subset of the above information, the TCP runtime can tell that there is no need to activate TCP congestion avoidance (e.g., reducing the CW, retransmitting the lost segment at intervals with increasing backoff, etc.). Rather, the sensible thing to do would be to halt the transmissions until the channel gets better (which can again be inferred using UE measurement reports from the RNIS) and then resume the transmissions at the same pace they had before (unless the radio frame has congested in the meantime).

Since MEC services can collect information regarding the radio (e.g., layers 1 and 2 of the protocol stack), through the RNIS, the aforementioned embodiments can also be configured as a standardized interface for cross-layer interactions. Cross-layer interactions refer to feedback/control from one protocol layer to another, which on one hand violates the protocol encapsulation golden rule, but on the other hand allows finer-grained control over the protocol-stack traversal of messages, and may result in higher efficiency and overall better service (see e.g., [RAIS], [CARN]). Cross-layer interactions normally require one protocol to configure and export specific interfaces for the other protocol to exploit (e.g., a layer-2 (MAC) protocol) exporting information that the layer-4 (transport) protocol may use. These solutions are often studied in academic papers, but they are hard to realize in practice, since they require coordinated deploying of different layers of the protocol stack. This is mainly because protocol stack layers are often deployed by different teams at different times. Using the embodiments herein, MEC services could act as standardized brokers for cross-layer interactions. For instance, the RNIS could provide the TPR with layer 1/2 information (e.g., the current channel quality on the radio interface), allowing the TPR to make better decisions. This does not require any modifications to the layer-2 protocol, or any coordinated development of layer-4 and layer-2 protocols.

### 2.2. Implementation Aspects and Example Embodiments

As alluded to previously, the embodiments herein include a MEC-based enhancement of the client-server communication, practically implemented as a customized MEC app both as container or VM (see e.g., Embodiment 1 discussed infra), or multiple customized MEC apps (see e.g., Embodiment 2 discussed infra). In both cases, the IP traffic is routed by the Data Plane (according to the traffic rules) and received by the TPR. The UP flow is always composed by several components: the regular protocol stack (actually implemented by a RAN node and Data Plane), the TPR (Layer 4), and a Server App (Layer 7).

The two embodiments discussed infra differ based on the functional split of TPR and the actual Server App, implemented as a single entity or two separate entities. In both cases, the interaction between TPR and MEC services (e.g., RNIS, BWMS, LS, etc.) can occur (e.g., via the Mp1 interface) either following a request/response pattern (e.g., when triggered by specific events, or, when the application traffic is scarce or irregular) or following a publish/subscribe pattern (e.g., for periodic updates, esp. for high traffic rates).

### 2.2.1. Embodiment 1: Entire Stack in a Single MEC App

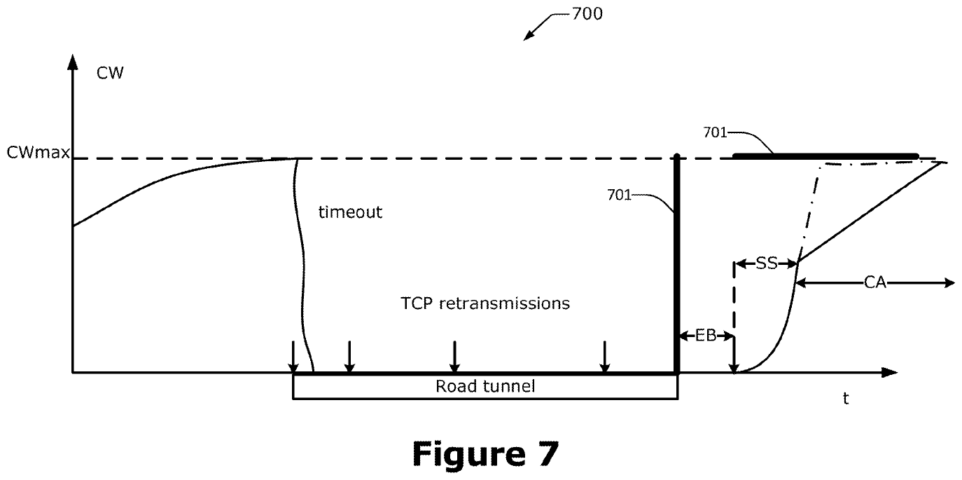

FIG. 8 shows an example 800 of embodiment 1 wherein a MEC App 826 includes both a Server App 827 and the TPR entity 828 within the same isolated user-space instance (e.g., container, partition, virtual environment (VE), etc.) or virtual machine (VM) (including a type 1 or type 2 VM). In this embodiment, the MEC app 826 includes a modified TPR 828, which acts as a client for the MEC service(s) and is capable of interacting with both the MEC service(s) to be consumed and the Server App (e.g., inside the same MEC app 826). The interactions between the TPR entity 828 and/or server app 827 with the MEC services may take place over a control plane. Additionally, the UE 801 includes a client app 817 that interacts with a local TPR entity 818, which interacts with various other protocol stack layers. The interactions between the TPR entity 828 and/or server app 827 with the client app 817 and/or TPR entity 818 may take place over a user plane.

### 2.2.2. Embodiment 2: TPR as a Service Producing MEC App

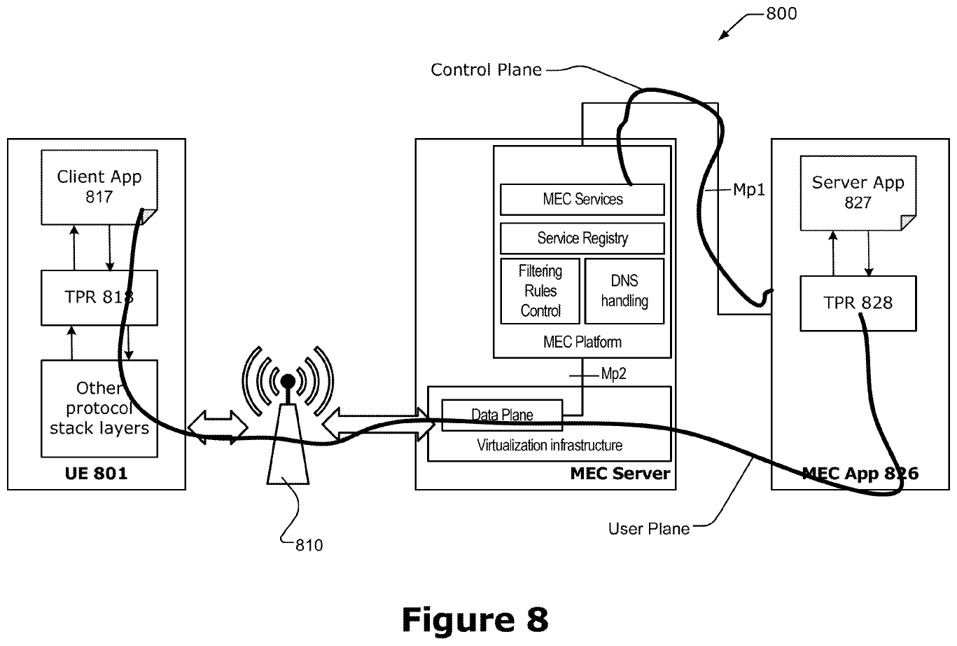

FIG. 9 shows an example 900 of embodiment 2 wherein the TPR entity 928 and the Server App 927 are two distinct entities (e.g., two distinct MEC apps 926-1 and 926-2, respectively). In this embodiment, each entity may be implemented or executed in respective isolated user space instances (e.g., containers, partitions, VEs, etc.) or respective VMs (including type 1 or type 2 VMs). In the example of FIG. 9, MEC app 926-1 represents the Server App 927, and MEC app 926-2 implements a modified TPR 928. MEC app 926-2 acts as a client for MEC services via the control plane, and is capable of interacting with both the MEC service(s) to be consumed and the Server App 927 (MEC app 926-1). Similar to embodiment 1, the UE 901 includes a client app 917 that interacts with a local TPR entity 918, which interacts with various other protocol stack layers. The interactions between the TPR entity 928 and/or server app 927 with the client app 917 and/or TPR entity 918 may take place over a user plane.

### 2.2.3. Communication Between TPR and MEC Service(s)

The communication between the instantiated TPR entity and the available MEC services may take place using MEC APIs. MEC allows running MEC apps at the edge of the network to be exposed to location and up-to-date information, such as up-to-date RNI. The information on current radio conditions are shared via the MEC platform over an RNIS, and location information is shared via a Location Service (LS). In this case, service consumers (e.g., a TPR instance) communicate with the RNIS over an RNI API to get contextual information from the radio access network. Both the MEC app and MEC platform may be service consumers, and the RNI may be provided by both the MEC platform and the MEC application. Service consumers (e.g., a TPR instances) interact with the LS over LS API to obtain location information of a UE, a group of UEs, and/or the radio nodes currently associated with a MEC host. The LS supports both geolocation (e.g., geographical coordinates) and logical location (e.g., Cell ID). The RNI API and the LS API support both queries and subscriptions (pub/sub mechanism) that are used over a RESTful API (e.g., using HTTP protocol bindings) or over a message broker of the MEC platform.

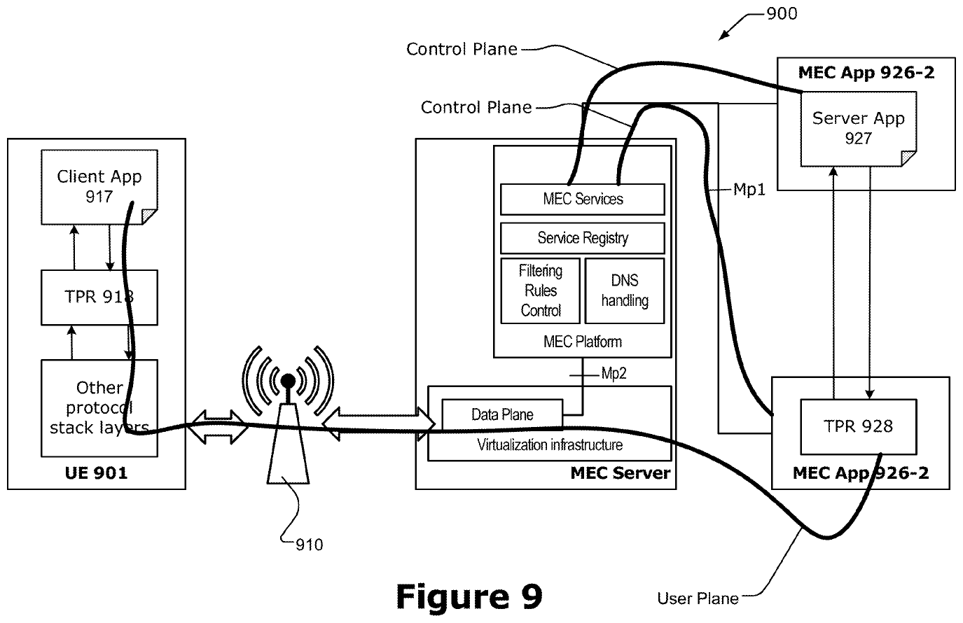

The TPR exposure to the Server App should be defined in order to enable interoperability. The possible MEC communications (e.g., at the control plane of MEC) are described infra, and are based on a query/response mechanism for obtaining information by MEC services, or a publish/subscribe mechanism. As an example, since a “proactive approach” is aimed to be designed, the pub/sub option can be convenient in some cases, especially with consistent traffic arrival rates. On the other hand, the “query/response” mechanism can be used in the case of scarce traffic (e.g., with massive machine-type communications (mMTC) and low-end devices) to save signaling resources at the receiver (Rx) side. While embodiment 1 embeds the TPR entity and the related Server App instance in the same entity (e.g., a VM, container, etc.), embodiment 2 allows interoperability, also including cases where the TPR entity may be instantiated at a MEC host different from the one where the Server App is instantiated. The procedures 1000 and 1100 of FIGS. 10 and 11, respectively, show and describe the communication mechanisms to expose this TPR service to higher layer Server Apps. Although the procedures 1000 and 1100 are described as interacting with the RNIS and the LS, in various embodiments the TRP may interact with other MEC services such as UE_ID Services [MEC014], BWM Services (BWMS) [MEC015], WLAN Access Information Service (WAIS) [MEC028], FAI Services (FAIS) [MEC029], and/or other like MEC services.

### 2.2.4. Query/Response Embodiments

FIG. 10 illustrates an example procedure 1000 for using the query/response pattern embodiments for MEC service consumption by the TPR entity at the server side (e.g., TRP entity 828 and 928 of FIGS. 8 and 9). Such a (reactive) pattern may be favorable to scenarios where user traffic is scarce and/or in case of non-stringent QoS requirements in terms of, for example, throughput sustainability. Procedure 1000 may operate as follows:

At step 1, the TPR detects occurrence of an event. The event may be, for example, a message time-out happens or a duplicated ACK is received. At step 2, the TPR sends an GET request message to the resource relevant to congestion event identification, which in this example is the RNIS to request Radio Access Bearer (RAB) information. At step 3, the TPR receives an response message (e.g., with “200 OK” response code) from the relevant resource with the message body containing the requested information (e.g., the RAB information). At step 4, the TPR sends an GET request message to the resource relevant to congestion event identification, which in this example is the LS to request the geo-location of a UE. At step 5, the TPR receives an response message (e.g., with “200 OK” response code) from the relevant resource with the message body containing the requested information (e.g., geo-location of the UE). At step 6, the TPR classifies the event as a non-congestion related event based on the gathered information. The transmission halts, and current CW dim. is saved.

Steps 7 through 10 repeat steps 2 through 5, respectively. At step 11, based on updated information, TPR determines that radio conditions have improved, and resumes transmission with the same congestion window as before the event's occurrence (e.g., message time-out or ACK duplication).

### 2.2.5. Publish/Subscribe Embodiments

FIG. 11 illustrates an example procedure 1100 for using the subscribe/notify (“pub/sub”) pattern for MEC service consumption by the TPR entity at the server side (e.g., TRP entity 828 and 928 of FIGS. 8 and 9). Such a pattern may be favorable to scenarios where the traffic arrival rate is consistently high, therefore, providing a level of proactiveness in view of forthcoming service degradation events (congestion or non-congestion related). Procedure 1100 may operate as follows:

At step 1, as a pre-condition, the TPR has active subscriptions with both the RNIS (e.g., for UE measurement reports and/or others discussed in [MEC012]) and the Location Service (LS) (e.g., those discussed in [MEC013]). At step 2, the RNIS detects the occurrence of an event relevant to the TPR. At step 3, the RNIS sends an POST request with the message body containing an updated data structure (e.g., “EventNotification”) to the callback reference address included by the TPR in the corresponding RNIS subscription. At step 4, the TPR sends an appropriate response to the RNIS, which in this example is a response message with the “204 No Content” status code. At step 5, based on the received notification, the RNI change together with the lack of a UE location event is classified by the TPR as an event indicating a possible forthcoming congestion. The TPR schedules or plans to implement a suitable congestion control algorithm.

### 3. OPTIMEC—Framework for Edge Computing Point-of-Presence (PoP) Optimizatons in Automotive Scenarios Based on Extended In-Advance QoS Notifications (e-IQN)

Embodiments herein are related to V2X services and QoS predictions utilizing the deployment of Edge Computing (e.g., MEC) infrastructure alongside RANs (and/or individual RAN nodes) such as 3GPP Fifth Generation (5G) RANs, 3GPP LTE E-UTRANs, WiFi wireless access points (WAPs), Intelligent Transport System (ITS) roadside equipment (R-ITS-S), and/or the like. The edge compute infrastructure may be implemented using Multi-access Edge Computing (MEC), which is a technology that allows applications to be instantiated at the edge of the access network, and provide a low-latency and close proximity environment to terminals/stations/UEs. As a result, vertical industries, such as the automotive industry, are expected to significantly benefit from the deployment of MEC infrastructure together with the RAN.

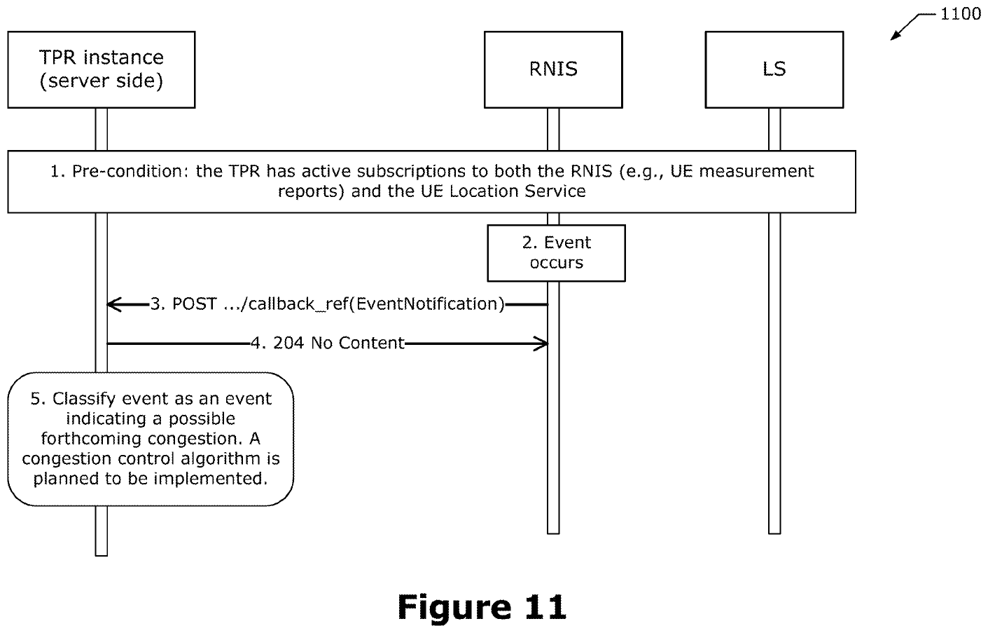

FIG. 12 illustrates an exemplary V2X system scenario 1200, where a MEC host 1240 is deployed in collocation with a NANs 1210 (including NAN 1210-1 and NAN 1210-2) providing coverage (e.g., V2X communication services). In this example, the NAN 1210-1 may be a road side unit (RSU) or roadside ITS station (R-ITS-S), a cellular base station (e.g., an eNB, ng-eNB, gNB, WiMAX base station, and/or the like), or some other network element providing network coverage (e.g., V2X communication services) to a first V-ITS-S 1201-1 and a second V-ITS-S 1201-2. In this example, the NAN 1210-2 may be a roadside AP (RSU, R-ITS-S, and/or the like) or some other network element providing network coverage (e.g., V2X communication services) to a third V-ITS-S 1201-3.

The MEC hosts 1240 (including MEC host 1240-1 co-located with NAN 1210-1 and MEC host 1240-2 co-located with NAN 1210-2) provides, inter alia, VIS, RNI Services (RNIS), Location Services (LS), UE_ID Services, BWM Services (BWMS), WAI Services (WAIS), FAI Services (FAIS), and/or other MEC services. In FIG. 12, a planned trajectory of first V-ITS-S 1201-1 and the second V-ITS-S 1201-2 are not known at the NAN 1210 or MEC host 1240. However, since V2X system scenarios are characterized by high mobility and dynamic topology, the accuracy and the timeliness of information (e.g., radio network, location information, etc.) when centrally collected by a MEC host 1240, are hampered by the environmental situation (e.g., the occurrence of network congestion events when multiple V-ITS-Ss 1201 attempt to provide radio measurements to respective NANs 1210, which is co-located with respective MEC hosts 1240), as well as by the deployment density of the cellular network, together with the capabilities of the deployed MEC infrastructure.

Scenario 1200 is based on an ITS or V2X environment incorporating connected vehicles 1201, radio network and road connectivity infrastructures 1210, and an edge computing system deployment including MEC hosts 1240 co-located with radio nodes 1210 (e.g., cellular Base Stations (BSs), radio Access Points (APs) and Roadside Units (RSUs), and/or the like).

In embodiments, Prediction Functions (PFs) (including RAN PF 1250-1 and RAN PF 1250-2) are deployed at the network and/or road infrastructure side. The PFs 1250 may be Machine Learning (ML) model(s)/algorithm(s) and/or Artificial Intelligence (AI) agents implemented, for example, by a Deep Neural Network (DNN), and/or some other ML/AI algorithm, such as those discussed herein. The role of the PF 1250 is to generate predictions of Quality-of-Service (QoS) to be experienced by, for example, Teleoperated Driving (ToD) applications, V2X applications, and the like.

Predictive QoS is a mechanism that enables a network (e.g., mobile network) to provide notifications about predicted QoS changes to interested consumers (e.g., connected vehicles 1201 or the like) in order to adjust the application behavior in advance. Such prior notifications, whenever predictions are made with sufficient confidence, may be delivered with a notice period before the new predicted QoS is experienced. The notice period depends on the specific application and use case, and should be long enough to give the application sufficient time to adapt to the new predicted QoS. The message carrying such information is called In-advance QoS Notification (IQN). IQNs are received by connected vehicles 1201, thus enabling V2X applications to take appropriate action prior to the predicted QoS change taking.

In case a predicted QoS is lower than a given threshold (or outside of some standard deviation), depending on the application's performance requirements, an IQN is sent to an IQN consumer (e.g., a V2X application as discussed in 5GAA, “Making 5G Proactive and Predictive for the Automotive Industry”, Working Group 2 White Paper (9 Dec. 2019) (hereinafter “[5GAAWG2]”)).

Additionally, [MEC030] specifies a VIS (see e.g., above discussion) and the exposure of its related V2X API, the role of which is, among others, to facilitate the forwarding of requests of the predicted (radio) QoS corresponding to potential routes (e.g., waypoints and planned visited times along a route or journey) of a vUE 1201, when issued by the VIS service consumer (e.g., a ITS/V2X application) and provide the requested, journey-specific predicted QoS to the VIS service consumer. For this task, an API resource called provide_predicted_qos is specified (see e.g., clause 7.6 of [MEC030]).

The issuing of predictive QoS notifications might be useful for a quite long list of VIS consumers, ranging from the customer/driver of the vehicle, and in general also to any ITS/V2X application or service provider (e.g., a Mobility-as-a-Service provider (MaaS)), a fleet, management company, vehicle Original Equipment Manufacturers (OEMs), MNOs, and/or a third party at the infrastructure side. In the latter case (e.g., consumption of VIS by OEMs and ITS operators), the usage of QoS notifications can be beneficial, for example, to reduce the incurred service consumption cost for the vehicle owner or ITS operator (e.g., a fleet management company, OEMs, etc.). Often, ITS operators or vehicle OEMs collaborate with MNOs to exploit mobile networks and operators' cloud facilities to deploy C-V2X services to end-customers. Nonetheless, such collaboration and edge cloud hosting comes at a cost for the vehicle OEMs. Consequently, these stakeholders, which are supposed to be the owners of the App to be hosted by the MEC system, want to achieve cost-efficient utilization of cloud computing facilities, while maximizing the quality of the V2X services offered.

In addition, these cases could be generically extended to MEC federation scenarios, where the implementation of a V2X service requires use of cloud resources in multiple MEC systems and/or multiple MEC hosts 1240. Also in these cases, the MEC App owners (vehicle OEMs, ITS operator, etc.) may be interested in optimizing the overall hosting costs associated with edge computing (e.g., MEC) Points-of-Presence (PoPs) involved in the V2X service, where, these PoPs, in a MEC federation scenario, generally belong to multiple MEC systems/MNOs. So, the retrieval of QoS notifications involving predictions across different MEC systems can be also useful also to optimize the overall (e.g., inter-system) MEC PoPs cloud resource costs.

A PoP is an artificial demarcation point or interface point between communicating entities. Additionally or alternatively, a PoP may be a physical location at which two or more networks or communication devices share a connection. A common example is an Internet point of presence, which is a local access point that allows users to connect to the Internet with their Internet Service Provider (ISP). A PoP can comprise a single server mounted in a cabinet (in contrast to edge compute node 1240 deployments, which are PoPs with deployments of advanced infrastructure—usually more than a single server). A PoPs may house various network elements such as servers, routers, (physical and/or virtual) network switches, hubs, multiplexers, firewall appliances, gateway appliances, and/or other network interface equipment used for traffic to cross over networks. PoPs are often located in data centers and/or at Internet exchange points (IXPs) and co-location centers. ISPs and edge networks may have multiple PoPs located at or near large IXPs where they have peering agreements. The proximity of PoPs and IXPs is a factor in how quickly traffic is able to traverse the Internet.

Currently, predictive QoS notifications only provide information on cellular communications-specific performance metrics related to the RAN and the Core Network (CN) (see e.g., Table E). Hence, no information on the expected availability of edge and/or cloud computing resources is included in the predictive QoS notification messages.

TABLE E
Use Cases Analysis for predicted QoS and QoS KPIs [5GAAWG21

| Use Case | QoS KPIs To Be Predicted | Examples of Potential Application Reactions |
|---|---|---|
| Tele-operated | Data rate, latency, reliability | Change route, park vehicle, hand over to nearby driver, |
| driving | | change sensor set/properties, change teleoperation mode |
| | | (e.g. from manoeuvring to trajectory provision). |
| High-density | Latency, reliability | Change inter-vehicle distance, hand over to driver, change |
| platooning | | platoon speed or length, terminate platoon. |
| Hazardous | Reliability | Inform user about availability of warning service, change |
| location warning | | speed, change route. |
| Lane merge | Latency, reliability | Change speed of merging attempt, abort lane merge. |
| Software update | Data rate | Reschedule, stop or resume download. |
| Infotainment | Data rate | Change video quality |

Given this gap in predictive QoS services, the present disclosure provides relevant applications, use cases, and scenarios, for which this gap is prominent.

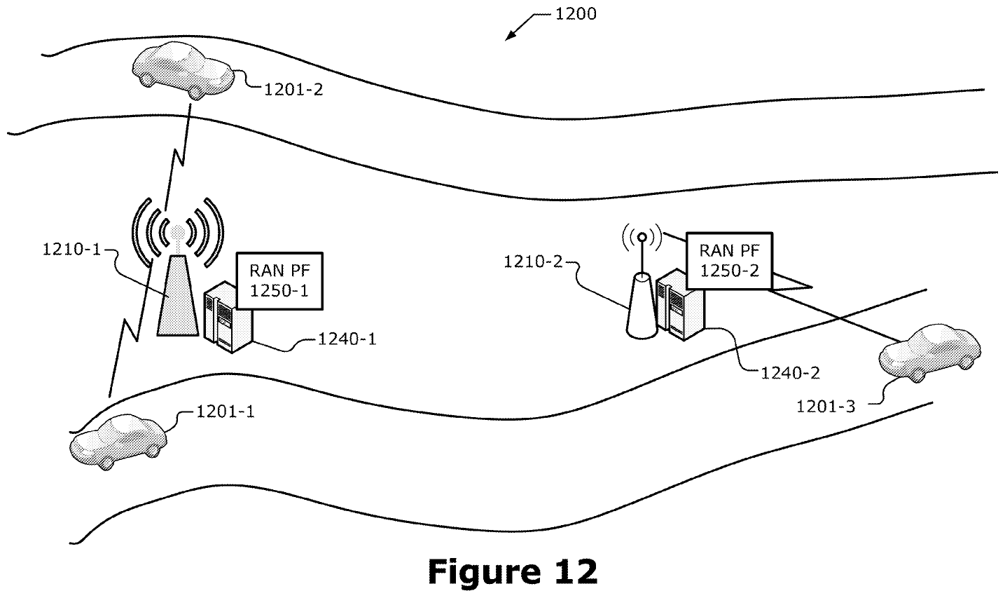

FIG. 13 depicts an example scenario 1300 of HD map data collection, consolidation, and distribution according to various embodiments. In FIG. 13 like numbered elements are the same as discussed elsewhere in the present disclosure.

A first use case example for FIG. 13 involves Real-time Situation Awareness using High-Definition (HD) Maps. In this example use case, participant nodes (actors) and their roles include client applications running in vehicles 1201, client applications running in NANs 1210 (e.g., smart RSUs), and host applications running in the edge nodes 1240. The client applications in vehicles that process sensory (sensor) data (e.g., cameras, radar, LiDAR, etc.) to collect their environmental perception and achieve real-time situation awareness, upload relevant perception and situation awareness data to the host application side, which is the application running in distributed edge nodes; and download HD map data that was consolidated in the distributed edge nodes.

In various implementations, the NANs 1210 (e.g., smart RSUs) are located in or nearby road segments and intersections. The NANs 1210 (e.g., smart RSUs and/or client application running in NANs 1210) are equipped with edge computing and sensors (e.g., cameras, radar, LiDAR, etc.) to also collect their own environmental perception. The client application running in NANs 1210 (e.g., smart RSUs) collect information from V2X messages transmitted by multiple road participants in or nearby the intersection or road segment where they are located. The host applications running in the edge nodes 1240 receive perception and situation awareness data from multiple vehicles 1201, NANs 1210, and other road participants (e.g. Vulnerable Road Users (VRUs), IoT devices, and/or the like). The host applications running in the edge nodes 1240 process and consolidate the data, prepare the layers of the HD map, and exchange data with other (e.g., neighboring) edge compute nodes 1240. The host applications running in the edge nodes 1240 disseminate/distribute the HD map layers via push or pull procedure(s) to the vehicles 1201, NANs 1210, and/or other road participants in a relevant geographical area.

For example, multiple vehicles 1201, as well as NANs 1210 collect information about a potential hazard 1305 in an intersection (e.g., a broken or stopped vehicle, road damages, fallen objects, etc.), In this example, V-ITS-S 1201-1 collects perception data representative of object 1305 in its sensor(s) field of view (FoV) 1301. Due to the formation of traffic congestion in and near the intersection, many vehicles 1201 will provide perception and situational data at the same time and will also download updates of the real-time HD map. Eventually, the network and radio QoS conditions in the vicinity and in the intersection may degrade. Additionally, the edge nodes 1240 may get overloaded with computing tasks/workloads. In these cases, edge computing (e.g., MEC) PoPs optimization may be required (e.g., relocating/migrating Virtual Machines (VMs) and/or containers of a MEC App to other MEC servers 1240 in the system, or simply performing a VM scale-up of the MEC App in the same MEC server 1240).

In this type of application, both the vehicle app and the MEC App may periodically request extended radio, edge, cloud IQNs (e-IQNs) in order to maintain a constant/periodic updates of the HD maps with real-time data. Eventually, an action might be taken by the vehicle 1201 or a recommendation might be provided by the MEC App on how to proceed. As a simple alternative, journey re-routing may be taken by a vehicle 1201 to avoid the problematic intersection, which may release (free up) radio and network resources in the area's vicinity, and also free up corresponding computational resources (e.g., at the edge compute nodes 1240). As a result, the e-IQN information may be useful to optimize MEC PoPs.

A second use case example for FIG. 13 involves combined distributed dynamic road Traffic Management™ with real-time remote support for automated driving. In this example use case, participant nodes (actors) and their roles include client applications running in vehicles 1201 and host applications running in the edge compute nodes 1240.

The client applications running in vehicles 1201 combine automated driving functionality with a data exchange module to interact with dynamic distributed road traffic management entities as well as the processing of instructions received in real-time from the remote driving support. The client applications running in vehicles 1201 also upload relevant perception and situation awareness data to the host application in the edge node, and receive maneuver instructions and/or real-time route information from the host applications running in the edge compute nodes 1240.

The host applications running in the edge nodes 1240 receive the perception and situation awareness data from multiple vehicles 1201 in their respective coverage areas (or respective service areas), perform local dynamic traffic management, and prepare for the remote support of the automated driving functions. The host applications running in the edge compute nodes 1240 distribute (e.g., provide for transmission and/or broadcast by the NANs 1210) in real-time route and maneuver instructions to the vehicles in the concerning area.

In this example use case, the distributed edge compute nodes 1240 take over the combined task of monitoring and controlling the road traffic in real time, as well as supporting the automated driving of the vehicles 1201 by providing specific routes as well as maneuvers to be performed. The distributed edge compute nodes 1240 are interconnected and also connected to centralized regional road traffic management entities. In some situations, there may appear some bottlenecks in terms of radio and network QoS as well as computing resources if many vehicles 1201 converge to a certain geographic area, or because some specific road traffic event happened (e.g., appearance of object 1305 in the roadway). Also in these cases, a MEC PoPs optimization may be required or desired (e.g., to relocate/migrate the VMs, containers, etc., of a MEC App to other MEC servers 1240 in the system, or simply performing a VM or container scale-up of the MEC App in the same MEC server 1240).

The usefulness of network performance predictions for stakeholders other than application consumers is discussed in Cambridge Consultants, Intel Link Performance Predictor: delivering better service performance and improved network efficiency with predictive network and service characterization (2019) (hereinafter “[CCLPP]”), which states that application developers and network operators could both deliver better services, with more efficient use of the available network resources, if services have access to the predicted network performance over time. Breaking down traditional barriers between services and the networks that support them will allow service performance to be improved in ways that were previously not possible. This will lay the path to more efficient network utilization. [CCLPP] also states that quality of service is traditionally associated with network performance metrics. Like speed limits on roads, static network performance metrics only provide a partial, often incorrect, and at best indicative, view of the experienced quality. Following the Google Traffic analogy, by gaining access to current and predicted network performance, drivers (or their satnav route planner) can adjust their route to optimize their experience. Likewise, many services could adjust their mode of operation if they have advance warning regarding any significant changes in expected network performance. Nevertheless, so far only network performance is considered for the predictions.

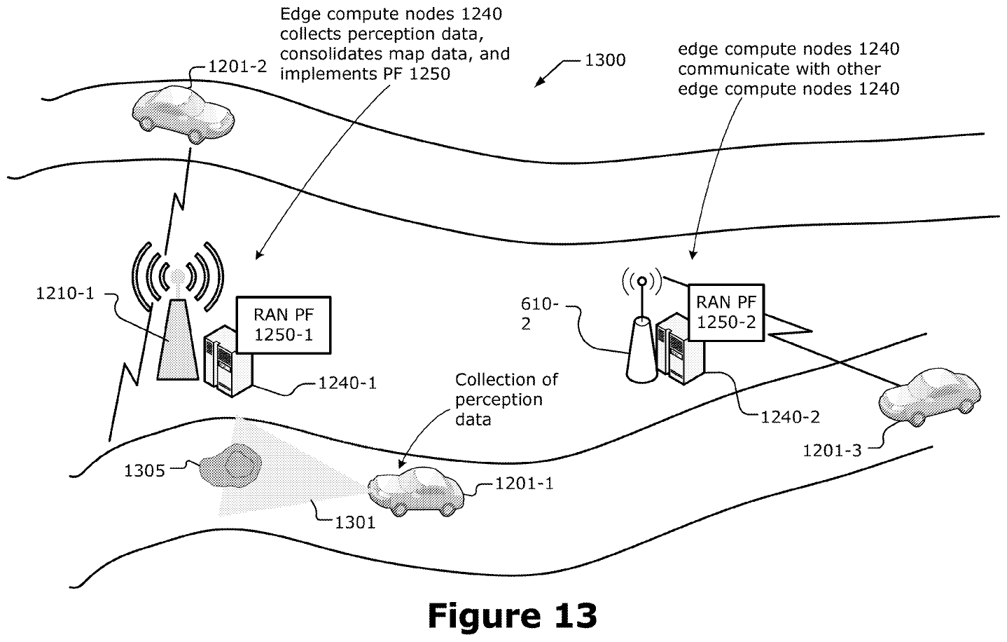

Additionally, in FIG. 14, the role and exploitation of IQNs for a C-V2X application is visually clarified (see e.g., [5GAAWG2]. Also, FIG. 14B shows the overall structure of a generic In-advance QoS Notification (see e.g., 5GAA TR 191007_2, “5G Automotive Association; Working Group System Architecture and Solution Development; Architectural Enhancements for Providing QoS Predictability in C-V2X v. 2.0” (hereinafter “[5GAATR]”)). In Section 4 of [5GAATR], the predicted Key Performance Indicator (KPI) attribute (data element/field/IE) of the message structure in FIG. 14B includes a KPI, which can be the latency, reliability, packet delivery ratio, throughput, User Plane (UP) connection, network utilization, delay variation (jitter), availability (of the communication service), and/or accuracy. None of the mentioned metrics focuses on the availability of edge cloud processing, memory and/or storage resources.

In addition, similar to the 5GAA references mentioned above, [MEC030] has specified a resource data type called PredictedQos. This data structure, reproduced in Table 6.2.5-1, is sent to the VIS service consumer following its request on journey specific QoS predictions. Based on Table 6.2.5-1, the only radio signal quality-specific attributes and their values are included in the response message.

TABLE 6.2.5-1
Attributes of the PredictedQos

| Name | Data type | Cardinality | Remarks |
|---|---|---|---|
| timeGranularity | TimeStamp | 0 . . . 1 | Time granularity of visiting a location. |
| locationGranularity | String | 1 | Granularity of visited location. Measured in meters. |
| routes | Structure (inlined) | 1 . . . N | Information relating to the potential routes of a |
| | | | vehicular UE. |
| >routeInfo | Structure (inlined) | 2 . . . N | Information relating to a specific route. |
| | | | The first structure shall relate to the route origin and |
| | | | the last to the route destination. Intermediate |
| | | | waypoint locations may also be provided. |
| >>location | LocationInfo | 1 | Vehicular UE location. |
| >>time | TimeStamp | 0 . . . 1 | Estimated time at the location. |
| >>rsrp | Uint8 | 0 . . . 1 | RSRP as defined in [TS36214], [TS38215] only |
| | | | included in the response. |
| >>rsrq | Uint8 | 0 . . . 1 | RSRQ as defined in [TS36214], [TS38215] only |
| | | | included in the response. |

NOTE:
The data type of locationGranularity is a string which indicates the granularity of a visited location by means of latitudinal and longitudinal margins.

In the current solutions discussed above, only V2X applications (e.g., MEC Apps and Client Apps) receive such notifications with the aim to take proper actions/countermeasures prior to signal quality degradation. Predictive QoS information is not accessed by MEC service providers, and therefore, it cannot be used for MEC PoP optimization per a performance (or cost) criterion. Also, the payload message of IQNs, as described in [5GAATR] only includes attributes related to performance metrics tightly related to radio signal quality, thus, only reflecting the RAN and CN parts of an radio access system. Predictions of the expected availability of MEC processing, storage and memory resources are neither performed, nor included to the state-of-the-art IQN message

Given these potential issues and other potential issues, how can ITS/V2X application and/or service providers utilize QoS predictions to optimize edge PoPs and proactively provision computational, memory, and/or storage resources when and where needed? Efficient utilization of radio QoS predictions by an application (running on an edge compute nodes 1240 such as a MEC platform) or service provider is not a trivial task, as predictions are obtained from PFs 1250 that are designed, managed and maintained by different entities or stakeholders (e.g., MNOs, edge computing service providers, etc.), which means that predictive QoS notifications may not be always accessible in an interoperable manner.

Various embodiments discussed herein enhance the definition of predicted QoS notification, currently focusing only on mobile communications-specific performance metrics relevant to the NANs 1210 and CNs by also including predictions of edge cloud computational resources. This cross-domain set of information is referred to herein as extended In-advance QoS Notifications (e-IQNs). The e-IGNs may be exploitable by multiple actors, such as vehicles OEMs, fleet operators, MaaS, and edge computing (e.g., MEC) service providers.

The embodiments herein provide a signaling framework that allows e-IQNs to be accessible by edge computing (e.g., MEC) apps and service providers in an interoperable manner. These embodiments may exploit a V2X API to provide interoperability. The term “interoperability” refers to the ability of computing systems utilizing one access technology (or RAT) to communicate with computing systems utilizing another access technology (or RAT). The embodiments herein also include processes/schemes for edge (e.g., MEC) PoP optimization using the e-IQN as input and involving edge computing orchestration (e.g., MEC Orchestrators (MEO)) across one or more geographic areas.

The embodiments herein may be adopted in various standards such as 5G Automotive Association (5GAA) standards, ETSI standards, 3GPP standards, GSMA standards, and/or the like. The embodiments herein can also be implemented using various communication means including, for example, API-based signaling incorporating the e-IQN data types.

The embodiments herein provide various improvements to computing systems and networks including data center, mobile networks (including 5G), and roadside equipment (RSE), and in particular, to technologies used to provide V2X, ITS, and smart city services. Also, MaaS and MEC service providers, vehicle OEMs and fleet management companies may benefit from the exposure of joint radio/signaling QoS and processing, memory, storage resource availability predictions. This is because proactive and focused deployment of edge applications and services at areas of high service demand, high radio signal quality and edge computing resources (e.g., data processing, memory, storage, etc.) availability will result in lower incurred costs and improved resource utilization efficiencies as compared to deployments taking place uniformly in space and in time without taking QoS and edge computing resource fluctuations into consideration.

### 3.1. Example e-IQN Configurations and Arrangements

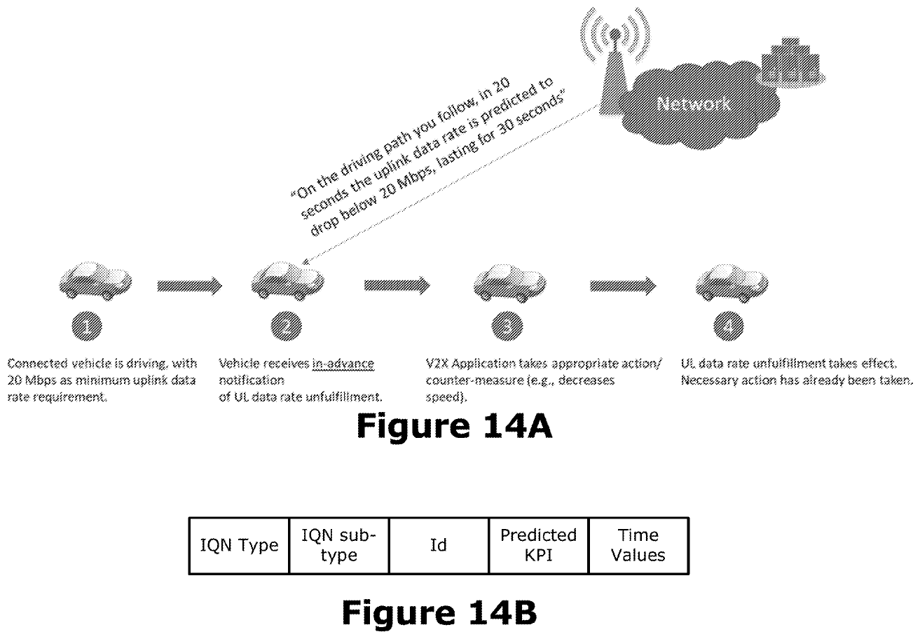

FIG. 15 depicts an exemplary scenario 1500 for practicing the embodiments herein. Scenario 1500 involves a client automotive/mobility App 1518 instantiated at a V-ITS-Ss 1501 requesting radio signal quality and edge host resource availability predictions to reach a decision (e.g., upon task offloading along a planned journey). Scenario 1500 may have a same or similar set up/arrangement as scenario 1200 of FIG. 12 and/or scenario 1300 of FIG. 13, and includes the following system entities:

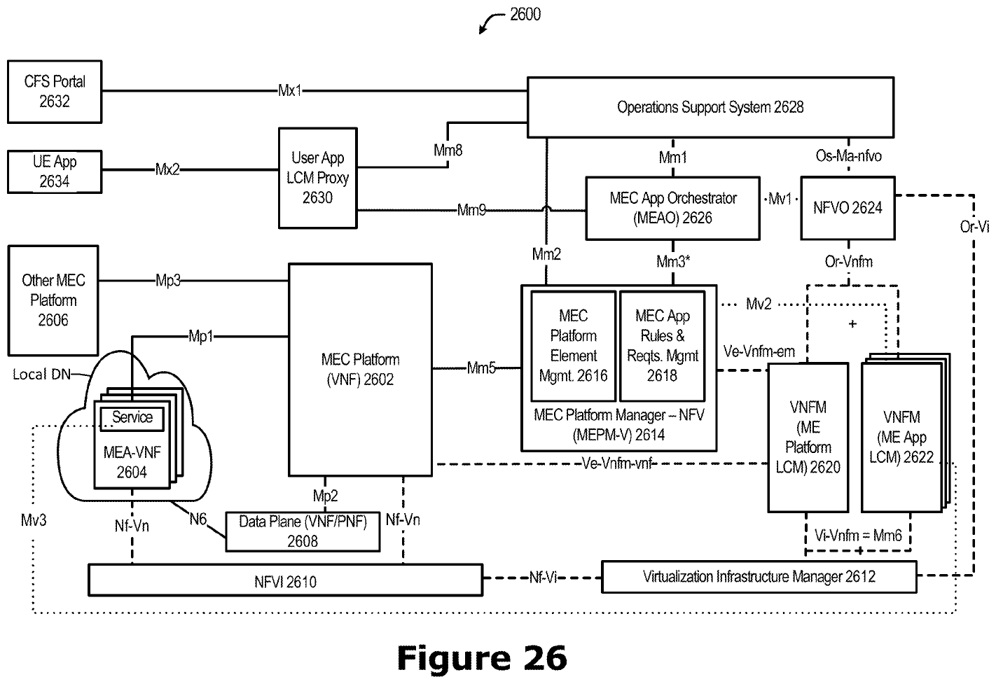

A Client App 1518 instantiated at the computing unit in the V-ITS-S 1501. The V-ITS-Ss 1501 contains associated communications hardware/circuitry as discussed herein (see e.g., FIGS. 27-31). In another embodiment, any road users, such as motorcycles or Vulnerable Road Users (VRUs) such as cyclists, pedestrians, etc. are equipped with a corresponding embedded unit or handheld/wearable device hosting the Client App 1518. Client app 1518 running on the V-ITS-S 1501, which is camping on NAN 1510, reports its planned journey information (e.g., map coordinates, route/navigation data, GNSS/GPS data, etc.) to a MEC Host 1540. A corresponding instantiated MEC App 1526 runs in computational resources (e.g., virtualization infrastructure) at the data network near or at a MEC platform 1532 (e.g., as part of a MEC host 1540 collocated with NAN 1510). MEC app 1526 and client app 1518 exchange data over interface 1519. In embodiments, the NAN 1510 may include WLAN, WWAN, cellular, and/or other RAT circuitries to provide local and/or wide area APs, act as a cellular base station (e.g., eNB, ng-eNB, gNB, etc.), RSU/Road Side Equipment (RSE), and/or the like.

V-ITS-S 1501 may be the same or similar as V-ITS-Ss 101, 201, 301, and 1201 discussed previously, and Client App 1518 may be the same or similar as UE App 202 or 2518 of FIGS. 2 and 25, respectively). NAN 1510 may be the same or similar as NAN 110, 210, and 1210 discussed previously. MEC Host 1540 may be the same or similar as MEC host 140, 240, 340, 1240, and 2502 discussed herein, MEC platform 1532 may be the same or similar as MEC platform 2532, and MEC app 1526 may be the same or similar as MEC app 2526 discussed herein.

A V2X Information Service (VIS) 1580 is exposed between producing and consuming entities via a V2X API. The VIS 1580 may be the same or similar as the MEC VIS 280 discussed previously. In embodiments, the VIS 1580 consumes E-IQN requests and provides E-IQN responses 1582 via V2X API (which may be referred to as V2X API 1582).

The RAN Prediction Function (PF) 1550 is a functional block responsible for predicting radio signal quality at specific vUE locations and times of interest. The RAN PF 1550 may be the same or similar as RAN PFs 1250 discussed previously. The predicted radio signal quality may be determined/predicted based on various Machine Learning (ML)/AI models. In embodiments, the RAN PF 1550 consumes/provides signal quality prediction requests/responses 1551 via an interface with the VIS 1580 (which may be referred to as interface 1551).

A Cloud PF 1554 is a functional block responsible for predicting edge resource availability at specific edge cloud deployment locations and times of interest. The predicted edge resource availability may be determined/predicted based on various ML/AI models. In embodiments, the Cloud PF 1554 is assumed reachable by multiple MEC Orchestrators (MEOs) (see e.g., MEO 2510 of FIG. 25) by a proper/suitable interface. In embodiments, the Cloud PF 1554 consumes/provides edge resource availability prediction requests/responses 1555 via an interface with the VIS 1580 (which may be referred to as interface 1555). Additionally, the RAN PF 1550 and Cloud PF 1554 may coordinate with one another over a ranPF-cloudPF interface 1553. This coordination may take place periodically or in response to suitable trigger events, and/or may take place “offline.”

In some embodiments, ML/AI models of the RAN PF 1550 and/or the Cloud PF 1554 is a neural network or another ML/AI structure, which predict signal/radio quality at a given time and/or location (RAN PF 1550) or the availability of processing resources given a user load under MEC coverage (Cloud PF 1554).

In an example implementation, the MEC host 1540, MEC platform 1532, RAN PF 1550, and Cloud PF 1552 are provided by an edge computing/network provider, the V-ITS-S 1501, client app 1518, MEC App 1526 are provided by a vehicle/car OEM, and NAN 1510 is provided by a MNO. In another example embodiment, the NAN 1510, MEC host 1540, MEC platform 1532, RAN PF 1550, and Cloud PF 1552 are provided by the same MNO/edge service provider.

In various embodiments, the definition of QoS prediction notifications is enhanced. Currently, IGNs are only based on communications network information (e.g., RAN and CN related). In embodiments, IQNs are enhanced/extended to include information on edge compute node and/or edge cloud computational resource predictions. This set of information is referred to herein as enhanced in-advance QoS Notification (e-IQN) information and the like. The current ETSI MEC V2X API [MEC030] and [5GAAWG2] standards may be extended/updated to enhance/extend IQNs in this manner.

In some embodiments, the PredictedQos data type is updated as an extension of the current ETSI MEC V2X API [MEC030] To address the need for holistic, multi-domain predictions to be consumed by different parties/stakeholders in a V2X networks, the PredictedQos data type of Table 6.2.5-1 in [MEC030] is enhanced as shown by Table 6.2.5-1x.

TABLE 6.2.5-1x
Attributes of the PredictedQos

| Name | Data type | Cardinality | Remarks |
|---|---|---|---|
| timeGranularity | TimeStamp | 0 . . . 1 | Time granularity of visiting a location. Measured in |
| | | | seconds. |
| locationGranularity | String | 1 | Granularity of visited location. Measured in meters. |
| routes | Structure (inlined) | 1 . . . N | Information relating to the potential routes of a |
| | | | vehicular UE. |
| >routeInfo | Structure (inlined) | 2 . . . N | Information relating to a specific route. |
| | | | The first structure shall relate to the route origin and |
| | | | the last to the route destination. Intermediate |
| | | | waypoint locations may also be provided. |
| >>location | LocationInfo | 1 | Vehicular UE location. |
| >>time | TimeStamp | 0 . . . 1 | Estimated time at the location. |
| >>rsrp | Uint8 | 0 . . . 1 | RSRP as defined in [TS36214], [TS38215]; only |
| | | | included in the response. |
| >>rsrq | Uint8 | 0 . . . 1 | RSRQ as defined in [TS36214], [TS38215]; only |
| | | | included in the response. |
| >>availProcPower | Integer | 0 . . . 1 | Available processing power of the MEC host closest |
| | | | to the corresponding vehicular UE location. Measure |
| | | | in GigaFLOPS (GFLOPS). |
| | | | Shall only be included in the response. |
| >>availMemory | Integer | 0 . . . 1 | Available memory of the MEC host closest to the |
| | | | corresponding vehicular UE location. Measured in |
| | | | Gigabytes (GB). |
| | | | Shall only be included in the response. |
| >>availStorage | Integer | 0 . . . 1 | Available storage resource of the MEC host closest to |
| | | | the corresponding vehicular UE location. Measured in |
| | | | Terabytes (TB). |
| | | | Shall only be included in the response. |

NOTE:
The data type of locationGranularity is a string which indicates the granularity of a visited location by means of latitudinal and longitudinal margins.

The PredictedQos data type represents the predicted QoS of a vehicular UE. This information is per UE potential route based. The attributes of the PredictedQos follow the notations provided in Table 6.2.5-1x. Table 6.2.5-1x shows the additional attributes of the PredictedQos data type of the ETSI MEC V2X API to form an e-IQN message.

In some embodiments, the overall IQN message structure as discussed in [5GAAWG2] is updated. In these embodiments, the list of possible performance metrics indicated by the “Predicted KPI” field/attribute of the IQN message structure appearing in FIG. 14B is enhanced/extended to include the following additional metrics: processing resources (e.g., processing power) measured in, for example, Gigaflops (GFLOPS); memory resources measured in, for example, gigabytes (GB); storage resources measured in, for example, terabytes (TB). A gigaflop is a unit of measurement used to measure the performance of a computer's floating point unit (FPU). One gigaflops is one billion floating point operations (FLOPs) per second.

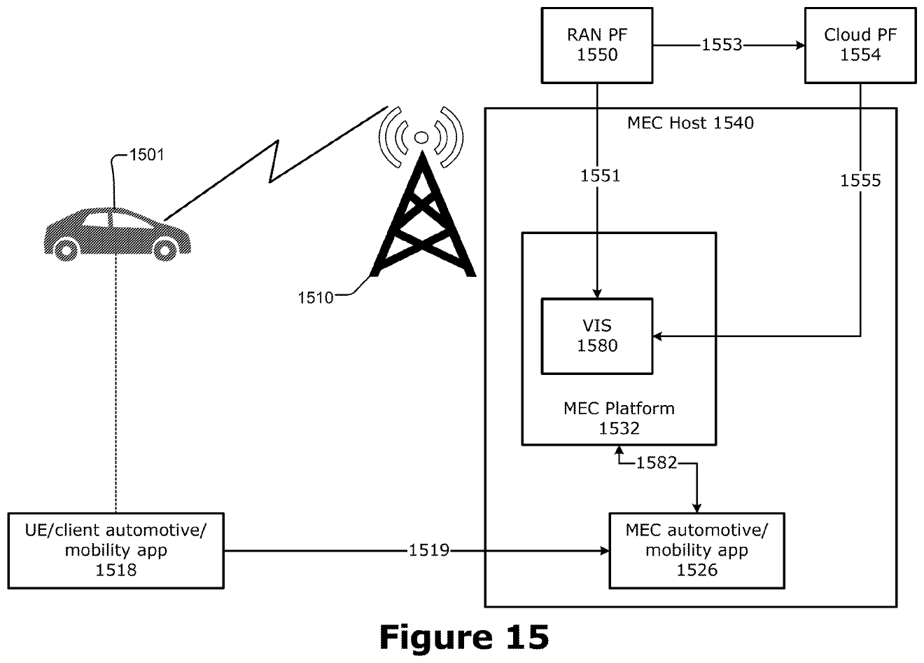

Additionally, embodiments include a signaling framework to ensure that e-IQNs are accessible by edge computing providers (e.g., MEC service providers) in an interoperable manner. In these embodiments, the V2X API may be exploited and/or enhanced. Based on the above, and assuming two different e-IQN consumers, an example of such a signaling framework is shown and described by FIG. 16.

FIG. 16 shows logical interactions among the various entities discussed with regard to FIG. 15, according to various embodiments. FIG. 16 includes e-IQN communications between different e-IQN consumers (e.g., a MEC App 1526 corresponding to a V2X application instantiated at a vUE 1501) and e-IQN producers (e.g., MEC App 1526 owned/managed by a car OEM/service provider). In this example, a first e-IQN consumer (e-IQN consumer 1) is a MEC App 1526 associated with a Client App 1518 running at a vUE 1501, which is the primary beneficiary of e-IQN information; and a second e-IQN consumer (“e-IQN consumer 2”) is another MEC App 1526 owned/managed by a service provider (e.g. vehicle OEM, a fleet manager, enterprise, etc.).

The procedure starts at step 1601 where a request for journey-specific predicted QoS is sent by Client App 1518 to the e-IQN consumer 1 (MEC App 1526), and at step 1602a an e-IQN request is sent to (VIS 1580 by e-IQN consumer 1. This e-IQN request includes (updated) route waypoints (locations) and their expected/predicted visit times. Additionally or alternatively, an e-IQN request can be sent by the e-IQN consumer 2 at step 1602b. This e-IQN request includes edge service deployment data, geolocation data of the edge node deployments, and time of interest. Both e-IQN consumers 1 and 2 are MEC Apps 1526 consuming the MEC VIS 1580 through the MEC V2X API. The e-IQN request at 1602a, with all input attributes/parameters, is forwarded by the e-IQN consumer 1 to the VIS 1580 by exploiting the V2X API.

At step 1603a, the VIS 1580 provides the e-IQN request(s) (e.g., from e-IQN consumer 1 and/or 2) and route information by other V2X apps to the RAN PF 1550. At step 1604a, the VIS 1580 obtains radio e-IQN attributes from the RAN PF 1550. The radio e-IQN attributes indicate predicted radio signal quality along the predicted/estimated route.

At step 1603b, the VIS 1580 provides the e-IQN request(s) (e.g., from e-IQN consumer 1 and/or 2) to the Cloud PF 1554. At step 1604b, the VIS 1580 obtains edge/cloud e-IQN attributes related to compute, storage, and/or network resources at edge nodes and/or cloud service(s) from the Cloud PF 1554.

Table 7.2.1 in [MEC030] only foresees the POST method for predicted QoS retrieval. Nevertheless, in embodiments, this may be updated to a GET method, in order to correctly reflect the fact that predicted QoS information is retrieved from the VIS 1580, and not pushed into the VIS 1580. Additionally, a dual message (POST) related to the insertion of this information into the VIS 1580 resource tree may be used.

The communication between VIS 1580 and prediction functions (RAN PF 1550 and Cloud PF 1554) can be realized in general with any type of protocol. This protocol (or combination of protocols) may or may not be standardized by, for example, ETSI MEC. The re-usage of existing HTTP queries in the VIS 1580 for the VIS-PF link may be used in one embodiment. Additionally or alternatively, the communication over may take place over the Mp1. Additionally or alternatively, the PFs (RAN PF 1550 and Cloud PF 1554) can be implemented as well as MEC Apps 1526, the POST message specified in ETSI MEC is valid, and simply an additional GET message can be introduced as needed.

Each of the two PFs (RAN PF 1550 and Cloud PF 1554) can also receive also other inputs in parallel. For example, the RAN PF 1550 may be concurrently collecting route information from other V2X Apps (e.g., over 1603a), which may allow the anticipated per-UE allocated radio resources over a given area at a given time window to be inferred. In another example, the Cloud PF 1554 may simultaneously obtain other MEC Orchestrator (MEO) and/or 5G system (5GS) inputs, such as MEC host capacity, backhaul connection status, network function data, and/or other like information/data.

After predictions are yielded by RAN PF 1550 and Cloud PF 1554, each of RAN PF 1550 and Cloud PF 1554 provide the corresponding attributes of the e-IQN message via the V2X API to the e-IQN consumer at operations 1604a and 1604b. For example, at operation 1604a the RAN PF 1550 provides e-IQN attributes on radio signal and network quality along the V-ITS-S's 1501 journey/route to e-IQN consumer 1 (e.g., MEC App 1526 corresponding to a V2X App 1518 executed at the V-ITS-S's 1501) in response to the request at 1602a. Additionally or alternatively, at operation 1604b the Cloud PF 1554 provides e-IQN attributes on available edge and/or cloud computing resources over a service deployment area in response to the request from e-IQN consumer 2 at 1602b. Additionally or alternatively, at operation 1604a the Cloud PF 1554 can provide e-IQN attributes on available edge and/or cloud computing resources along the V-ITS-S's 1501 journey/route in response to a request of e-IQN consumer 1 (e.g., if requested at 1601 and 1602a).

Once both domains' e-IQN prediction attributes are collected by the VIS 1580, the VIS 1580 concatenates the e-IQN prediction attributes to form a single compound e-IQN response message to be sent to the requesting e-IQN consumer 1 or 2 via the V2X API at operations 1605a and 1605b. Here, the e-IQN prediction attributes related to radio characteristics are provided to the e-IQN consumer 1 at step 1605a, and the e-IQN prediction attributes related to edge/cloud characteristics are provided to the e-IQN consumer 2 at step 1605b. Furthermore, at 1606, coordination between the RAN PF 1550 and the Cloud PF 1554 takes place independent of the other operations/steps of the procedure.

In some embodiments, the two phases of the communication (e.g. the retrieval of predictions from individual PFs and the concatenation/combination of e-IQN attributes) can be asynchronous and done at separated moments in time. In some implementations, the individual e-IQN prediction attributes from different PFs can be buffered as they are received, and concatenated or otherwise combined as needed (e.g. due to the predictions are generated with different periodicities and different phase offsets). Thus, the messages in FIG. 16 should not be necessarily seen as strictly consequential.

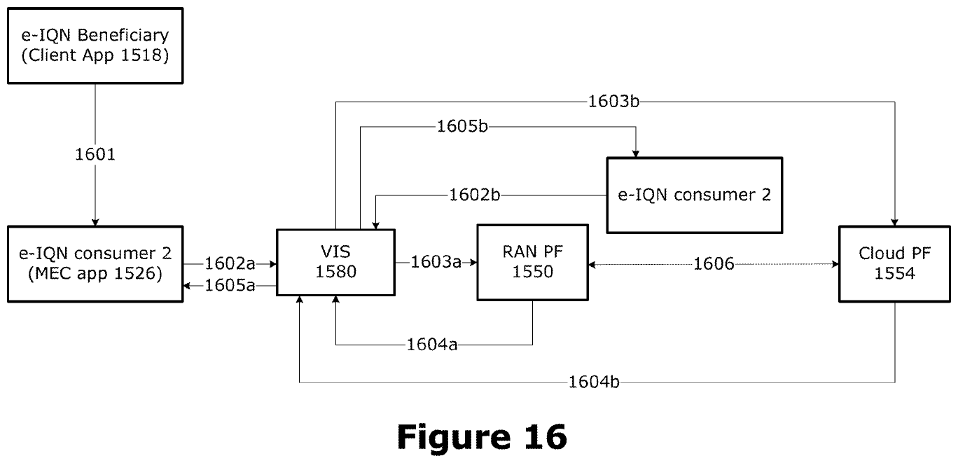

FIG. 17 depicts an example procedure 1700 for journey-aware e-IQN request and response according to various embodiments. Procedure 1700 includes participation by e-IQN consumer 1 and the e-IQN beneficiary from the example of FIG. 16, where the e-IQN beneficiary (e.g., client App 1518) and/or the e-IQN consumer (e.g., MEC App 1526) requests feasibility of application offloading at the edge for a given route and given journey times. Procedure 1700 may operate as follows:

At step 1, the e-IQN beneficiary requests the feasibility of application offloading (REQ off.) at the network edge for a given route at particular journey times. At step 2, the e-IQN consumer 1 sends an e-IQN request (REQ) for the planned route via the V2X API.

At step 3a, the VIS 1580 forwards REQ for radio signal quality/conditions along the route (e.g., at various waypoints along the journey) to the RAN PF 1550. At step 4a, the RAN PF 1550 implements one or more prediction algorithms, taking into account all planned routes of various V-ITS-Ss 1501. At step 5a, the RAN PF 1550 provides an radio e-IQN response (RESP) to the VIS 1580 including the predicted radio signal quality/conditions.

At step 3b, the VIS 1580 forwards REQ for edge and/or cloud compute capabilities and resources (REQ edge/cloud e-IQN) along the route (e.g., at various waypoints along the journey) to the Cloud PF 1554. At step 4b, the Cloud PF 1554 implements one or more prediction algorithms, taking into account all V-ITS-S, MEO, and 5GS inputs. At step 5b, the Cloud PF 1554 provides an edge/cloud e-IQN RESP to the VIS 1580 including the predicted edge/cloud capabilities and resource predictions. Steps 3b, 4b, and 5b may take place subsequent to, or simultaneous with steps 3a, 4a, and 5a.

At step 6, the VIS 1580 concatenates the e-IQN attributes from the RAN PF 1550 and the Cloud PF 1554 into a single response message. At step 7. the VIS 1580 sends an e-IQN RESP with all attributes/parameters to the e-IQN consumer via the V2X API. At step 8, the e-IQN consumer forwards the e-IQN predictions to the e-IQN beneficiary. At step 9, the e-IQN beneficiary (e.g., client app 1518) makes an offloading decision based on communicated cross-domain predictions.

In some embodiments, a trigger is the client app 1518 in the vehicle 1501, which is a V2X Application (see e.g., 3GPP TS 23.885) asking info to take a decision on application offloading at the edge compute node. As shown, at the end of the communication cycle, the provided e-IQN message not only includes the predicted performance of the communication network, but also the resource availability of MEC PoP (e.g., edge servers). Based on this compound information, the V2X App can proactively take a task offloading decision, based on the acquired predictions (e.g., the e-IQN information). The procedure of FIG. 17 is just an example, as, in some other cases, the e-IQN request can be triggered directly by the MEC App 1526, without explicit request from vehicles 1501 or client (V2X) apps 1518.

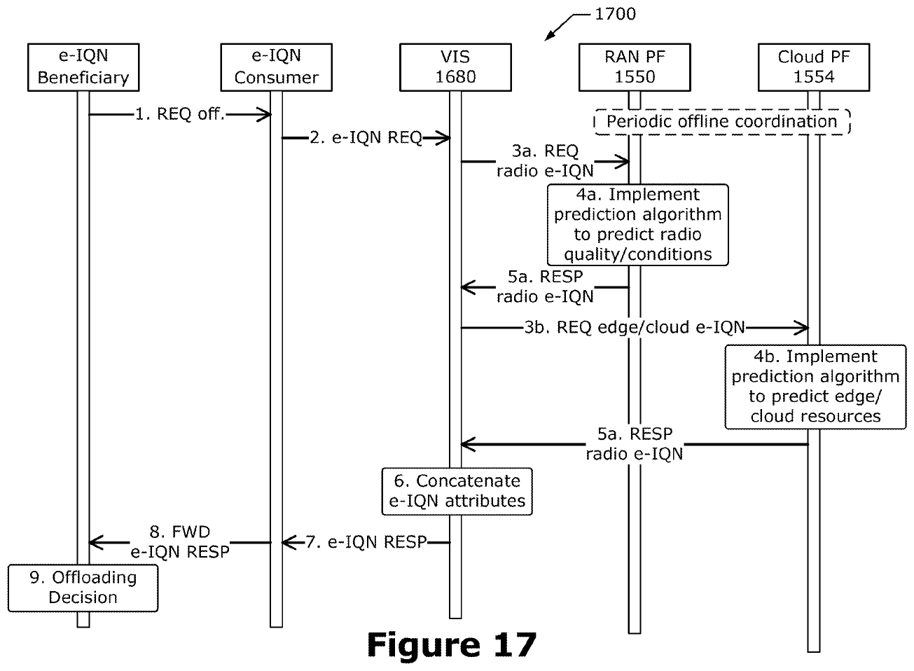

FIG. 18 depicts an example procedure 1800 of journey-aware e-IQN request and response, according to various embodiment, where the e-IQN consumer (e.g., a MEC App after being triggered by a corresponding Client App running at a vehicular UE) requests the feasibility of application offloading at the edge for a given route and given journey times. Procedure 1800 may operate as follows:

As a precondition of procedure 1800 all attributes of the e-IQN response message have been obtained by the VIS 1580 and forwarded to the e-IQN consumer (e.g., the requesting MEC app 1526). Procedure 1800 begins at step 1 where the MEC platform 1532 provides e-IQN attributes on available edge resources along route (originating from the VIS) to the MEPM 1806 (e.g., which may be the same or similar as MEPM 2506 of FIG. 25) via the Mm5 reference point. At step 2, the MPEM 1806 sends e-IQN attributes on available edge resources along route (originating from the VIS) are provided to the MEC Orchestrator (MEO) 1810 (e.g., which may be the same or similar as MEO 2510 of FIG. 25) via the Mm3 reference point. At step 3, the MEO 1810 determines edge/cloud resources. In one example, the MEO 1810 matches route waypoints to deployed MEC hosts, identifies resource bottlenecks at the MEC hosts, and suggests a VM migration policy to be implemented to specific MEC hosts and times. At step 4, the MEO 1810 forwards policy regarding edge/cloud resources (e.g., including VM migration policies) to the VIM 1808 (e.g., which may be the same or similar as VIM 2508 of FIG. 25) of the MEC system via the Mm4 reference point. At step 5, the VIM 1808 implements the policy if there are enough resources; otherwise, marks it as infeasible and informs the MEO 1810 accordingly. At step 6, the client app 1518 initially associated with the e-IQN consumer (e.g., MEC app 1526) instantiated at a certain MEC host will decide upon MEC App instance migration to a different MEC host of the MEC system, which has been identified by the MEO 1810.

### 3.2. Edge Computing PoP Optimization Embodiments

As mentioned previous, embodiments also include edge Point-of Presence (PoP) optimization scheme taking as input the e-IQN information, involving Edge Orchestrators (e.g., MEOs) across a geographic area(s). In these embodiments, the obtained e-IQN information is exploited to proactively optimize the PoPs of both the MEC system the e-IQN consumer (that is, a MEC App, triggered, e.g., by a Client App at a vehicular UE) is instantiated/attached to, as well as the PoPs of neighboring/adjacently deployed federated MEC systems involved in a planned vehicle route.

### 3.2.1. Intra-MEC System MEC PoP Optimization

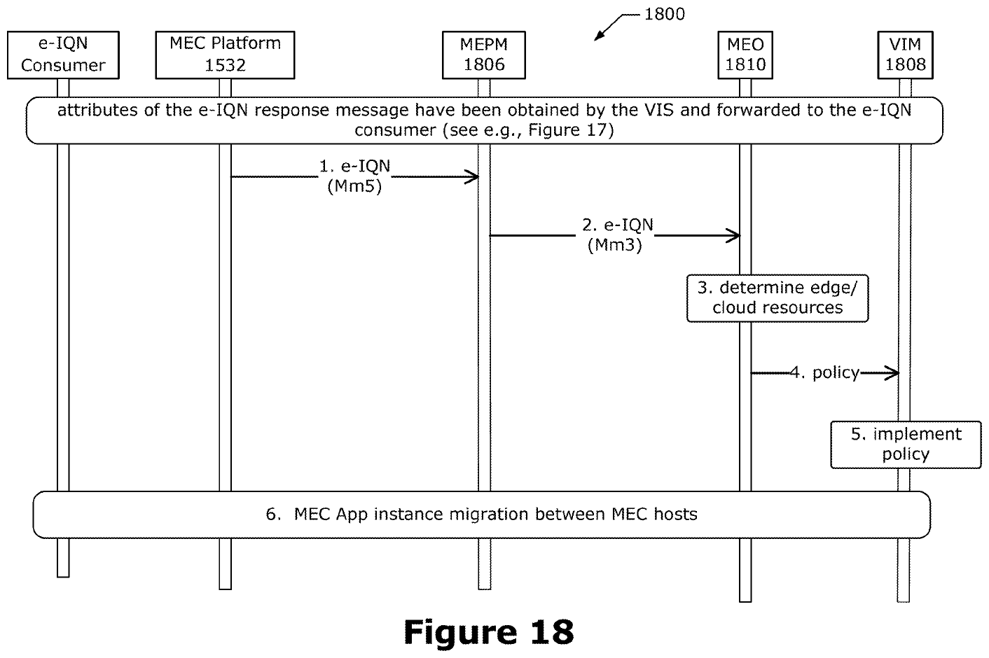

In these embodiments, e-IQNs are able to be forwarded by the MEC platform providing the VIS to the system's MEO via the MEC Platform Manager (MEPM) (see e.g., MEPM 2506 of FIG. 25). Then, the system's MEO, to ensure that the service QoS is satisfied at the focused time window, identifies resource bottlenecks at MEC hosts of the MEC system along the vehicle's planned route and suggests a VM migration policy to be implemented at specific MEC hosts and times. The policy is forwarded to the Virtualized Infrastructure Manager (VIM) (see e.g., MEPM 2508 of FIG. 25) of the MEC system, and if feasible, it is implemented right before the time of focus, otherwise it is marked as infeasible and the MEO is informed accordingly. Following these steps, the Client App, initially associated to a MEC App instantiated at a certain MEC host, will decide upon MEC App instant migration to a different MEC host, which has been identified by the MEO. Please note that “how the MEC PoP optimization is done by the MEO/VIM” is NOT the focus of the present invention. Instead, we introduce the needed framework, information exchange and message charts needed to enable this optimization. The optimization framework is explained in FIGS. 18 and 19 for the cases of the VIS being implemented as a MEC platform service or as a service-producing MEC App, respectively.

FIG. 19 depicts an example procedure 1900 for MEC PoP optimization scheme according to various embodiments. In this example, the MEC PoP optimization is triggered by an instantiated MEC App requesting journey-specific radio and edge cloud resource predictions within a MEC system. In this embodiment, the VIS is implemented as a MEC platform service. Procedure 1900 may have the same precondition as discussed previously with respect to procedure 1800. As a precondition of procedure 1800 all attributes of the e-IQN response message have been obtained by the VIS 1580 and forwarded to the e-IQN consumer (e.g., the requesting MEC app 1526). Procedure 1900 begins at step 1 where a MEC app 1526 producing the VIS 1580 provides e-IQN attributes on available edge resources along route to the MEC platform 1532 via the Mp1 reference point. Steps 3 to 7 in procedure 1900 may be the same as steps 2 to 6 of procedure 1800, respectively.

### 3.2.2. MEC PoP Optimization Across a MEC Federation

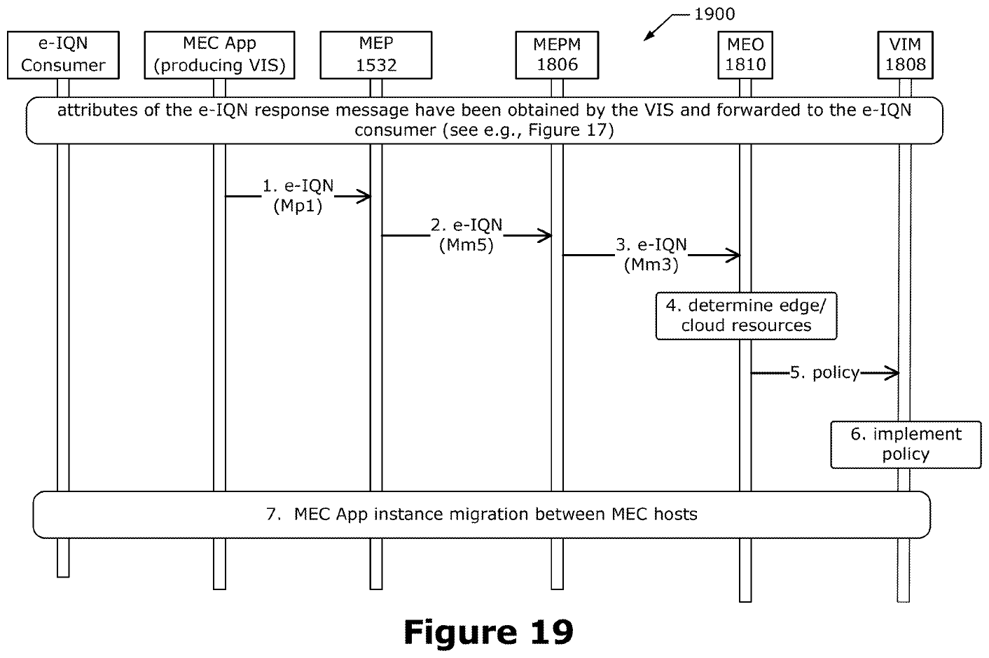

FIG. 20 depicts an example logical architecture 2000 for MEC PoP optimization according to various embodiments. The logical architecture 2000 includes two MEC systems (MEC system 1 and MEC system 2), each of which includes an OSS 2021 communicatively coupled with an MEO 2010 via an Mm1 reference point, and an MEPM 2006 communicatively coupled with the MEO 2010 via an Mm3 reference point. The logical architecture 2000 also includes a business & service layer 2001, which includes the OSSs 2021 of each MEC system and a federation manager 2025 for each MEC system (e.g., federation manager 2025-1 and federation manager 2025-2). Each federation manager 2025 is communicatively coupled with a respective MEO 2010 via an Mfm-fed reference point, which is a new reference point not defined by current ETSI standards. The MEC system(s) discovery includes security (e.g., authentication, authorization, system topology hiding, and encryption), charging, identity management, and monitoring aspects. In this example, the MEC PoP optimization is triggered by an instantiated MEC App requesting journey-specific radio and edge cloud resource predictions within a MEC system. In this embodiment, the VIS is implemented as a (service-producing) MEC App.

According to [MEC030] section 5.4.1, “the VIS service may be produced by the MEC platform or by the MEC application”. Focusing on MEC PoP optimization, in both cases, the initial trigger is always the VIS, as it is the owner of the overall e-IQN message, after concatenating the radio/edge prediction attributes. Hence, as a first step, the VIS provides the e-IQN edge resource information to the MEPM with two subcases: (i) VIS implemented as a MEC platform service 4 through Mm5 reference point (FIG. 19); and (ii) VIS as a service-producing MEC App 4 through the Mp1 and Mm5 reference points (FIG. 20).

FIG. 20 depicts example federation management reference points Mfm-fed connecting a MEC system's MEO 2010 with a Federation Manager 2025. MEC federation for inter-MEC system offloading involves the presence of two or more “federated” MEC systems, where, for example, the Client App, which is the primary beneficiary of e-IQN messages, may want to evaluate the PoP optimization possibly by exploiting the presence of the other MEC systems in the federation, and evaluate the opportunity to relocate the MEC App instance (e.g., for application offloading) to another MEC host of a different MEC system of the same MEC federation. In this case, it is assumed that an initial inter-MEC system discovery between two (or among more) MEC systems is feasible at the MEO 2010 level via a dedicated Mfm-fed reference point, connecting MEOs 2010 with Federation Managers 2025 located in the Operator Platforms 2001 (see e.g., GSMA White Paper, “Operator Platform Concept—Phase 1: Edge Cloud Computing” (January 2020), available at: https://www.ssma.com/futurenetworks/resources/operator-platform-concept-whitepaper/; and ETSI MEC as document 188r1).

In addition to MEC systems discovery, as a pre-condition, it is further assumed that inter-system MEC platform discovery has been performed via a dedicated reference point connecting MEOs of federated MEC systems, including the discovery of available services (through the MEC platforms). Additionally, it is assumed that the e-IQN consumer has obtained an e-IQN response with all attributes based on predictions performed by RAN/Cloud PFs managed by the MNO owing MEC system 1, as well as that MEC PoP optimization has been performed in MEC system 1, as in FIGS. 18 and 19.

Assuming, for simplicity, a MEC federation formed by only two MEC systems, e.g., MEC system 1 and MEC system 2, to ensure service continuity, especially challenging for high-speed V2X scenarios, the VIS of MEC system 1 provides the e-IQN attributes on available edge resources along a vehicle's route to a VIS service consumer located in MEC system 2 via an inter-MEC system platform-to-platform reference point. Then, within the MEC system 2, a MEC PoP optimization procedure is performed, similar to the one illustrated in FIGS. 18 and 19. Furthermore, while the VIS is the service, and owns the e-IQN information, the MEC platform owns the Service Registry, and makes the VIS service discovery possible among the two MEC systems. Hence, it is important to note that the MEC platform is not transferring the e-IQN info per se.

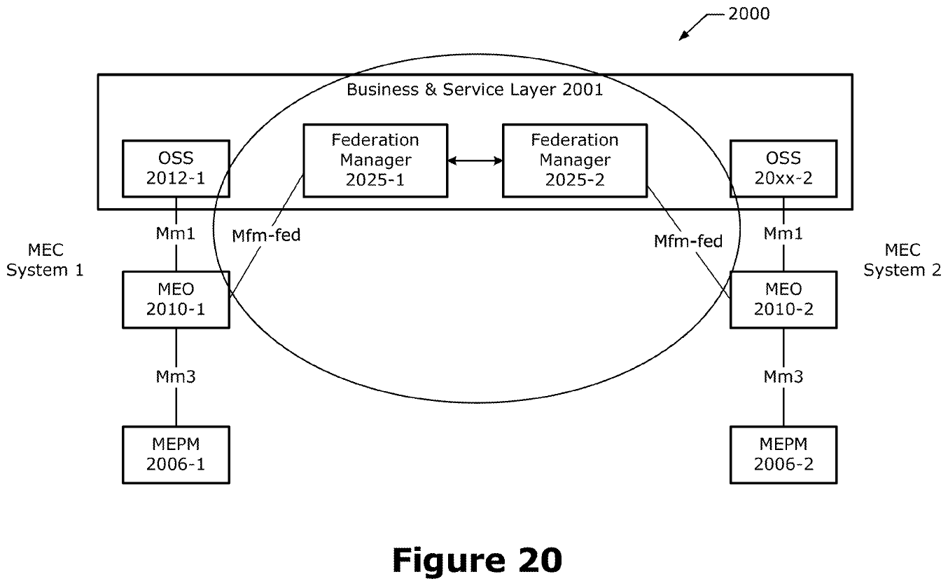

In various embodiments, the Client App, initially associated to a MEC App (e.g., the e-IQN consumer) instantiated at a certain MEC host of MEC system 1, decides upon MEC App instant migration to a MEC host of MEC system 2, which has been identified by MEO2. The procedure is explained with respect to FIG. 21.

FIG. 21 depicts an example procedure 2100 for MEC PoP optimization across a MEC federation influencing the decision of migrating (or not) a MEC App instance from a first MEC system to a second MEC system of the same MEC federation. In this example it is assumed that two federated MEC systems are deployed across a geographical area. The framework is applicable also to MEC federations including multiple MEC systems. In this example, the VIS 1580 is implemented as a MEC platform 1532 service. This framework is also applicable to the case where the VIS 1580 is implemented as a (service-producing) MEC App 1526.

The procedure 2100 has three preconditions. The first precondition is that the e-IQN consumer has obtained an e-IQN response with all attributes based on predictions performed by RAN/Cloud PFs 1550, 1554 managed by the MNO owning/operating MEC system 1. The second precondition is that the MEC federation has been established between MEC systems 1 and 2, and therefore, as MEC platforms 1532 and their supported services are discoverable across the systems forming the MEC federation, and inter-MEC system platform-to-platform communication is feasible. The third precondition is that MEC PoP optimization has been performed.

Procedure 2100 begins at step 1 where e-IQN attributes on available edge resources along route (originating from the VIS) are provided by a MEC platform 1532 in MEC system 1 to a MEC platform 1532 in MEC system 2 (MEP-2 1532) via the inter-MEC system platform-to-platform reference point (e.g., the Mfm-fed reference point). At step 2, the MEP-2 1532 provides e-IQN attributes on available edge resources along route to the MEPM 1806 in MEC system 2 (MEPM-2 1806) via the Mm5 reference point. At step 3, the MEPM-2 1806 sends e-IQN attributes on available edge resources along route are provided to the MEO 1810 in MEC system 2 (MEO-2 1810) via the Mm3 reference point.

At step 4, the MEO-2 1810 determines edge/cloud resources. In one example, the MEO 1810 matches route waypoints to deployed MEC hosts, identifies resource bottlenecks at the MEC hosts, and suggests a VM migration policy to be implemented to specific MEC hosts and times. At step 5, the MEO-2 1810 forwards policy regarding edge/cloud resources (e.g., including VM migration policies) to the VIM 1808 in MEC system 2 (VIM-2 1808) via the Mm4 reference point. At step 6, the VIM-2 1808 implements the policy if there are enough resources; otherwise, marks it as infeasible and informs the MEO 1810 accordingly. At step 7, the client app 1518 initially associated with the e-IQN consumer (e.g., MEC app 1526) instantiated at MEC host of MEC system 1 will decide upon MEC App instance migration to a different MEC host of MEC system 2, which has been identified by the MEO-2 1810.

### 4. Example Edge Computing System Configurations and Arrangements

Edge computing refers to the implementation, coordination, and use of computing and resources at locations closer to the “edge” or collection of “edges” of a network. Deploying computing resources at the network's edge may reduce application and network latency, reduce network backhaul traffic and associated energy consumption, improve service capabilities, improve compliance with security or data privacy requirements (especially as compared to conventional cloud computing), and improve total cost of ownership.

Individual compute platforms or other components that can perform edge computing operations (referred to as “edge compute nodes,” “edge nodes,” or the like) can reside in whatever location needed by the system architecture or ad hoc service. In many edge computing architectures, edge nodes are deployed at NANs, gateways, network routers, and/or other devices that are closer to endpoint devices (e.g., UEs, IoT devices, etc.) producing and consuming data. As examples, edge nodes may be implemented in a high performance compute data center or cloud installation; a designated edge node server, an enterprise server, a roadside server, a telecom central office; or a local or peer at-the-edge device being served consuming edge services.

Edge compute nodes may partition resources (e.g., memory, CPU, GPU, interrupt controller, I/O controller, memory controller, bus controller, network connections or sessions, etc.) where respective partitionings may contain security and/or integrity protection capabilities. Edge nodes may also provide orchestration of multiple applications through isolated user-space instances such as containers, partitions, virtual environments (VEs), virtual machines (VMs), Function-as-a-Service (FaaS) engines, Servlets, servers, and/or other like computation abstractions. Containers are contained, deployable units of software that provide code and needed dependencies. Various edge system arrangements/architecture treats VMs, containers, and functions equally in terms of application composition. The edge nodes are coordinated based on edge provisioning functions, while the operation of the various applications are coordinated with orchestration functions (e.g., VM or container engine, etc.). The orchestration functions may be used to deploy the isolated user-space instances, identifying and scheduling use of specific hardware, security related functions (e.g., key management, trust anchor management, etc.), and other tasks related to the provisioning and lifecycle of isolated user spaces.

Applications that have been adapted for edge computing include but are not limited to virtualization of traditional network functions including include, for example, Software-Defined Networking (SDN), Network Function Virtualization (NFV), distributed RAN units and/or RAN clouds, and the like. Additional example use cases for edge computing include computational offloading, Content Data Network (CDN) services (e.g., video on demand, content streaming, security surveillance, alarm system monitoring, building access, data/content caching, etc.), gaming services (e.g., AR/VR, etc.), accelerated browsing, IoT and industry applications (e.g., factory automation), media analytics, live streaming/transcoding, and V2X applications (e.g., driving assistance and/or autonomous driving applications).

The present disclosure provides specific examples relevant to edge computing configurations provided within Multi-Access Edge Computing (MEC) and 5G network implementations. However, many other standards and network implementations are applicable to the edge and service management concepts discussed herein. For example, the embodiments discussed herein may be applicable to many other edge computing/networking technologies in various combinations and layouts of devices located at the edge of a network. Examples of such other edge computing/networking technologies that may implement the embodiments herein include Content Delivery Networks (CDNs) (also referred to as “Content Distribution Networks” or the like); Mobility Service Provider (MSP) edge computing and/or Mobility as a Service (MaaS) provider systems (e.g., used in AECC architectures); Nebula edge-cloud systems; Fog computing systems; Cloudlet edge-cloud systems; Mobile Cloud Computing (MCC) systems; Central Office Re-architected as a Datacenter (CORD), mobile CORD (M-CORD) and/or Converged Multi-Access and Core (COMAC) systems; and/or the like. Further, the techniques disclosed herein may relate to other IoT edge network systems and configurations, and other intermediate processing entities and architectures may also be used to practice the embodiments herein.

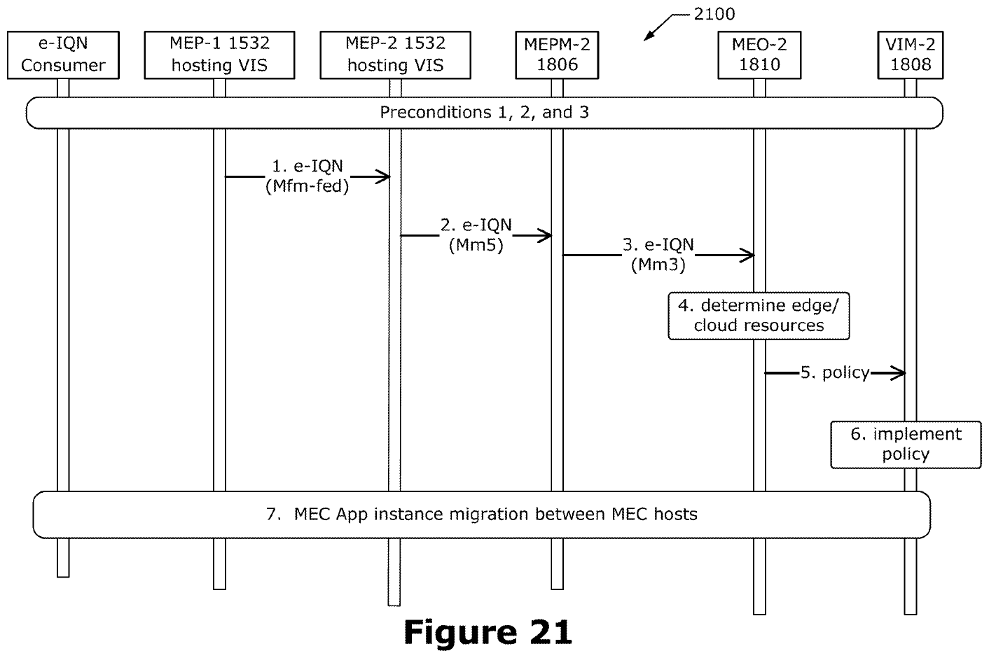

FIG. 22 is a block diagram 2200 showing an overview of a configuration for edge computing, which includes a layer of processing referred to in many of the following examples as an “edge cloud”. An “Edge Cloud” may refer to an interchangeable cloud ecosystem encompassing storage and compute assets located at a network's edge and interconnected by a scalable, application-aware network that can sense and adapt to changing needs, in real-time, and in a secure manner. An Edge Cloud architecure is used to decentralize computing resources and power to the edges of one or more networks (e.g., end point devices and/or intermediate nodes such as client devices/UEs). Traditionally, the computing power of servers is used to perform tasks and create distributed systems, Within the cloud model, such intelligent tasks are performed by servers (e.g., in a data center) so they can be transferred to other devices with less or almost no computing power. In the edge cloud 2210, some or all of these processing tasks are shifted to endpoint nodes and intermediate nodes such as client devices, IoT devices, network devices/appliances, and/or the like. It should be noted that an endpoint node may be the end of a communication path in some contexts, while in other contexts an endpoint node may be an intermediate node; similarly, an intermediate node may be the end of a communication path in some contexts, while in other contexts an intermediate node may be an endpoint node.

As shown, the edge cloud 2210 is co-located at an edge location, such as an access point or base station 2240, a local processing hub 2250, or a central office 2220, and thus may include multiple entities, devices, and equipment instances. The edge cloud 2210 is located much closer to the endpoint (consumer and producer) data sources 2260 (e.g., autonomous vehicles 2261, user equipment 2262, business and industrial equipment 2263, video capture devices 2264, drones 2265, smart cities and building devices 2266, sensors and IoT devices 2267, etc.) than the cloud data center 2230. Compute, memory, and storage resources which are offered at the edges in the edge cloud 2210 are critical to providing ultra-low latency response times for services and functions used by the endpoint data sources 2260 as well as reduce network backhaul traffic from the edge cloud 2210 toward cloud data center 2230 thus improving energy consumption and overall network usages among other benefits.

Compute, memory, and storage are scarce resources, and generally decrease depending on the edge location (e.g., fewer processing resources being available at consumer endpoint devices, than at a base station, than at a central office). However, the closer that the edge location is to the endpoint (e.g., user equipment (UE)), the more that space and power is often constrained. Thus, edge computing attempts to reduce the amount of resources needed for network services, through the distribution of more resources which are located closer both geographically and in network access time. In this manner, edge computing attempts to bring the compute resources to the workload data where appropriate, or, bring the workload data to the compute resources.

The following describes aspects of an edge cloud architecture that covers multiple potential deployments and addresses restrictions that some network operators or service providers may have in their own infrastructures. These include, variation of configurations based on the edge location (because edges at a base station level, for instance, may have more constrained performance and capabilities in a multi-tenant scenario); configurations based on the type of compute, memory, storage, fabric, acceleration, or like resources available to edge locations, tiers of locations, or groups of locations; the service, security, and management and orchestration capabilities; and related objectives to achieve usability and performance of end services. These deployments may accomplish processing in network layers that may be considered as “near edge”, “close edge”, “local edge”, “middle edge”, or “far edge” layers, depending on latency, distance, and timing characteristics.

Edge computing is a developing paradigm where computing is performed at or closer to the “edge” of a network, typically through the use of a compute platform (e.g., x86 or ARM compute hardware architecture) implemented at base stations, gateways, network routers, or other devices which are much closer to endpoint devices producing and consuming the data. For example, edge gateway servers may be equipped with pools of memory and storage resources to perform computation in real-time for low latency use-cases (e.g., autonomous driving or video surveillance) for connected client devices. Or as an example, base stations may be augmented with compute and acceleration resources to directly process service workloads for connected user equipment, without further communicating data via backhaul networks. Or as another example, central office network management hardware may be replaced with standardized compute hardware that performs virtualized network functions and offers compute resources for the execution of services and consumer functions for connected devices. Within edge computing networks, there may be scenarios in services which the compute resource will be “moved” to the data, as well as scenarios in which the data will be “moved” to the compute resource. Or as an example, base station compute, acceleration and network resources can provide services in order to scale to workload demands on an as needed basis by activating dormant capacity (subscription, capacity on demand) in order to manage corner cases, emergencies or to provide longevity for deployed resources over a significantly longer implemented lifecycle.

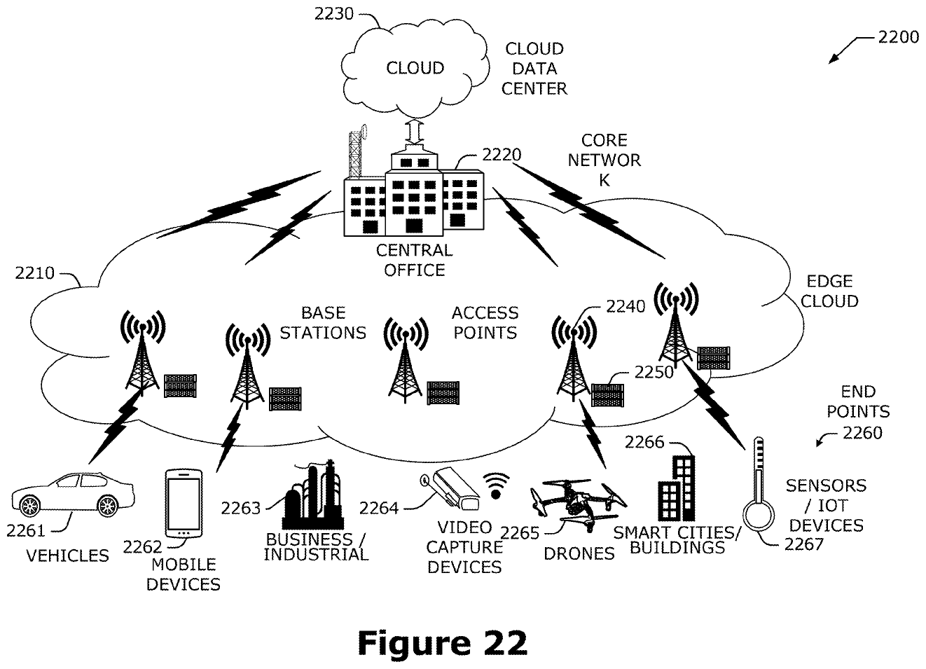

FIG. 23 illustrates operational layers among endpoints, an edge cloud, and cloud computing environments. Specifically, FIG. 23 depicts examples of computational use cases 2305, utilizing the edge cloud 2210 among multiple illustrative layers of network computing. The layers begin at an endpoint (devices and things) layer 2300, which accesses the edge cloud 2210 to conduct data creation, analysis, and data consumption activities. The edge cloud 2210 may span multiple network layers, such as an edge devices layer 2310 having gateways, on-premise servers, or network equipment (nodes 2315) located in physically proximate edge systems; a network access layer 2320, encompassing base stations, radio processing units, network hubs, regional data centers (DC), or local network equipment (equipment 2325); and any equipment, devices, or nodes located therebetween (in layer 2312, not illustrated in detail). The network communications within the edge cloud 2210 and among the various layers may occur via any number of wired or wireless mediums, including via connectivity architectures and technologies not depicted.

Examples of latency, resulting from network communication distance and processing time constraints, may range from less than a millisecond (ms) when among the endpoint layer 2300, under 5 ms at the edge devices layer 2310, to even between 10 to 40 ms when communicating with nodes at the network access layer 2320. Beyond the edge cloud 2210 are core network 2330 and cloud data center 2340 layers, each with increasing latency (e.g., between 50-60 ms at the core network layer 2330, to 100 or more ms at the cloud data center layer). As a result, operations at a core network data center 2335 or a cloud data center 2345, with latencies of at least 50 to 100 ms or more, will not be able to accomplish many time-critical functions of the use cases 2305. Each of these latency values are provided for purposes of illustration and contrast; it will be understood that the use of other access network mediums and technologies may further reduce the latencies. In some examples, respective portions of the network may be categorized as “close edge”, “local edge”, “near edge”, “middle edge”, or “far edge” layers, relative to a network source and destination. For instance, from the perspective of the core network data center 2335 or a cloud data center 2345, a central office or content data network may be considered as being located within a “near edge” layer (“near” to the cloud, having high latency values when communicating with the devices and endpoints of the use cases 2305), whereas an access point, base station, on-premise server, or network gateway may be considered as located within a “far edge” layer (“far” from the cloud, having low latency values when communicating with the devices and endpoints of the use cases 2305). It will be understood that other categorizations of a particular network layer as constituting a “close”, “local”, “near”, “middle”, or “far” edge may be based on latency, distance, number of network hops, or other measurable characteristics, as measured from a source in any of the network layers 2300-2340.

The various use cases 2305 may access resources under usage pressure from incoming streams, due to multiple services utilizing the edge cloud. To achieve results with low latency, the services executed within the edge cloud 2210 balance varying requirements in terms of: (a) Priority (throughput or latency) and Quality of Service (QoS) (e.g., traffic for an autonomous car may have higher priority than a temperature sensor in terms of response time requirement; or, a performance sensitivity/bottleneck may exist at a compute/accelerator, memory, storage, or network resource, depending on the application); (b) Reliability and Resiliency (e.g., some input streams need to be acted upon and the traffic routed with mission-critical reliability, where as some other input streams may be tolerate an occasional failure, depending on the application); and (c) Physical constraints (e.g., power, cooling and form-factor).

The end-to-end service view for these use cases involves the concept of a service-flow and is associated with a transaction. The transaction details the overall service requirement for the entity consuming the service, as well as the associated services for the resources, workloads, workflows, and business functional and business level requirements. The services executed with the “terms” described may be managed at each layer in a way to assure real time, and runtime contractual compliance for the transaction during the lifecycle of the service. When a component in the transaction is missing its agreed to SLA, the system as a whole (components in the transaction) may provide the ability to (1) understand the impact of the SLA violation, and (2) augment other components in the system to resume overall transaction SLA, and (3) implement steps to remediate.

Thus, with these variations and service features in mind, edge computing within the edge cloud 2210 may provide the ability to serve and respond to multiple applications of the use cases 2305 (e.g., object tracking, video surveillance, connected cars, etc.) in real-time or near real-time, and meet ultra-low latency requirements for these multiple applications. These advantages enable a whole new class of applications (Virtual Network Functions (VNFs), Function as a Service (FaaS), Edge as a Service (EaaS), standard processes, etc.), which cannot leverage conventional cloud computing due to latency or other limitations.

However, with the advantages of edge computing comes the following caveats. The devices located at the edge are often resource constrained and therefore there is pressure on usage of edge resources. Typically, this is addressed through the pooling of memory and storage resources for use by multiple users (tenants) and devices. The edge may be power and cooling constrained and therefore the power usage needs to be accounted for by the applications that are consuming the most power. There may be inherent power-performance tradeoffs in these pooled memory resources, as many of them are likely to use emerging memory technologies, where more power requires greater memory bandwidth. Likewise, improved security of hardware and root of trust trusted functions are also required, because edge locations may be unmanned and may even need permissioned access (e.g., when housed in a third-party location). Such issues are magnified in the edge cloud 2210 in a multi-tenant, multi-owner, or multi-access setting, where services and applications are requested by many users, especially as network usage dynamically fluctuates and the composition of the multiple stakeholders, use cases, and services changes.

At a more generic level, an edge computing system may be described to encompass any number of deployments at the previously discussed layers operating in the edge cloud 2210 (network layers 2300-2340), which provide coordination from client and distributed computing devices. One or more edge gateway nodes, one or more edge aggregation nodes, and one or more core data centers may be distributed across layers of the network to provide an implementation of the edge computing system by or on behalf of a telecommunication service provider (“telco”, or “TSP”), internet-of-things service provider, cloud service provider (CSP), enterprise entity, or any other number of entities. Various implementations and configurations of the edge computing system may be provided dynamically, such as when orchestrated to meet service objectives.

Consistent with the examples provided herein, a client compute node may be embodied as any type of endpoint component, device, appliance, or other thing capable of communicating as a producer or consumer of data. Further, the label “node” or “device” as used in the edge computing system does not necessarily mean that such node or device operates in a client or agent/minion/follower role; rather, any of the nodes or devices in the edge computing system refer to individual entities, nodes, or subsystems which include discrete or connected hardware or software configurations to facilitate or use the edge cloud 2210.

As such, the edge cloud 2210 is formed from network components and functional features operated by and within edge gateway nodes, edge aggregation nodes, or other edge compute nodes among network layers 2310-2330. The edge cloud 2210 thus may be embodied as any type of network that provides edge computing and/or storage resources which are proximately located to radio access network (RAN) capable endpoint devices (e.g., mobile computing devices, IoT devices, smart devices, etc.), which are discussed herein. In other words, the edge cloud 2210 may be envisioned as an “edge” which connects the endpoint devices and traditional network access points that serve as an ingress point into service provider core networks, including mobile carrier networks (e.g., Global System for Mobile Communications (GSM) networks, Long-Term Evolution (LTE) networks, 5G/6G networks, etc.), while also providing storage and/or compute capabilities. Other types and forms of network access (e.g., Wi-Fi, long-range wireless, wired networks including optical networks) may also be utilized in place of or in combination with such 3GPP carrier networks.

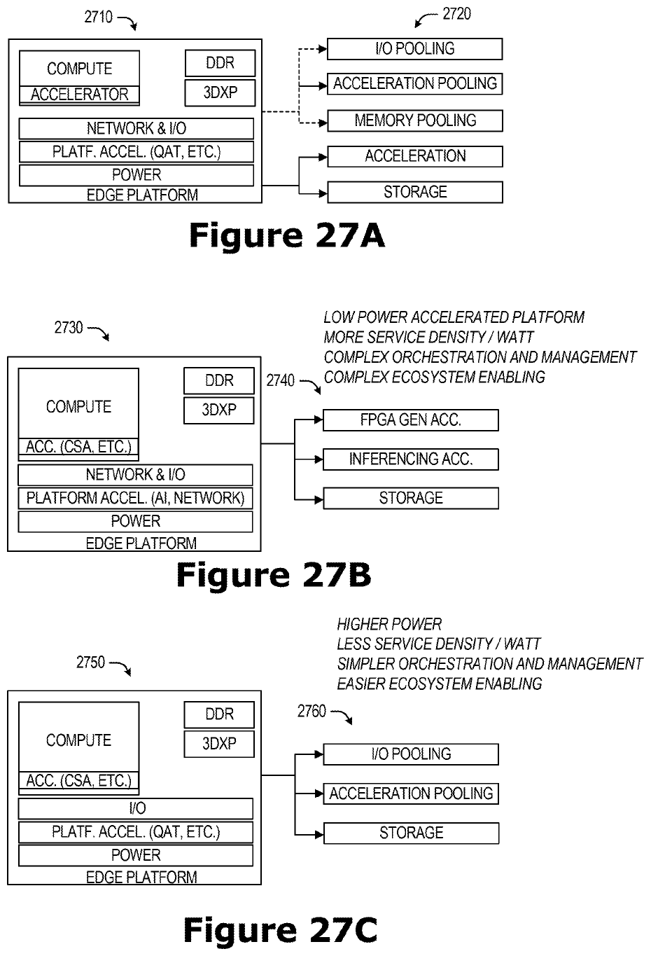

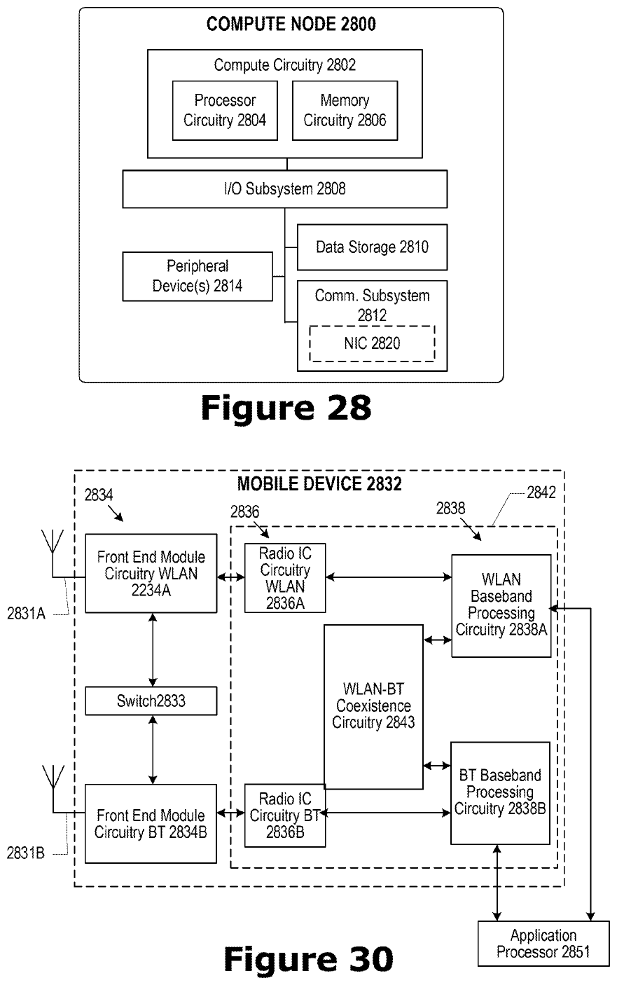

The network components of the edge cloud 2210 may be servers, multi-tenant servers, appliance computing devices, and/or any other type of computing devices. For example, the edge cloud 2210 may include an appliance computing device that is a self-contained electronic device including a housing, a chassis, a case or a shell. In some circumstances, the housing may be dimensioned for portability such that it can be carried by a human and/or shipped. Example housings may include materials that form one or more exterior surfaces that partially or fully protect contents of the appliance, in which protection may include weather protection, hazardous environment protection (e.g., EMI, vibration, extreme temperatures), and/or enable submergibility. Example housings may include power circuitry to provide power for stationary and/or portable implementations, such as AC power inputs, DC power inputs, AC/DC or DC/AC converter(s), power regulators, transformers, charging circuitry, batteries, wired inputs and/or wireless power inputs. Example housings and/or surfaces thereof may include or connect to mounting hardware to enable attachment to structures such as buildings, telecommunication structures (e.g., poles, antenna structures, etc.) and/or racks (e.g., server racks, blade mounts, etc.). Example housings and/or surfaces thereof may support one or more sensors (e.g., temperature sensors, vibration sensors, light sensors, acoustic sensors, capacitive sensors, proximity sensors, etc.). One or more such sensors may be contained in, carried by, or otherwise embedded in the surface and/or mounted to the surface of the appliance. Example housings and/or surfaces thereof may support mechanical connectivity, such as propulsion hardware (e.g., wheels, propellers, etc.) and/or articulating hardware (e.g., robot arms, pivotable appendages, etc.). In some circumstances, the sensors may include any type of input devices such as user interface hardware (e.g., buttons, switches, dials, sliders, etc.). In some circumstances, example housings include output devices contained in, carried by, embedded therein and/or attached thereto. Output devices may include displays, touchscreens, lights, LEDs, speakers, I/O ports (e.g., USB), etc. In some circumstances, edge devices are devices presented in the network for a specific purpose (e.g., a traffic light), but may have processing and/or other capacities that may be utilized for other purposes. Such edge devices may be independent from other networked devices and may be provided with a housing having a form factor suitable for its primary purpose; yet be available for other compute tasks that do not interfere with its primary task. Edge devices include Internet of Things devices. The appliance computing device may include hardware and software components to manage local issues such as device temperature, vibration, resource utilization, updates, power issues, physical and network security, etc. Example hardware for implementing an appliance computing device is described in conjunction with FIGS. 28-29. The edge cloud 2210 may also include one or more servers and/or one or more multi-tenant servers. Such a server may include an operating system and a virtual computing environment. A virtual computing environment may include a hypervisor managing (spawning, deploying, destroying, etc.) one or more virtual machines, one or more containers, etc. Such virtual computing environments provide an execution environment in which one or more applications and/or other software, code or scripts may execute while being isolated from one or more other applications, software, code or scripts.

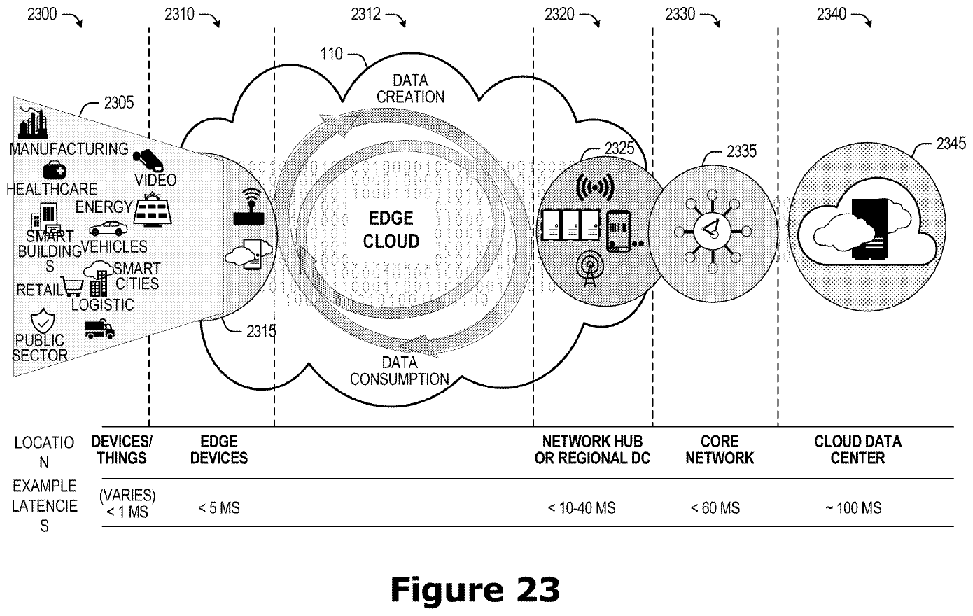

In FIG. 24, various client endpoints 2410 (in the form of mobile devices, computers, autonomous vehicles, business computing equipment, industrial processing equipment) exchange requests and responses that are specific to the type of endpoint network aggregation. For instance, client endpoints 2410 may obtain network access via a wired broadband network, by exchanging requests and responses 2422 through an on-premise network system 2432. Some client endpoints 2410, such as mobile computing devices, may obtain network access via a wireless broadband network, by exchanging requests and responses 2424 through an access point (e.g., cellular network tower) 2434. Some client endpoints 2410, such as autonomous vehicles may obtain network access for requests and responses 2426 via a wireless vehicular network through a street-located network system 2436. However, regardless of the type of network access, the TSP may deploy aggregation points 2442, 2444 within the edge cloud 2210 to aggregate traffic and requests. Thus, within the edge cloud 2210, the TSP may deploy various compute and storage resources, such as at edge aggregation nodes 2440, to provide requested content. The edge aggregation nodes 2440 and other systems of the edge cloud 2210 are connected to a cloud or data center 2460, which uses a backhaul network 2450 to fulfill higher-latency requests from a cloud/data center for websites, applications, database servers, etc. Additional or consolidated instances of the edge aggregation nodes 2440 and the aggregation points 2442, 2444, including those deployed on a single server framework, may also be present within the edge cloud 2210 or other areas of the TSP infrastructure.

FIG. 25 illustrates a MEC system reference architecture (or MEC architecture) 2500 providing functionalities in accordance with [MEC003]. MEC offers application developers and content providers cloud-computing capabilities and an IT service environment at the edge of the network. This environment is characterized by ultra-low latency and high bandwidth as well as real-time access to radio network information that can be leveraged by applications. MEC technology permits to flexible and rapid deployment of innovative applications and services towards mobile subscribers, enterprises and vertical segments. In particular, regarding the automotive sector, applications such as V2X (e.g., IEEE 802.11p based protocols such as DSRC/ITS-G5, or 3GPP C-V2X based protocols) need to exchange data, provide data to aggregation points and access to data in databases which provide an overview of the local situation derived from a multitude of sensors (by various cars, roadside units, etc.).

The MEC architecture 2500 includes MEC hosts 2502, a virtualization infrastructure manager (VIM) 2508, an MEC platform manager 2506, an MEC orchestrator 2510, an operations support system (OSS) 2512, a user app proxy 2514, a UE app 2518 running on UE 2520, and CFS portal 2516. The MEC host 2502 can include a MEC platform 2532 with filtering rules control component 2540, a DNS handling component 2542, a service registry 2538, and MEC services 2536. The MEC services 2536 can include at least one scheduler, which can be used to select resources for instantiating MEC apps (or NFVs) 2526 upon virtualization infrastructure (VI) 2522. The MEC apps 2526 can be configured to provide services 2530, which can include processing network communications traffic of different types associated with one or more wireless connections (e.g., connections to one or more RANs or core network functions) and/or some other services such as those discussed herein. The other MEC host 2502 may have a same or similar configuration/implementation as the MEC host 2502, and the other MEC app 2526 instantiated within other MEC host 2502 can be similar to the MEC apps 2526 instantiated within MEC host 2502. The VI 2522 includes a data plane 2524 coupled to the MEC platform 2522 via an MP2 interface. Additional interfaces between various network entities of the MEC architecture 2500 are illustrated in FIG. 25.

The MEC system 2500 includes three groups of reference points, including “Mp” reference points regarding the MEC platform functionality; “Mm” reference points, which are management reference points; and “Mx” reference points, which connect MEC entities to external entities. The interfaces/reference points in the MEC system 2500 may include IP-based connections, and may be used to provide Representational State Transfer (REST or RESTful) services, and the messages conveyed using the reference points/interfaces may be in XML, HTML, JSON, or some other desired format, such as those discussed herein. A suitable Authentication, Authorization, and Accounting (AAA) protocol, such as the radius or diameter protocols, may also be used for communicating over the reference points/interfaces in other embodiments.

The logical connections between various entities of the MEC architecture 2500 may be access-agnostic and not dependent on a particular deployment. MEC enables implementation of MEC apps 2526 as software-only entities that run on top of a VI 2522, which is located in or close to the network edge. A MEC app 2526 is an application that can be instantiated on a MEC host 2502 within the MEC system 2500 and can potentially provide or consume MEC services 2536.

The MEC entities depicted by FIG. 25 can be grouped into a MEC system level, MEC host level, and network level entities (not shown). The network level (not shown) includes various external network level entities, such as a 3GPP network, a local areanetwork (e.g., a LAN, WLAN, PAN, DN, LADN, etc.), and external network(s). The MEC system level includes MEC system level management entities and UE 2520, and is discussed in more detail infra. The MEC host level includes one or more MEC hosts 2502, 2504 and MEC management entities, which provide functionality to run MEC Apps 2526 within an operator network or a subset of an operator network. The MEC management entities include various components that handle the management of the MEC-specific functionality of a particular MEC platform 2532, MEC host 2502, and the MEC Apps 2526 to be run.

The MEC platform manager 2506 is a MEC management entity including MEC platform element management component 2544, MEC app rules and requirements management component 2546, and MEC app lifecycle management component 2548. The various entities within the MEC architecture 2500 can perform functionalities as discussed in [MEC003]. The remote app 2550 is configured to communicate with the MEC host 2502 (e.g., with the MEC apps 2526) via the MEC orchestrator 2510 and the MEC platform manager 2506.

The MEC host 2502 is an entity that contains an MEC platform 2532 and VI 2522 which provides compute, storage, and network resources for the purpose of running MEC Apps 2526. The VI 2522 includes a data plane (DP) 2524 that executes traffic rules 2540 received by the MEC platform 2532, and routes the traffic among MEC Apps 2526, MEC services 2536, DNS server/proxy (see e.g., via DNS handling entity 2542), 3GPP network, local networks, and external networks. The MEC DP 2524 may be connected with the (R)AN nodes and the 3GPP core network, and/or may be connected with an access point via a wider network, such as the internet, an enterprise network, or the like.

The MEC platform 2532 is a collection of essential functionality required to run MEC Apps 2526 on a particular VI 2522 and enable them to provide and consume MEC services 2536, and that can provide itself a number of MEC services 937a. The MEC platform 2532 can also provide various services and/or functions, such as offering an environment where the MEC Apps 2526 can discover, advertise, consume and offer MEC services 2536 (discussed infra), including MEC services 2536 available via other platforms when supported. The MEC platform 2532 may be able to allow authorized MEC Apps 2526 to communicate with third party servers located in external networks. The MEC platform 2532 may receive traffic rules from the MEC platform manager 2506, applications, or services, and instruct the data plane accordingly (see e.g., Traffic Rules Control 2540). The MEC platform 2532 may send instructions to the DP 2524 within the VI 2522 via the Mp2 reference point. The Mp2 reference point between the MEC platform 2532 and the DP 2524 of the VI 2522 may be used to instruct the DP 2534 on how to route traffic among applications, networks, services, etc. The MEC platform 2532 may translate tokens representing UEs 2520 in the traffic rules into specific IP addresses. The MEC platform 2532 also receives DNS records from the MEC platform manager 2506 and configures a DNS proxy/server accordingly. The MEC platform 2532 hosts MEC services 2536 including the multi-access edge services discussed infra, and provide access to persistent storage and time of day information. Furthermore, the MEC platform 2532 may communicate with other MEC platforms 2532 of other MEC servers 2502 via the Mp3 reference point.

The VI 2522 represents the totality of all hardware and software components which build up the environment in which MEC Apps 2526 and/or MEC platform 2532 are deployed, managed and executed. The VI 2522 may span across several locations, and the network providing connectivity between these locations is regarded to be part of the VI 2522. The physical hardware resources of the VI 2522 includes computing, storage and network resources that provide processing, storage and connectivity to MEC Apps 2526 and/or MEC platform 2532 through a virtualization layer (e.g., a hypervisor, VM monitor (VMM), or the like). The virtualization layer may abstract and/or logically partition the physical hardware resources of the MEC server 2502 as a hardware abstraction layer. The virtualization layer may also enable the software that implements the MEC Apps 2526 and/or MEC platform 2532 to use the underlying VI 2522, and may provide virtualized resources to the MEC Apps 2526 and/or MEC platform 2532, so that the MEC Apps 2526 and/or MEC platform 2532 can be executed.

The MEC Apps 2526 are applications that can be instantiated on a MEC host/server 2502 within the MEC system 2500 and can potentially provide or consume MEC services 2536. The term “MEC service” refers to a service provided via a MEC platform 2532 either by the MEC platform 2532 itself or by a MEC App 2526. MEC Apps 2526 may run as VM on top of the VI 2522 provided by the MEC server 2502, and can interact with the MEC platform 2532 to consume and provide the MEC services 2536. The Mp1 reference point between the MEC platform 2532 and the MEC Apps 2526 is used for consuming and providing service specific functionality. Mp1 provides service registration 2538, service discovery, and communication support for various services, such as the MEC services 2536 provided by MEC host 2502. Mp1 may also provide application availability, session state relocation support procedures, traffic rules and DNS rules activation, access to persistent storage and time of day information, and/or the like.

The MEC Apps 2526 are instantiated on the VI 2522 of the MEC server 2502 based on configuration or requests validated by the MEC management (e.g., MEC platform manager 2506). The MEC Apps 2526 can also interact with the MEC platform 2532 to perform certain support procedures related to the lifecycle of the MEC Apps 2526, such as indicating availability, preparing relocation of user state, etc. The MEC Apps 2526 may have a certain number of rules and requirements associated to them, such as required resources, maximum latency, required or useful services, etc. These requirements may be validated by the MEC management, and can be assigned to default values if missing. MEC services 2536 are services provided and/or consumed either by the MEC platform 2532 and/or MEC Apps 2526. The service consumers (e.g., MEC Apps 2526 and/or MEC platform 2532) may communicate with particular MEC services 2536 over individual APIs (including MEC V2X API and the other MEC APIs discussed herein). When provided by an application, a MEC service 2536 can be registered in a list of services in the service registries 2538 to the MEC platform 2532 over the Mp1 reference point. Additionally, a MEC App 2526 can subscribe to one or more services 2530/2536 for which it is authorized over the Mp1 reference point.

Examples of MEC services 2536 include the VIS, RNIS [MEC012], LS [MEC011], UE_ID Services [MEC014], BWMS [MEC015], WAIS [MEC028], FAIS [MEC029], and/or other MEC services. The RNIS, when available, provides authorized MEC Apps 2526 with radio network related information, and expose appropriate up-to-date radio network information to the MEC Apps 2526. The RNI may include, inter alia, radio network conditions, measurement and statistics information related to the user plane, information related to UEs 2520 served by the radio node(s) associated with the MEC host 2502 (e.g., UE context and radio access bearers), changes on information related to UEs 2520 served by the radio node(s) associated with the MEC host XE136, and/or the like. The RNI may be provided at the relevant granularity (e.g., per UE 2520, per cell, per period of time).

The service consumers (e.g., MEC Apps 2526, MEC platform 2532, etc.) may communicate with the RNIS over an RNI API to obtain contextual information from a corresponding RAN. RNI may be provided to the service consumers via a NAN (e.g., (R)AN node, RRH, AP, etc.). The RNI API may support both query and subscription (e.g., a pub/sub) based mechanisms that are used over a Representational State Transfer (RESTful) API or over a message broker of the MEC platform 2532 (not shown). A MEC App 2526 may query information on a message broker via a transport information query procedure, wherein the transport information may be pre-provisioned to the MEC App 2526 via a suitable configuration mechanism. The various messages communicated via the RNI API may be in XML, JSON, Protobuf, or some other suitable format.

The VIS provides supports various V2X applications including the journey-aware QoS predictions according to the various embodiments discussed herein. The RNI may be used by MEC Apps 2526 and MEC platform 2532 to optimize the existing services and to provide new types of services that are based on up to date information on radio conditions. As an example, a MEC App 2526 may use RNI to optimize current services such as video throughput guidance. In throughput guidance, a radio analytics MEC App 2526 may use MEC services to provide a backend video server with a near real-time indication on the throughput estimated to be available at the radio DL interface in a next time instant. The throughput guidance radio analytics application computes throughput guidance based on the required radio network information it obtains from a multi-access edge service running on the MEC server 2502. RNI may be also used by the MEC platform 2532 to optimize the mobility procedures required to support service continuity, such as when a certain MEC App 2526 requests a single piece of information using a simple request-response model (e.g., using RESTful mechanisms) while other MEC Apps 2526 subscribe to multiple different notifications regarding information changes (e.g., using a pub/sub mechanism and/or message broker mechanisms).

The LS, when available, may provide authorized MEC Apps 2526 with location-related information, and expose such information to the MEC Apps 2526. With location related information, the MEC platform 2532 or one or more MEC Apps 2526 perform active device location tracking, location-based service recommendations, and/or other like services. The LS supports the location retrieval mechanism, e.g., the location is reported only once for each location information request. The LS supports a location subscribe mechanism, for example, the location is able to be reported multiple times for each location request, periodically or based on specific events, such as location change. The location information may include, inter alia, the location of specific UEs 2520 currently served by the radio node(s) associated with the MEC server 2502, information about the location of all UEs 2520 currently served by the radio node(s) associated with the MEC server XE136, information about the location of a certain category of UEs 2520 currently served by the radio node(s) associated with the MEC server XE136, a list of UEs 2520 in a particular location, information about the location of all radio nodes currently associated with the MEC host 2502, and/or the like. The location information may be in the form of a geolocation, a Global Navigation Satellite Service (GNSS) coordinate, a Cell identity (ID), and/or the like. The LS is accessible through the API defined in the Open Mobile Alliance (OMA) specification “RESTful Network API for Zonal Presence” OMA-TS-REST-NetAPI-ZonalPresence-V1-0-20160308-C. The Zonal Presence service utilizes the concept of “zone”, where a zone lends itself to be used to group all radio nodes that are associated to a MEC host 2502, or a subset thereof, according to a desired deployment. In this regard, the OMA Zonal Presence API provides means for MEC Apps 2526 to retrieve information about a zone, the access points associated to the zones and the users that are connected to the access points. In addition, the OMA Zonal Presence API, allows authorized application to subscribe to a notification mechanism, reporting about user activities within a zone. A MEC server 2502 may access location information or zonal presence information of individual UEs 2520 using the OMA Zonal Presence API to identify the relative location or positions of the UEs 2520.

The BWMS provides for the allocation of bandwidth to certain traffic routed to and from MEC Apps 2526, and specify static/dynamic up/down bandwidth resources, including bandwidth size and bandwidth priority. MEC Apps 2526 may use the BWMS to update/receive bandwidth information to/from the MEC platform 2532. Different MEC Apps 2526 running in parallel on the same MEC server 2502 may be allocated specific static, dynamic up/down bandwidth resources, including bandwidth size and bandwidth priority. The BWMS includes a bandwidth management (BWM) API to allowed registered applications to statically and/or dynamically register for specific bandwidth allocations per session/application. The BWM API includes HTTP protocol bindings for BWM functionality using RESTful services or some other suitable API mechanism.

The purpose of the UE Identity feature is to allow UE specific traffic rules in the MEC system 2500. When the MEC system 2500 supports the UE Identity feature, the MEC platform 2532 provides the functionality (e.g., UE Identity API) for a MEC App 2526 to register a tag representing a UE 2520 or a list of tags representing respective UEs 2520. Each tag is mapped into a specific UE 2520 in the MNO's system, and the MEC platform 2532 is provided with the mapping information. The UE Identity tag registration triggers the MEC platform 2532 to activate the corresponding traffic rule(s) 2540 linked to the tag. The MEC platform 2532 also provides the functionality (e.g., UE Identity API) for a MEC App 2526 to invoke a de-registration procedure to disable or otherwise stop using the traffic rule for that user.

The WAIS is a service that provides WLAN access related information to service consumers within the MEC System 2500. The WAIS is available for authorized MEC Apps 2526 and is discovered over the Mp1 reference point. The granularity of the WLAN Access Information may be adjusted based on parameters such as information per station, per NAN/AP, or per multiple APs (Multi-AP). The WLAN Access Information may be used by the service consumers to optimize the existing services and to provide new types of services that are based on up-to-date information from WLAN APs, possibly combined with the information such as RNI or Fixed Access Network Information. The WAIS defines protocols, data models, and interfaces in the form of RESTful APIs. Information about the APs and client stations can be requested either by querying or by subscribing to notifications, each of which include attribute-based filtering and attribute selectors.

The FAIS is a service that provides Fixed Access Network Information (or FAI) to service consumers within the MEC System 2500. The FAIS is available for the authorized MEC Apps 2526 and is discovered over the Mp1 reference point. The FAI may be used by MEC Apps 2526 and the MEC platform 2532 to optimize the existing services and to provide new types of services that are based on up-to-date information from the fixed access (e.g., NANs), possibly combined with other information such as RNI or WLAN Information from other access technologies. Service consumers interact with the FAIS over the FAI API to obtain contextual information from the fixed access network. Both the MEC Apps 2526 and the MEC platform 2532 may consume the FAIS; and both the MEC platform 2532 and the MEC Apps 2526 may be the providers of the FAI. The FAI API supports both queries and subscriptions (pub/sub mechanism) that are used over the RESTful API or over alternative transports such as a message bus. Alternative transports may also be used.

The MEC management comprises MEC system level management and MEC host level management. The MEC management comprises the MEC platform manager 2506 and the VI manager (VIM) 2508, and handles the management of MEC-specific functionality of a particular MEC server 2502 and the applications running on it. In some implementations, some or all of the multi-access edge management components may be implemented by one or more servers located in one or more data centers, and may use virtualization infrastructure that is connected with NFV infrastructure used to virtualize NFs, or using the same hardware as the NFV infrastructure.

The MEC platform manager 2506 is responsible for managing the life cycle of applications including informing the MEC orchestrator (MEC-O) 2510 of relevant application related events. The MEC platform manager 2506 may also provide MEC Platform Element management functions 2544 to the MEC platform 2532, manage MEC App rules and requirements 2546 including service authorizations, traffic rules, DNS configuration and resolving conflicts, and manage MEC App lifecycles mgmt 2548. The MEC platform manager 2506 may also receive virtualized resources, fault reports, and performance measurements from the VIM 2508 for further processing. The Mm5 reference point between the MEC platform manager 2506 and the MEC platform 2532 is used to perform platform configuration, configuration of the MEC Platform element mgmt 2544, MEC App rules and reqts 2546, MEC App lifecycles mgmt 2548, and management of application relocation.

The VIM 2508 may be an entity that allocates, manages and releases virtualized (compute, storage and networking) resources of the VI 2522, and prepares the VI 2522 to run a software image. To do so, the VIM 2508 may communicate with the VI 2522 over the Mm7 reference point between the VIM 2508 and the VI 2522. Preparing the VI 2522 may include configuring the VI 2522, and receiving/storing the software image. When supported, the VIM 2508 may provide rapid provisioning of applications, such as described in “Openstack++ for Cloudlet Deployments”, available at http://reports-archive.adm.cs.cmu.edu/anon/2015/CMU-CS-15-123.pdf. The VIM 2508 may also collect and report performance and fault information about the virtualized resources, and perform application relocation when supported. For application relocation from/to external cloud environments, the VIM 2508 may interact with an external cloud manager to perform the application relocation, for example using the mechanism described in “Adaptive VM Handoff Across Cloudlets”, and/or possibly through a proxy. Furthermore, the VIM 2508 may communicate with the MEC platform manager 2506 via the Mm6 reference point, which may be used to manage virtualized resources, for example, to realize the application lifecycle management. Moreover, the VIM 2508 may communicate with the MEC-O 2510 via the Mm4 reference point, which may be used to manage virtualized resources of the MEC server 2502, and to manage application images. Managing the virtualized resources may include tracking available resource capacity, etc.

The MEC system level management includes the MEC-O 2510, which has an overview of the complete MEC system 2500. The MEC-O 2510 may maintain an overall view of the MEC system 2500 based on deployed MEC hosts 2502, available resources, available MEC services 2536, and topology. The Mm3 reference point between the MEC-O 2510 and the MEC platform manager 2506 may be used for the management of the application lifecycle, application rules and requirements and keeping track of available MEC services 2536. The MEC-O 2510 may communicate with the user application lifecycle management proxy (UALMP) 2514 via the Mm9 reference point in order to manage MEC Apps 2526 requested by UE app 2518.

The MEC-O 2510 may also be responsible for on-boarding of application packages, including checking the integrity and authenticity of the packages, validating application rules and requirements and if necessary adjusting them to comply with operator policies, keeping a record of on-boarded packages, and preparing the VIM(s) 2508 to handle the applications. The MEC-O 2510 may select appropriate MEC host(s) 901 for application instantiation based on constraints, such as latency, available resources, and available services. The MEC-O 2510 may also trigger application instantiation and termination, as well as trigger application relocation as needed and when supported.

The Operations Support System (OSS) 2512 is the OSS of an operator that receives requests via the Customer Facing Service (CFS) portal 2516 over the Mx1 reference point and from UE apps 2518 for instantiation or termination of MEC Apps 2526. The OSS 2512 decides on the granting of these requests. The CFS portal 2516 (and the Mx1 interface) may be used by third-parties to request the MEC system 2500 to run apps 2518 in the MEC system 2500. Granted requests may be forwarded to the MEC-O 2510 for further processing. When supported, the OSS 2512 also receives requests from UE apps 2518 for relocating applications between external clouds and the MEC system 2500. The Mm2 reference point between the OSS 2512 and the MEC platform manager 2506 is used for the MEC platform manager 2506 configuration, fault and performance management. The Mm1 reference point between the MEC-O 2510 and the OSS 2512 is used for triggering the instantiation and the termination of MEC Apps 2526 in the MEC system 2500.

The UE app(s) 2518 (also referred to as “device applications” or the like) is one or more apps running in a device 2520 that has the capability to interact with the MEC system 2500 via the user application lifecycle management proxy 2514. The UE app(s) 2518 may be, include, or interact with one or more client applications, which in the context of MEC, is application software running on the device 2518 that utilizes functionality provided by one or more specific MEC Apps 2526. The user app LCM proxy 2514 may authorize requests from UE apps 2518 in the UE 2520 and interacts with the OSS 2512 and the MEC-O 2510 for further processing of these requests. The term “lifecycle management,” in the context of MEC, refers to a set of functions required to manage the instantiation, maintenance and termination of a MEC App 2526 instance. The user app LCM proxy 2514 may interact with the OSS 2512 via the Mm8 reference point, and is used to handle UE 2518 requests for running applications in the MEC system 2500. A user app may be an MEC App 2526 that is instantiated in the MEC system 2500 in response to a request of a user via an application running in the UE 2520 (e.g., UE App 2518). The user app LCM proxy 2514 allows UE apps 2518 to request on-boarding, instantiation, termination of user applications and when supported, relocation of user applications in and out of the MEC system 2500. It also allows informing the user apps about the state of the user apps. The user app LCM proxy 2514 is only accessible from within the mobile network, and may only be available when supported by the MEC system 2500. A UE app 2518 may use the Mx2 reference point between the user app LCM proxy 2514 and the UE app 2518 to request the MEC system 2500 to run an application in the MEC system 2500, or to move an application in or out of the MEC system 2500. The Mx2 reference point may only be accessible within the mobile network and may only be available when supported by the MEC system 2500.

In order to run an MEC App 2526 in the MEC system 2500, the MEC-O 2510 receives requests triggered by the OSS 2512, a third-party, or a UE app 2518. In response to receipt of such requests, the MEC-O 2510 selects a MEC server/host 2502 to host the MEC App 2526 for computational offloading, etc. These requests may include information about the application to be run, and possibly other information, such as the location where the application needs to be active, other application rules and requirements, as well as the location of the application image if it is not yet on-boarded in the MEC system 2500.

The MEC-O 2510 may select one or more MEC servers 2502 for computational intensive tasks. The selected one or more MEC servers XE136 may offload computational tasks of a UE app 2518 based on various operational parameters, such as network capabilities and conditions, computational capabilities and conditions, application requirements, and/or other like operational parameters. The application requirements may be rules and requirements associated to/with one or more MEC Apps 2526, such as deployment model of the application (e.g., whether it is one instance per user, one instance per host, one instance on each host, etc.); required virtualized resources (e.g., compute, storage, network resources, including specific hardware support); latency requirements (e.g., maximum latency, how strict the latency constraints are, latency fairness between users); requirements on location; multi-access edge services that are required and/or useful for the MEC Apps 2526 to be able to run; multi-access edge services that the MEC Apps 2526 can take advantage of, if available; connectivity or mobility support/requirements (e.g., application state relocation, application instance relocation); required multi-access edge features, such as VM relocation support or UE identity; required network connectivity (e.g., connectivity to applications within the MEC system 2500, connectivity to local networks, or to the Internet); information on the operator's MEC system 2500 deployment or mobile network deployment (e.g., topology, cost); requirements on access to user traffic; requirements on persistent storage; traffic rules 2540; DNS rules 2542; etc.

The MEC-O 2510 considers the requirements and information listed above and information on the resources currently available in the MEC system 2500 to select one or several MEC servers 2502 to host MEC Apps 2526 and/or for computational offloading. After one or more MEC servers XE136 are selected, the MEC-O 2510 requests the selected MEC host(s) 2502 to instantiate the application(s) or application tasks. The actual algorithm used to select the MEC servers 2502 depends on the implementation, configuration, and/or operator deployment. The selection algorithm(s) may be based on the task offloading criteria/parameters, for example, by taking into account network, computational, and energy consumption requirements for performing application tasks, as well as network functionalities, processing, and offloading coding/encodings, or differentiating traffic between various RATs. Under certain circumstances (e.g., UE mobility events resulting in increased latency, load balancing decisions, etc.), and if supported, the MEC-O 2510 may decide to select one or more new MEC hosts 2502 to act as a master node, and initiates the transfer of an application instance or application-related state information from the one or more source MEC hosts 2502 to the one or more target MEC hosts 2502.

In a first implementation, a user plane function (UPF) of the 5GS is mapped into the MEC architecture 2500 as the MEC data plane 2524. In these implementations, the UPF handles the user plane path of PDU sessions. Additionally, UPF provides the interface to a data network (DN) and supports the functionality of a PDU session anchor.

In a second implementation, an application function (AF) of the 5GS is mapped into the MEC architecture 2500 as the MEC platform 2532. In these implementations, the AF is configurable or operable to perform application influence on traffic routing, access network capability exposure, and interact with the policy framework for policy control. The second implementation may be combined with the first implementation, or may be a standalone implementation. In the first and/or second implementations, since user traffic is routed to the local DN, MEC apps 2526, 2527, and/or 2528 can be mapped in or to the DN of the 5GS.

In a third implementation, the RAN of 5GS can be a virtual RAN based on a VNF, and the UPF is configurable or operable to function as the MEC data plane 2524 within an NF virtualization infrastructure (NFVI) (e.g., VI 2522). In these implementations, the AF can be configured as MEC platform VNF (see e.g., discussion of FIG. 26, with MEC APIs, MEC application enablement functionality (see e.g., [MEC011]), and API principles functionality (see e.g., [MEC009]). Additionally, the local DN can include MEC apps 2526, 2527, and/or 2528 instantiated as VNFs. This implementation can be configured to provide functionalities in accordance with the [MEC003] and/or ETSI GR MEC 017 V1.1.1 (2018-02) (“[MEC017]”). The third implementation may be combined with the first implementation and/or the second implementation, or may be a standalone implementation.

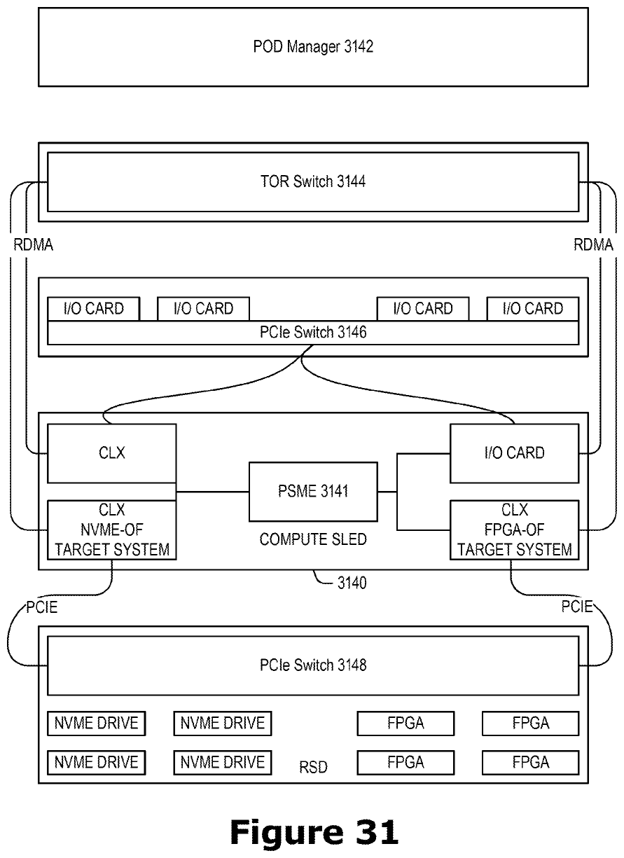

Additionally or alternatively, the access level edge (e.g., the NANs 3128, 3130, and 3132 of FIG. 31 and/or the other NANs discussed previously) can use one or more APIs to communicate with local/regional level edge networks. The local/regional level edge networks can include network nodes using corresponding applications to communicate with a national level edge network. The national level edge can include various NANs that use applications for accessing one or more remote clouds within the global level edge. The NANs are also configurable or operable for vertical segment management and SLA compliance. Additionally or alternatively, MEC deployment can be based on the definition of “edge” to provide degrees of freedom to MNOs, especially when deploying MEC in an NFV environment (e.g., MEC entities can be instantiated as Virtualized NFs (VNFs), thus with high flexibility in terms of deployment for the operator).

In some embodiments, MEC system 2500 can be flexibly deployed depending on the use case/vertical segment/information to be processed. Some components of the MEC system 2500 can be co-located with other elements of the system. As an example, in certain use cases (e.g., enterprise), a MEC app 2526 may need to consume a MEC service locally, and it may be efficient to deploy a MEC host locally equipped with the needed set of APIs. In another example, deploying a MEC server 2502 in a data center (which can be away from the access network) may not need to host some APIs like the RNI API (which can be used for gathering radio network information from the radio base station). On the other hand, RNI information can be elaborated and made available in the cloud RAN (CRAN) environments at the aggregation point, thus enabling the execution of suitable radio-aware traffic management algorithms. In some other aspects, a bandwidth management API may be present both at the access level edge and also in more remote edge locations, in order to set up transport networks (e.g., for CDN-based services).

FIG. 26 illustrates a MEC reference architecture 2600 in a NFV environment. The MEC architecture 2600 can be configured to provide functionalities in accordance with [ETSINFV]. The MEC architecture 2600 includes a MEC platform 2602, a MEC platform manager-NFV (MEPM-V) 2614, a data plane 2608, a NFV infrastructure (NFVI) 2610, VNF managers (VNFMs) 2620 and 2622, NFV orchestrator (NFVO) 2624, a MEC app orchestrator (MEAO) 2626, an OSS 2628, a user app LCM proxy 2630, a UE app 2634, and a CFS portal 2632. The MEC platform manager 2614 can include a MEC platform element management 2616 and MEC app rules and requirements management 2618. The MEC platform 2602 can be coupled to another MEC platform 2606 via an MP3 interface.

In this embodiments, the MEC platform 2602 is deployed as a VNF. The MEC applications 2604 can appear like VNFs towards the ETSI NFV Management and Orchestration (MANO) components. This allows re-use of ETSI NFV MANO functionality. The full set of MANO functionality may be unused and certain additional functionality may be needed. Such a specific MEC app is denoted by the name “MEC app VNF” or “MEA-VNF”. The virtualization infrastructure is deployed as an NFVI 2610 and its virtualized resources are managed by the virtualized infrastructure manager (VIM) 2612. For that purpose, one or more of the procedures defined by ETSI NFV Infrastructure specifications can be used (see e.g., ETSI GS NFV-INF 003 V2.4.1 (2018-02), ETSI GS NFV-INF 004 V2.4.1 (2018-02), ETSI GS NFV-INF 005 V3.2.1 (2019-04), and ETSI GS NFV-IFA 009 V1.1.1 (2016-07) (collectively “[ETSINFV]”)). The MEA-VNF 2604 are managed like individual VNFs, allowing that a MEC-in-NFV deployment can delegate certain orchestration and LCM tasks to the NFVO 2624 and VNFMs 2620 and 2622, as defined by ETSI NFV MANO.

When a MEC platform is implemented as a VNF (e.g., MEC platform VNF 2602), the MEPM-V 2614 may be configured to function as an Element Manager (EM). The MEAO 2626 uses the NFVO 2624 for resource orchestration, and for orchestration of the set of MEA-VNFs 2604 as one or more NFV Network Services (NSs). The MEPM-V 2614 delegates the LCM part to one or more VNFMs 2620 and 2622. A specific or generic VNFM 2620, 2622 is/are used to perform LCM. The MEPM-V 2614 and the VNFM (ME platform LCM) 2620 can be deployed as a single package as per the ensemble concept in 3GPP TR 32.842 v13.1.0 (2015 Dec. 21), or that the VNFM is a Generic VNFM and the MEC Platform VNF 2602 and the MEPM-V 2614 are provided by a single vendor.

The Mp1 reference point between a MEC app 2604 and the MEC platform 2614 can be optional for the MEC app 2604, unless it is an application that provides and/or consumes a MEC service. The Mm3* reference point between MEAO 2626 and the MEPM-V 2614 is based on the Mm3 reference point (see e.g., [MEC003]). Changes may be configured to this reference point to cater for the split between MEPM-V 2614 and VNFM (ME applications LCM) 2622. The following new reference points (Mv1, Mv2, and Mv3) are introduced between elements of the ETSI MEC architecture and the ETSI NFV architecture to support the management of ME app VNFs 2604.

The following reference points are related to existing NFV reference points, but only a subset of the functionality may be used for ETSI MEC, and extensions may be necessary. Mv1 is a reference point connecting the MEAO 2626 and the NFVO 2624, and is related to the Os-Ma-nfvo reference point as defined in ETSI NFV). Mv2 is a reference point connecting the VNFM 2622 that performs the LCM of the MEC app VNFs 2604 with the MEPM-V 2614 to allow LCM related notifications to be exchanged between these entities. Mv2 is related to the Ve-Vnfm-em reference point as defined in ETSI NFV, but may possibly include additions, and might not use all functionality offered by the Ve-Vnfm-em. Mv3 is a reference point connecting the VNFM 2622 with the ME app VNF 2604 instance to allow the exchange of messages (e.g., related to MEC app LCM or initial deployment-specific configuration). Mv3 is related to the Ve-Vnfm-vnf reference point, as defined in ETSI NFV, but may include additions, and might not use all functionality offered by Ve-Vnfm-vnf.

The following reference points are used as they are defined by ETSI NFV: Nf-Vn reference point connects each ME app VNF 2604 with the NFVI 2610. The Nf-Vi reference point connects the NFVI 2610 and the VIM 2612. The Os-Ma-nfvo reference point connects the OSS 2628 and the NFVO 2624 and is primarily used to manage NSs (e.g., a number of VNFs connected and orchestrated to deliver a service). The Or-Vnfm reference point connects the NFVO 2624 and the VNFM (MEC Platform LCM) 2620 and is primarily used for the NFVO 2624 to invoke VNF LCM operations. Vi-Vnfm reference point connects the VIM 2612 and the VNFM (MEC Platform LCM) 2620 and is primarily used by the VNFM 2620 to invoke resource management operations to manage cloud resources that are needed by the VNF (it is assumed in an NFV-based MEC deployment that this reference point corresponds 1:1 to Mm6). The Or-Vi reference point connects the NFVO 2624 and the VIM 2612 and is primarily used by the NFVO 2624 to manage cloud resources capacity. The Ve-Vnfm-em reference point connects the VNFM (MEC Platform LCM) 2620 with the MEPM-V 2614. The Ve-Vnfm-vnf reference point connects the VNFM (MEC Platform LCM) 2620 with the MEC Platform VNF 2602.

### III.C. Hardware Components

FIG. 27A illustrates a first edge computing hardware configuration, which maps various architectural aspects of an edge platform 2710 (e.g., compute hardware, network features, power management features, etc.) to specific edge platform capabilities 2720 (e.g., I/O pooling, acceleration pooling, memory pooling, acceleration technologies, storage capabilities). To offer the edge configuration as an overall solution for services, then the workloads or basic hardware components for services and service requirements/constraints (e.g., network and I/O, platform acceleration, power) are considered in light of available architectural aspects (e.g., pooling, storage, etc.).

Within the edge platform capabilities 2720, specific acceleration types may be configured or identified in order to ensure service density is satisfied across the edge cloud. Specifically, four primary acceleration types may be deployed in an edge cloud configuration: (1) General Acceleration (e.g., FPGAs) to implement basic blocks such as a Fast Fourier transform (FFT), k-nearest neighbors algorithm (KNN) and machine learning workloads; (2) Image, Video and transcoding accelerators; (3) Inferencing accelerators; (4) Crypto and compression related workloads (implemented such as in Intel® QuickAssist™ technology). Thus, the particular design or configuration of the edge platform capabilities 2720 can consider which is the right type of acceleration and platform product models that needs to be selected in order to accommodate the service and throughput density as well as available power.

FIG. 27B illustrates a second edge computing hardware configuration, offering a second edge platform 2730 with a second set of edge platform capabilities 2740. This configuration may be deployable as a low power but more service-dense solution. This approach is targeted to define a lower power solution which uses acceleration schemes in order to achieve better service density or service throughout per watt. This main design trade-off leads to a platform that uses sacrifices general compute in favor specialized hardware (e.g., FPGAs, inferencing accelerators) that can perform the same work at better performance-per-watt ratio. In this example, a “service dense” solution enables more service actions per platform and per watt or being able to drive more throughput at a service level per watt.

The platform capabilities 2740 may be designed to be favorable in terms of power envelope as well in terms of physical space. As a result, the configuration of FIG. 27B may provide a suitable target for base station deployments. However, the platform capabilities 2740 may have tradeoffs including: (1) requirements in terms of orchestration, maintenance and system management (which can be translated to OPEX/TCO costs); (2) requiring an operator ecosystem to enable all a system stack to work with different accelerators that are exposed. However, these disadvantages may be mitigated with a developed software abstraction layer.

FIG. 27C illustrates a third edge computing hardware configuration, offering a third edge platform 2750 with a second set of edge platform capabilities 2760. This configuration offers a high power yet homogenous and generic architecture. FIG. 27C provides an approach that is opposite as compared FIG. 27B, to provide a platform architecture with reduced heterogeneity in the different types of resources that an operator or edge owner has to deal with respect to management, maintenance and orchestration. However, removing accelerators in favor of homogeneity comes at a cost of having less service density and service throughput per watt at platform level. In further examples, the edge platform capabilities 2760 may implement general purpose acceleration (such as in the form of FPGAs).

Other derivative functions of the edge platforms depicted in FIGS. 27A-C may also be adapted. For example, the platform can be sized and designed in order to incorporate new ingredients that make it more service and throughput dense but keeping it more homogenous by for example including accelerators inside the platform or on die in order to make them seamlessly manageable to the operators.

FIGS. 28 and 29 depict further examples of edge computing systems and environments that may fulfill any of the compute nodes or devices discussed herein. Respective edge compute nodes may be embodied as a type of device, appliance, computer, or other “thing” capable of communicating with other edge, networking, or endpoint components. For example, an edge compute device may be embodied as a smartphone, a mobile compute device, a smart appliance, an in-vehicle compute system (e.g., a navigation system), or other device or system capable of performing the described functions.

In FIG. 28, an edge compute node 2800 includes a compute engine (also referred to herein as “compute circuitry”) 2802, an input/output (I/O) subsystem 2808, data storage 2810, a communication circuitry subsystem 2812, and, optionally, one or more peripheral devices 2814. In other examples, respective compute devices may include other or additional components, such as those typically found in a computer (e.g., a display, peripheral devices, etc.). Additionally, in some examples, one or more of the illustrative components may be incorporated in, or otherwise form a portion of, another component.

The compute node 2800 may be embodied as any type of engine, device, or collection of devices capable of performing various compute functions. In some examples, the compute node 2800 may be embodied as a single device such as an integrated circuit, an embedded system, an FPGA, a System-on-Chip (SoC), or other integrated system or device. The compute node 2800 includes or is embodied as a processor 2804 and a memory 2806. The processor 2804 may be embodied as any type of processor capable of performing the functions described herein (e.g., executing an application). For example, the processor 2804 may be embodied as a multi-core processor(s), a microcontroller, or other processor or processing/controlling circuit. In some examples, the processor 2804 may be embodied as, include, or be coupled to an FPGA, an application specific integrated circuit (ASIC), reconfigurable hardware or hardware circuitry, or other specialized hardware to facilitate performance of the functions described herein.

The main memory 2806 may be embodied as any type of volatile (e.g., dynamic random access memory (DRAM), etc.) or non-volatile memory or data storage capable of performing the functions described herein. Volatile memory may be a storage medium that requires power to maintain the state of data stored by the medium. Non-limiting examples of volatile memory may include various types of random access memory (RAM), such as DRAM or static random access memory (SRAM). One particular type of DRAM that may be used in a memory module is synchronous dynamic random access memory (SDRAM).

In one example, the memory device is a block addressable memory device, such as those based on NAND or NOR technologies. A memory device may also include a three dimensional cross point memory device (e.g., Intel® 3D XPoint™ memory), or other byte addressable write-in-place nonvolatile memory devices. The memory device may refer to the die itself and/or to a packaged memory product. In some examples, 3D crosspoint memory (e.g., Intel® 3D XPoint™ memory) may comprise a transistor-less stackable cross point architecture in which memory cells sit at the intersection of word lines and bit lines and are individually addressable and in which bit storage is based on a change in bulk resistance. In some examples, all or a portion of the main memory 2806 may be integrated into the processor 2804. The main memory 2806 may store various software and data used during operation such as one or more applications, data operated on by the application(s), libraries, and drivers.

The compute circuitry 2802 is communicatively coupled to other components of the compute node 2800 via the I/O subsystem 2808, which may be embodied as circuitry and/or components to facilitate input/output operations with the compute circuitry 2802 (e.g., with the processor 2804 and/or the main memory 2806) and other components of the compute circuitry 2802. For example, the I/O subsystem 2808 may be embodied as, or otherwise include, memory controller hubs, input/output control hubs, integrated sensor hubs, firmware devices, communication links (e.g., point-to-point links, bus links, wires, cables, light guides, printed circuit board traces, etc.), and/or other components and subsystems to facilitate the input/output operations. In some examples, the I/O subsystem 2808 may form a portion of a system-on-a-chip (SoC) and be incorporated, along with one or more of the processor 2804, the main memory 2806, and other components of the compute circuitry 2802, into the compute circuitry 2802.

The one or more illustrative data storage devices 2810 may be embodied as any type of devices configured for short-term or long-term storage of data such as, for example, memory devices and circuits, memory cards, hard disk drives, solid-state drives, or other data storage devices. Individual data storage devices 2810 may include a system partition that stores data and firmware code for the data storage device 2810. Individual data storage devices 2810 may also include one or more operating system partitions that store data files and executables for operating systems depending on, for example, the type of compute node 2800.

The communication circuitry 2812 may be embodied as any communication circuit, device, or collection thereof, capable of enabling communications over a network between the compute circuitry 2802 and another compute device (e.g., an edge gateway node or the like). The communication circuitry 2812 may be configured to use any one or more communication technology (e.g., wired or wireless communications) and associated protocols (e.g., a cellular networking protocol such a 3GPP 4G or 5G standard, a wireless local area network protocol such as IEEE 802.11/Wi-Fi, a wireless wide area network protocol, Ethernet, Bluetooth®, Bluetooth Low Energy, a IoT protocol such as IEEE 802.15.4 or ZigBee®, low-power wide-area network (LPWAN) or low-power wide-area (LPWA) protocols, etc.) to effect such communication.

The illustrative communication circuitry 2812 includes a network interface controller (NIC) 2820, which may also be referred to as a host fabric interface (HFI). The NIC 2820 may be embodied as one or more add-in-boards, daughter cards, network interface cards, controller chips, chipsets, or other devices that may be used by the compute node 2800 to connect with another compute device. In some examples, the NIC 2820 may be embodied as part of a system-on-a-chip (SoC) that includes one or more processors, or included on a multichip package that also contains one or more processors. In some examples, the NIC 2820 may include a local processor (not shown) and/or a local memory (not shown) that are both local to the NIC 2820. In such examples, the local processor of the NIC 2820 may be capable of performing one or more of the functions of the compute circuitry 2802 described herein. Additionally, or alternatively, in such examples, the local memory of the NIC 2820 may be integrated into one or more components of the client compute node at the board level, socket level, chip level, and/or other levels.

Additionally, in some examples, a respective compute node 2800 may include one or more peripheral devices 2814. Such peripheral devices 2814 may include any type of peripheral device found in a compute device or server such as audio input devices, a display, other input/output devices, interface devices, and/or other peripheral devices, depending on the particular type of the compute node 2800. In further examples, the compute node 2800 may be embodied by a respective edge compute node in an edge computing system (e.g., client compute node, edge gateway node, edge aggregation node, V-ITS-Ss discussed previous, etc.) or like forms of appliances, computers, subsystems, circuitry, or other components.

FIG. 29 illustrates an example of components that may be present in an edge computing node 2950 for implementing the techniques (e.g., operations, processes, methods, and methodologies) described herein. This edge computing node 2950 provides a closer view of the respective components of node 2900 when implemented as or as part of a computing device (e.g., as a mobile device, a base station, server, gateway, etc.). The edge computing node 2950 may include any combinations of the hardware or logical components referenced herein, and it may include or couple with any device usable with an edge communication network or a combination of such networks. The components may be implemented as ICs, portions thereof, discrete electronic devices, or other modules, instruction sets, programmable logic or algorithms, hardware, hardware accelerators, software, firmware, or a combination thereof adapted in the edge computing node 2950, or as components otherwise incorporated within a chassis of a larger system.

The edge computing node 2950 includes processing circuitry in the form of one or more processors 2852. The processor circuitry 2952 includes circuitry such as, but not limited to one or more processor cores and one or more of cache memory, low drop-out voltage regulators (LDOs), interrupt controllers, serial interfaces such as SPI, I2C or universal programmable serial interface circuit, real time clock (RTC), timer-counters including interval and watchdog timers, general purpose I/O, memory card controllers such as secure digital/multi-media card (SD/MMC) or similar, interfaces, mobile industry processor interface (MIPI) interfaces and Joint Test Access Group (JTAG) test access ports. In some implementations, the processor circuitry 2952 may include one or more hardware accelerators (e.g., same or similar to acceleration circuitry 2964), which may be microprocessors, programmable processing devices (e.g., FPGA, ASIC, etc.), or the like. The one or more accelerators may include, for example, computer vision and/or deep learning accelerators. In some implementations, the processor circuitry 2952 may include on-chip memory circuitry, which may include any suitable volatile and/or non-volatile memory, such as DRAM, SRAM, EPROM, EEPROM, Flash memory, solid-state memory, and/or any other type of memory device technology, such as those discussed herein

The processor circuitry 2952 may include, for example, one or more processor cores (CPUs), application processors, GPUs, RISC processors, Acorn RISC Machine (ARM) processors, CISC processors, one or more DSPs, one or more FPGAs, one or more PLDs, one or more ASICs, one or more baseband processors, one or more radio-frequency integrated circuits (RFIC), one or more microprocessors or controllers, a multi-core processor, a multithreaded processor, an ultra-low voltage processor, an embedded processor, or any other known processing elements, or any suitable combination thereof. The processors (or cores) 2952 may be coupled with or may include memory/storage and may be configured to execute instructions stored in the memory/storage to enable various applications or operating systems to run on the platform 2950. The processors (or cores) 2952 is configured to operate application software to provide a specific service to a user of the platform 2950. In some embodiments, the processor(s) 2952 may be a special-purpose processor(s)/controller(s) configured (or configurable) to operate according to the various embodiments herein.

As examples, the processor(s) 2952 may include an Intel® Architecture Core™ based processor such as an i3, an i5, an i7, an i9 based processor; an Intel® microcontroller-based processor such as a Quark™, an Atom™, or other MCU-based processor; Pentium® processor(s), Xeon® processor(s), or another such processor available from Intel® Corporation, Santa Clara, Calif. However, any number other processors may be used, such as one or more of Advanced Micro Devices (AMD) Zen® Architecture such as Ryzen® or EPYC® processor(s), Accelerated Processing Units (APUs), MxGPUs, Epyc® processor(s), or the like; A5-A12 and/or S1-S4 processor(s) from Apple® Inc., Snapdragon™ or Centriq™ processor(s) from Qualcomm® Technologies, Inc., Texas Instruments, Inc.® Open Multimedia Applications Platform (OMAP)™ processor(s); a MIPS-based design from MIPS Technologies, Inc. such as MIPS Warrior M-class, Warrior I-class, and Warrior P-class processors; an ARM-based design licensed from ARM Holdings, Ltd., such as the ARM Cortex-A, Cortex-R, and Cortex-M family of processors; the ThunderX2® provided by Cavium™, Inc.; or the like. In some implementations, the processor(s) 2952 may be a part of a system on a chip (SoC), System-in-Package (SiP), a multi-chip package (MCP), and/or the like, in which the processor(s) 2952 and other components are formed into a single integrated circuit, or a single package, such as the Edison™ or Galileo™ SoC boards from Intel® Corporation. Other examples of the processor(s) 2952 are mentioned elsewhere in the present disclosure.

The processor(s) 2952 may communicate with system memory 2954 over an interconnect (IX) 2956. Any number of memory devices may be used to provide for a given amount of system memory. As examples, the memory may be random access memory (RAM) in accordance with a Joint Electron Devices Engineering Council (JEDEC) design such as the DDR or mobile DDR standards (e.g., LPDDR, LPDDR2, LPDDR3, or LPDDR4). In particular examples, a memory component may comply with a DRAM standard promulgated by JEDEC, such as JESD79F for DDR SDRAM, JESD79-2F for DDR2 SDRAM, JESD79-3F for DDR3 SDRAM, JESD79-4A for DDR4 SDRAM, JESD209 for Low Power DDR (LPDDR), JESD209-2 for LPDDR2, JESD209-3 for LPDDR3, and JESD209-4 for LPDDR4. Other types of RAM, such as dynamic RAM (DRAM), synchronous DRAM (SDRAM), and/or the like may also be included. Such standards (and similar standards) may be referred to as DDR-based standards and communication interfaces of the storage devices that implement such standards may be referred to as DDR-based interfaces. In various implementations, the individual memory devices may be of any number of different package types such as single die package (SDP), dual die package (DDP) or quad die package (Q17P). These devices, in some examples, may be directly soldered onto a motherboard to provide a lower profile solution, while in other examples the devices are configured as one or more memory modules that in turn couple to the motherboard by a given connector. Any number of other memory implementations may be used, such as other types of memory modules, e.g., dual inline memory modules (DIMMs) of different varieties including but not limited to microDIMMs or MiniDIMMs.

To provide for persistent storage of information such as data, applications, operating systems and so forth, a storage 2958 may also couple to the processor 2952 via the IX 2956. In an example, the storage 2958 may be implemented via a solid-state disk drive (SSDD) and/or high-speed electrically erasable memory (commonly referred to as “flash memory”). Other devices that may be used for the storage 2958 include flash memory cards, such as SD cards, microSD cards, XD picture cards, and the like, and USB flash drives. In an example, the memory device may be or may include memory devices that use chalcogenide glass, multi-threshold level NAND flash memory, NOR flash memory, single or multi-level Phase Change Memory (PCM), a resistive memory, nanowire memory, ferroelectric transistor random access memory (FeTRAM), anti-ferroelectric memory, magnetoresistive random access memory (MRAM) memory that incorporates memristor technology, phase change RAM (PRAM), resistive memory including the metal oxide base, the oxygen vacancy base and the conductive bridge Random Access Memory (CB-RAM), or spin transfer torque (STT)-MRAM, a spintronic magnetic junction memory based device, a magnetic tunneling junction (MTJ) based device, a Domain Wall (DW) and Spin Orbit Transfer (SOT) based device, a thyristor based memory device, or a combination of any of the above, or other memory. The memory circuitry 2954 and/or storage circuitry 2958 may also incorporate three-dimensional (3D) cross-point (XPOINT) memories from Intel® and Micron®.

In low power implementations, the storage 2958 may be on-die memory or registers associated with the processor 2952. However, in some examples, the storage 2858 may be implemented using a micro hard disk drive (HDD). Further, any number of new technologies may be used for the storage 2958 in addition to, or instead of, the technologies described, such resistance change memories, phase change memories, holographic memories, or chemical memories, among others.

The components of edge computing device 2950 may communicate over the IX 2956. The IX 2956 may include any number of technologies, including ISA, extended ISA, I2C, SPI, point-to-point interfaces, power management bus (PMBus), PCI, PCIe, PCIx, Intel® UPI, Intel® Accelerator Link, Intel® CXL, CAPI, OpenCAPI, Intel® QPI, UPI, Intel® OPA IX, RapidIO™ system IXs, CCIX, Gen-Z Consortium IXs, a HyperTransport interconnect, NVLink provided by NVIDIA®, a Time-Trigger Protocol (TTP) system, a FlexRay system, PROFIBUS, and/or any number of other IX technologies. The IX 2956 may be a proprietary bus, for example, used in a SoC based system.

The IX 2956 couples the processor 2952 to communication circuitry 2966 for communications with other devices, such as a remote server (not shown) and/or the connected edge devices 2962. The communication circuitry 2966 is a hardware element, or collection of hardware elements, used to communicate over one or more networks (e.g., cloud 2963) and/or with other devices (e.g., edge devices 2962).

The transceiver 2966 may use any number of frequencies and protocols, such as 2.4 Gigahertz (GHz) transmissions under the IEEE 802.15.4 standard, using the Bluetooth® low energy (BLE) standard, as defined by the Bluetooth® Special Interest Group, or the ZigBee® standard, among others. Any number of radios, configured for a particular wireless communication protocol, may be used for the connections to the connected edge devices 2962. For example, a wireless local area network (WLAN) unit may be used to implement Wi-Fi® communications in accordance with the Institute of Electrical and Electronics Engineers (IEEE) 802.11 standard. In addition, wireless wide area communications, e.g., according to a cellular or other wireless wide area protocol, may occur via a wireless wide area network (WWAN) unit.

The wireless network transceiver 2966 (or multiple transceivers) may communicate using multiple standards or radios for communications at a different range. For example, the edge computing node 2950 may communicate with close devices, e.g., within about 10 meters, using a local transceiver based on BLE, or another low power radio, to save power. More distant connected edge devices 2962, e.g., within about 50 meters, may be reached over ZigBee® or other intermediate power radios. Both communications techniques may take place over a single radio at different power levels or may take place over separate transceivers, for example, a local transceiver using BLE and a separate mesh transceiver using ZigBee®.

A wireless network transceiver 2966 (e.g., a radio transceiver) may be included to communicate with devices or services in the edge cloud 2963 via local or wide area network protocols. The wireless network transceiver 2966 may be an LPWA transceiver that follows the IEEE 802.15.4, or IEEE 802.15.4g standards, among others. The edge computing node 2963 may communicate over a wide area using LoRaWAN™ (Long Range Wide Area Network) developed by Semtech and the LoRa Alliance. The techniques described herein are not limited to these technologies but may be used with any number of other cloud transceivers that implement long range, low bandwidth communications, such as Sigfox, and other technologies. Further, other communications techniques, such as time-slotted channel hopping, described in the IEEE 802.15.4e specification may be used.

Any number of other radio communications and protocols may be used in addition to the systems mentioned for the wireless network transceiver 2966, as described herein. For example, the transceiver 2966 may include a cellular transceiver that uses spread spectrum (SPA/SAS) communications for implementing high-speed communications. Further, any number of other protocols may be used, such as Wi-Fi® networks for medium speed communications and provision of network communications. The transceiver 2966 may include radios that are compatible with any number of 3GPP specifications, such as LTE and 5G/NR communication systems, discussed in further detail at the end of the present disclosure. A network interface controller (NIC) 2968 may be included to provide a wired communication to nodes of the edge cloud 2963 or to other devices, such as the connected edge devices 2962 (e.g., operating in a mesh). The wired communication may provide an Ethernet connection or may be based on other types of networks, such as Controller Area Network (CAN), Local Interconnect Network (LIN), DeviceNet, ControlNet, Data Highway+, or PROFINET, among many others. An additional NIC 2968 may be included to enable connecting to a second network, for example, a first NIC 2968 providing communications to the cloud over Ethernet, and a second NIC 2968 providing communications to other devices over another type of network.

Given the variety of types of applicable communications from the device to another component or network, applicable communications circuitry used by the device may include or be embodied by any one or more of components 2964, 2966, 292868, or 2970. Accordingly, in various examples, applicable means for communicating (e.g., receiving, transmitting, etc.) may be embodied by such communications circuitry.

The edge computing node 2950 may include or be coupled to acceleration circuitry 2964, which may be embodied by one or more AI accelerators, a neural compute stick, neuromorphic hardware, an FPGA, an arrangement of GPUs, one or more SoCs (including programmable SoCs), one or more CPUs, one or more digital signal processors, dedicated ASICs (including programmable ASICs), PLDs such as CPLDs or HCPLDs, and/or other forms of specialized processors or circuitry designed to accomplish one or more specialized tasks. These tasks may include AI processing (including machine learning, training, inferencing, and classification operations), visual data processing, network data processing, object detection, rule analysis, or the like. In FPGA-based implementations, the acceleration circuitry 2964 may comprise logic blocks or logic fabric and other interconnected resources that may be programmed (configured) to perform various functions, such as the procedures, methods, functions, etc. of the various embodiments discussed herein. In such implementations, the acceleration circuitry 2964 may also include memory cells (e.g., EPROM, EEPROM, flash memory, static memory (e.g., SRAM, anti-fuses, etc.) used to store logic blocks, logic fabric, data, etc. in LUTs and the like.

The IX 2956 also couples the processor 2952 to a sensor hub or external interface 2970 that is used to connect additional devices or subsystems. The additional/external devices may include sensors 2972, actuators 2974, and positioning circuitry 2945.

The sensor circuitry 2972 includes devices, modules, or subsystems whose purpose is to detect events or changes in its environment and send the information (sensor data) about the detected events to some other a device, module, subsystem, etc. Examples of such sensors 2972 include, inter alia, inertia measurement units (IMU) comprising accelerometers, gyroscopes, and/or magnetometers; microelectromechanical systems (MEMS) or nanoelectromechanical systems (NEMS) comprising 3-axis accelerometers, 3-axis gyroscopes, and/or magnetometers; level sensors; flow sensors; temperature sensors (e.g., thermistors); pressure sensors; barometric pressure sensors; gravimeters; altimeters; image capture devices (e.g., cameras); light detection and ranging (LiDAR) sensors; proximity sensors (e.g., infrared radiation detector and the like); depth sensors, ambient light sensors; optical light sensors; ultrasonic transceivers; microphones; and the like.

The actuators 2974, allow platform 2950 to change its state, position, and/or orientation, or move or control a mechanism or system. The actuators 2974 comprise electrical and/or mechanical devices for moving or controlling a mechanism or system, and converts energy (e.g., electric current or moving air and/or liquid) into some kind of motion. The actuators 2974 may include one or more electronic (or electrochemical) devices, such as piezoelectric biomorphs, solid state actuators, solid state relays (SSRs), shape-memory alloy-based actuators, electroactive polymer-based actuators, relay driver integrated circuits (ICs), and/or the like. The actuators 2974 may include one or more electromechanical devices such as pneumatic actuators, hydraulic actuators, electromechanical switches including electromechanical relays (EMRs), motors (e.g., DC motors, stepper motors, servomechanisms, etc.), power switches, valve actuators, wheels, thrusters, propellers, claws, clamps, hooks, audible sound generators, visual warning devices, and/or other like electromechanical components. The platform 2950 may be configured to operate one or more actuators 2974 based on one or more captured events and/or instructions or control signals received from a service provider and/or various client systems

The positioning circuitry 2945 includes circuitry to receive and decode signals transmitted/broadcasted by a positioning network of a global navigation satellite system (GNSS). Examples of navigation satellite constellations (or GNSS) include United States' Global Positioning System (GPS), Russia's Global Navigation System (GLONASS), the European Union's Galileo system, China's BeiDou Navigation Satellite System, a regional navigation system or GNSS augmentation system (e.g., Navigation with Indian Constellation (NAVIC), Japan's Quasi-Zenith Satellite System (QZSS), France's Doppler Orbitography and Radio-positioning Integrated by Satellite (DORIS), etc.), or the like. The positioning circuitry 2945 comprises various hardware elements (e.g., including hardware devices such as switches, filters, amplifiers, antenna elements, and the like to facilitate OTA communications) to communicate with components of a positioning network, such as navigation satellite constellation nodes. In some embodiments, the positioning circuitry 2945 may include a Micro-Technology for Positioning, Navigation, and Timing (Micro-PNT) IC that uses a master timing clock to perform position tracking/estimation without GNSS assistance. The positioning circuitry 2945 may also be part of, or interact with, the communication circuitry 2966 to communicate with the nodes and components of the positioning network. The positioning circuitry 2945 may also provide position data and/or time data to the application circuitry, which may use the data to synchronize operations with various infrastructure (e.g., radio base stations), for turn-by-turn navigation, or the like. When a GNSS signal is not available or when GNSS position accuracy is not sufficient for a particular application or service, a positioning augmentation technology can be used to provide augmented positioning information and data to the application or service. Such a positioning augmentation technology may include, for example, satellite based positioning augmentation (e.g., EGNOS) and/or ground based positioning augmentation (e.g., DGPS). In some implementations, the positioning circuitry 2945 is, or includes an INS, which is a system or device that uses sensor circuitry 2972 (e.g., motion sensors such as accelerometers, rotation sensors such as gyroscopes, and altimeters, magnetic sensors, and/or the like to continuously calculate (e.g., using dead by dead reckoning, triangulation, or the like) a position, orientation, and/or velocity (including direction and speed of movement) of the platform 2950 without the need for external references.

In some optional examples, various input/output (I/O) devices may be present within or connected to, the edge computing node 2950, which are referred to as input circuitry 2986 and output circuitry 2984 in FIG. 29. The input circuitry 292886 and output circuitry 2984 include one or more user interfaces designed to enable user interaction with the platform 2950 and/or peripheral component interfaces designed to enable peripheral component interaction with the platform 2950. Input circuitry 2986 may include any physical or virtual means for accepting an input including, inter alia, one or more physical or virtual buttons (e.g., a reset button), a physical keyboard, keypad, mouse, touchpad, touchscreen, microphones, scanner, headset, and/or the like. The output circuitry 2984 may be included to show information or otherwise convey information, such as sensor readings, actuator position(s), or other like information. Data and/or graphics may be displayed on one or more user interface components of the output circuitry 2984. Output circuitry 2984 may include any number and/or combinations of audio or visual display, including, inter alia, one or more simple visual outputs/indicators (e.g., binary status indicators (e.g., light emitting diodes (LEDs)) and multi-character visual outputs, or more complex outputs such as display devices or touchscreens (e.g., Liquid Chrystal Displays (LCD), LED displays, quantum dot displays, projectors, etc.), with the output of characters, graphics, multimedia objects, and the like being generated or produced from the operation of the platform 2950. The output circuitry 2984 may also include speakers or other audio emitting devices, printer(s), and/or the like. In some embodiments, the sensor circuitry 292872 may be used as the input circuitry 2984 (e.g., an image capture device, motion capture device, or the like) and one or more actuators 2974 may be used as the output device circuitry 2984 (e.g., an actuator to provide haptic feedback or the like). In another example, near-field communication (NFC) circuitry comprising an NFC controller coupled with an antenna element and a processing device may be included to read electronic tags and/or connect with another NFC-enabled device. Peripheral component interfaces may include, but are not limited to, a non-volatile memory port, a USB port, an audio jack, a power supply interface, etc. A display or console hardware, in the context of the present system, may be used to provide output and receive input of an edge computing system; to manage components or services of an edge computing system; identify a state of an edge computing component or service; or to conduct any other number of management or administration functions or service use cases.

A battery 2976 may power the edge computing node 2950, although, in examples in which the edge computing node 2950 is mounted in a fixed location, it may have a power supply coupled to an electrical grid, or the battery may be used as a backup or for temporary capabilities. The battery 2976 may be a lithium ion battery, or a metal-air battery, such as a zinc-air battery, an aluminum-air battery, a lithium-air battery, and the like.

A battery monitor/charger 2978 may be included in the edge computing node 2950 to track the state of charge (SoCh) of the battery 2976, if included. The battery monitor/charger 2978 may be used to monitor other parameters of the battery 2976 to provide failure predictions, such as the state of health (SoH) and the state of function (SoF) of the battery 2976. The battery monitor/charger 2978 may include a battery monitoring integrated circuit, such as an LTC4020 or an LTC2990 from Linear Technologies, an ADT7488A from ON Semiconductor of Phoenix Ariz., or an IC from the UCD90xxx family from Texas Instruments of Dallas, Tex. The battery monitor/charger 2978 may communicate the information on the battery 2976 to the processor 2952 over the IX 2956. The battery monitor/charger 2978 may also include an analog-to-digital (ADC) converter that enables the processor 2952 to directly monitor the voltage of the battery 2976 or the current flow from the battery 2976. The battery parameters may be used to determine actions that the edge computing node 2950 may perform, such as transmission frequency, mesh network operation, sensing frequency, and the like.

A power block 2980, or other power supply coupled to a grid, may be coupled with the battery monitor/charger 2978 to charge the battery 2976. In some examples, the power block 2980 may be replaced with a wireless power receiver to obtain the power wirelessly, for example, through a loop antenna in the edge computing node 2950. A wireless battery charging circuit, such as an LTC4020 chip from Linear Technologies of Milpitas, Calif., among others, may be included in the battery monitor/charger 2978. The specific charging circuits may be selected based on the size of the battery 2976, and thus, the current required. The charging may be performed using the Airfuel standard promulgated by the Airfuel Alliance, the Qi wireless charging standard promulgated by the Wireless Power Consortium, or the Rezence charging standard, promulgated by the Alliance for Wireless Power, among others.

The storage 2958 may include instructions 2982 in the form of software, firmware, or hardware commands to implement the techniques described herein. Although such instructions 2982 are shown as code blocks included in the memory 2954 and the storage 2958, it may be understood that any of the code blocks may be replaced with hardwired circuits, for example, built into an application specific integrated circuit (ASIC).

In an example, the instructions 2882 provided via the memory 2954, the storage 2958, or the processor 2952 may be embodied as a non-transitory, machine-readable medium 2960 including code to direct the processor 2952 to perform electronic operations in the edge computing node 2950. The processor 2952 may access the non-transitory, machine-readable medium 2960 over the IX 2956. For instance, the non-transitory, machine-readable medium 2960 may be embodied by devices described for the storage 2958 or may include specific storage units such as optical disks, flash drives, or any number of other hardware devices. The non-transitory, machine-readable medium 2960 may include instructions to direct the processor 2952 to perform a specific sequence or flow of actions, for example, as described with respect to the flowchart(s) and block diagram(s) of operations and functionality depicted above. As used herein, the terms “machine-readable medium” and “computer-readable medium” are interchangeable.

In further examples, a machine-readable medium also includes any tangible medium that is capable of storing, encoding or carrying instructions for execution by a machine and that cause the machine to perform any one or more of the methodologies of the present disclosure or that is capable of storing, encoding or carrying data structures utilized by or associated with such instructions. A “machine-readable medium” thus may include but is not limited to, solid-state memories, and optical and magnetic media. Specific examples of machine-readable media include non-volatile memory, including but not limited to, by way of example, semiconductor memory devices (e.g., electrically programmable read-only memory (EPROM), electrically erasable programmable read-only memory (EEPROM)) and flash memory devices; magnetic disks such as internal hard disks and removable disks; magneto-optical disks; and CD-ROM and DVD-ROM disks. The instructions embodied by a machine-readable medium may further be transmitted or received over a communications network using a transmission medium via a network interface device utilizing any one of a number of transfer protocols (e.g., HTTP).

A machine-readable medium may be provided by a storage device or other apparatus which is capable of hosting data in a non-transitory format. In an example, information stored or otherwise provided on a machine-readable medium may be representative of instructions, such as instructions themselves or a format from which the instructions may be derived. This format from which the instructions may be derived may include source code, encoded instructions (e.g., in compressed or encrypted form), packaged instructions (e.g., split into multiple packages), or the like. The information representative of the instructions in the machine-readable medium may be processed by processing circuitry into the instructions to implement any of the operations discussed herein. For example, deriving the instructions from the information (e.g., processing by the processing circuitry) may include: compiling (e.g., from source code, object code, etc.), interpreting, loading, organizing (e.g., dynamically or statically linking), encoding, decoding, encrypting, unencrypting, packaging, unpackaging, or otherwise manipulating the information into the instructions.

In an example, the derivation of the instructions may include assembly, compilation, or interpretation of the information (e.g., by the processing circuitry) to create the instructions from some intermediate or preprocessed format provided by the machine-readable medium. The information, when provided in multiple parts, may be combined, unpacked, and modified to create the instructions. For example, the information may be in multiple compressed source code packages (or object code, or binary executable code, etc.) on one or several remote servers. The source code packages may be encrypted when in transit over a network and decrypted, uncompressed, assembled (e.g., linked) if necessary, and compiled or interpreted (e.g., into a library, stand-alone executable, etc.) at a local machine, and executed by the local machine.

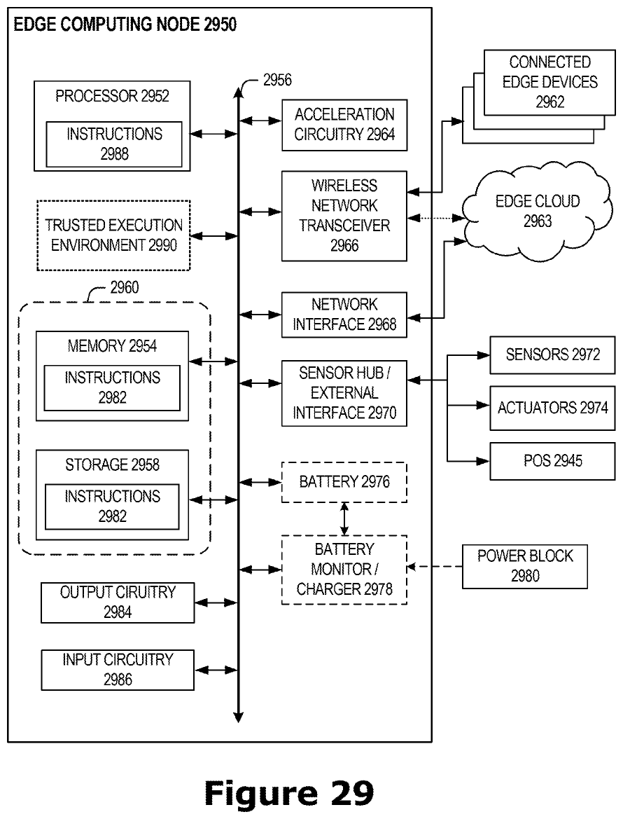

FIG. 30 depicts communication components within an example mobile device 2832. This mobile device 2832 provides a closer view of the communication processing components of node 2800 or device 2850 when implemented as a user equipment or a component of a user equipment. The mobile device 2832 may include radio front-end module (FEM) circuitry 2834, radio IC circuitry 2836 and baseband processing circuitry 2838. The mobile device 2832 as shown includes both Wireless Local Area Network (WLAN) functionality and Bluetooth (BT) functionality although aspects of the device are not so limited, and other radio technologies discussed herein may be implemented by similar circuitry. FEM circuitry 2834 may include, for example, a WLAN or Wi-Fi FEM circuitry 2834A and a Bluetooth (BT) FEM circuitry 2834B. The WLAN FEM circuitry 2834A may include a receive signal path comprising circuitry configured to operate on WLAN RF signals received from one or more antennas 2831A, to amplify the received signals and to provide the amplified versions of the received signals to the WLAN radio IC circuitry 2836A for further processing. The BT FEM circuitry 2834B may include a receive signal path which may include circuitry configured to operate on BT RF signals received from one or more antennas 2831B, to amplify the received signals and to provide the amplified versions of the received signals to the BT radio IC circuitry 2836B for further processing. FEM circuitry 2834A may also include a transmit signal path which may include circuitry configured to amplify WLAN signals provided by the radio IC circuitry 2836A for wireless transmission by one or more of the antennas 2831A. In addition, FEM circuitry 2834B may also include a transmit signal path which may include circuitry configured to amplify BT signals provided by the radio IC circuitry 2836B for wireless transmission by the one or more antennas 2831B. In the example of FIG. 30, although FEM 2834A and FEM 2834B are shown as being distinct from one another, aspects of the present disclosure are not so limited, and include within their scope the use of an FEM (not shown) that includes a transmit path and/or a receive path for both WLAN and BT signals, or the use of one or more FEM circuitries where at least some of the FEM circuitries share transmit and/or receive signal paths for both WLAN and BT signals.

Radio IC circuitry 2836 as shown may include WLAN radio IC circuitry 2836A and BT radio IC circuitry 2836B. The WLAN radio IC circuitry 2836A may include a receive signal path which may include circuitry to down-convert WLAN RF signals received from the FEM circuitry 2834A and provide baseband signals to WLAN baseband processing circuitry 2838A. BT radio IC circuitry 2836B may in turn include a receive signal path which may include circuitry to down-convert BT RF signals received from the FEM circuitry 2834B and provide baseband signals to BT baseband processing circuitry 2838B. WLAN radio IC circuitry 2836A may also include a transmit signal path which may include circuitry to up-convert WLAN baseband signals provided by the WLAN baseband processing circuitry 2838A and provide WLAN RF output signals to the FEM circuitry 2834A for subsequent wireless transmission by the one or more antennas 2831A. BT radio IC circuitry 2836B may also include a transmit signal path which may include circuitry to up-convert BT baseband signals provided by the BT baseband processing circuitry 2838B and provide BT RF output signals to the FEM circuitry 2834B for subsequent wireless transmission by the one or more antennas 2831B. In the example of FIG. 30, although radio IC circuitries 2836A and 2836B are shown as being distinct from one another, aspects of the present disclosure are not so limited, and include within their scope the use of a radio IC circuitry (not shown) that includes a transmit signal path and/or a receive signal path for both WLAN and BT signals, or the use of one or more radio IC circuitries where at least some of the radio IC circuitries share transmit and/or receive signal paths for both WLAN and BT signals.

Baseband processing circuitry 2838 may include a WLAN baseband processing circuitry 2838A and a BT baseband processing circuitry 2838B. The WLAN baseband processing circuitry 2838A may include a memory, such as, for example, a set of RAM arrays in a Fast Fourier Transform or Inverse Fast Fourier Transform block (not shown) of the WLAN baseband processing circuitry 2838A. Each of the WLAN baseband circuitry 2838A and the BT baseband circuitry 2838B may further include one or more processors and control logic to process the signals received from the corresponding WLAN or BT receive signal path of the radio IC circuitry 2836, and to also generate corresponding WLAN or BT baseband signals for the transmit signal path of the radio IC circuitry 2836. Each of the baseband processing circuitries 2838A and 2838B may further include physical layer (PHY) and medium access control layer (MAC) circuitry, and may further interface with application processor 2851 (or, in other examples, processor circuitry 2850) for generation and processing of the baseband signals and for controlling operations of the radio IC circuitry 2836.

Referring still to FIG. 30, according to the illustrated aspects, WLAN-BT coexistence circuitry 2843 may include logic providing an interface between the WLAN baseband circuitry 2838A and the BT baseband circuitry 2838B to enable use cases requiring WLAN and BT coexistence. In addition, a switch 2833 may be provided between the WLAN FEM circuitry 2834A and the BT FEM circuitry 2834B to allow switching between the WLAN and BT radios according to application needs. In addition, although the antennas 2831A, 2831B are depicted as being respectively connected to the WLAN FEM circuitry 2834A and the BT FEM circuitry 2834B, aspects of the present disclosure include within their scope the sharing of one or more antennas as between the WLAN and BT FEMs, or the provision of more than one antenna connected to each of FEM 2834A or 2834B.

In some aspects of the present disclosure, the front-end module circuitry 2834, the radio IC circuitry 2836, and baseband processing circuitry 2838 may be provided on a single radio card. In other aspects, the one or more antennas 2831A, 2831B, the FEM circuitry 2834 and the radio IC circuitry 2836 may be provided on a single radio card. In some other aspects of the present disclosure, the radio IC circuitry 2836 and the baseband processing circuitry 2838 may be provided on a single chip or integrated circuit (IC).

FIG. 31 illustrates Rack Scale Design (RSD) components that may be included a part of a server or other discrete compute node in an edge platform architecture. This arrangement provides a closer view of the configurable processing components of node 2800 or device 2950 when implemented as a server (e.g., in a server rack, blade, etc.). This configurable architecture differs from some others by disaggregating field programmable gate array (FPGA), non-volatile memory express (NVMe), and input-output (I/O) pooling resources. The FPGA and NVMe resources provide elements that may be used for any type of edge services, such as video or speech analytics. I/O pooling may be used to provide flexible NFs. This architecture enables scaling network interfaces according to the expected data rate or network load for a particular VNF. This architecture also enables flexibility to map different network cards to compute nodes depending on the type of network processing happening at a given node.

The illustrated RSD architecture includes a point of delivery (POD) Manager 3142. The POD Manager 3142 is responsible of managing the resources-including compute and disaggregated resources-within a POD (e.g., one or more racks). The POD Manager 3142 exposes interfaces to an orchestrator in order to create, manage, or destroy composed nodes. Managing a composed node includes the feature of scaling up or down the amount of pooled resources 3148 connected to a particular compute sled 3140. The POD Manager 3142 typically runs on a node controller. The POD Manager 3142 is responsible for discovery of resources in the POD, configuring and managing the resources, and composing a logical server. In an example, the POD Manager 3142 is an optional separate component and will not be required in-rack. However, in an example, to be “RSD conformant” a Rack is manageable by a certified POD Manager.

The following are some example attributes of a POD Manager 3142. For example, a rack may include a set of compute sleds 3140 used to execute edge services and other related system software stacks (e.g., such as orchestration or other system services). One type of compute sled 3140 may be a Pooled Resources Sled. This compute sled 3140 may manage a set of disaggregated resources. Here, a compute sled 2840 may include a pooled System Management Engine software (PSME) 3141. The PSME 3141 provides a management interface to manage the modules or blades at a drawer level. In an example, a rack contains one or more logical PSME(s). For example, each drawer may have a PSME or server drawers may share a PSME, or a PSME may run on a top-of-rack (TOR) 3144 switch or on a separate host. In an example, the PSME 3141 supports the RSD APIs.

In an example, the compute sled 3140 may include processors (e.g., CLX) to run an RSD software stack implementing NVM-oF or FPGA-oF acting as a target system and managing a set of disaggregated resources. In an example, the processors are connected using PCIe x16 bifurcation port to a PCIe switch 3146 providing access to the target resources (FPGA or NVME in the RSD 3148).

Various RSD edge-composed node flavors may be used in the compute sled 3140 to run edge services. Services running on those nodes may use client software libraries or drivers to provide transparent access to the disaggregated FPGAS and NVME in the RSD 3148. In a further example, the rack includes one or more PCIe switches connecting the compute sleds 3140 to a set of disaggregated resources (e.g., RSD 3148).

The illustrations of FIGS. 28, 29, 30, and 31 are intended to depict a high-level view of components of a varying device, subsystem, or arrangement of an edge computing node. However, it will be understood that some of the components shown may be omitted, additional components may be present, and a different arrangement of the components shown may occur in other implementations. Further, these arrangements are usable in a variety of use cases and environments, including those discussed below (e.g., a mobile UE in industrial compute for smart city or smart factory, among many other examples).

The respective compute platforms of FIGS. 28, 29, 30, and 31 may support multiple edge instances (e.g., edge clusters) by use of tenant containers running on a single compute platform. Likewise, multiple edge nodes may exist as subnodes running on tenants within the same compute platform. Accordingly, based on available resource partitioning, a single system or compute platform may be partitioned or divided into supporting multiple tenants and edge node instances, each of which may support multiple services and functions-even while being potentially operated or controlled in multiple compute platform instances by multiple owners. These various types of partitions may support complex multi-tenancy and many combinations of multi-stakeholders through the use of an LSM or other implementation of an isolation/security policy. References to the use of an LSM and security features which enhance or implement such security features are thus noted in the following sections. Likewise, services and functions operating on these various types of multi-entity partitions may be load-balanced, migrated, and orchestrated to accomplish necessary service objectives and operations.

### 5. Example Implementations

Additional examples of the presently described method, system, and device embodiments include the following, non-limiting implementations. Each of the following non-limiting examples may stand on its own or may be combined in any permutation or combination with any one or more of the other examples provided below or throughout the present disclosure.

Example 1 includes a method of obtaining network-related information for network congestion control identification and for offloading application tasks, the method comprising: receiving, at a client-side application, “app”, operated by a mobile device, network-related information from Multi-access Edge Computing, “MEC”, app operated by a MEC server; and adapting, by the client app, one or more network parameters based on the acquired network-related information; or offloading, by the client app, one or more app tasks to the MEC server based on the network-related information.

Example 2 includes the method of example 1 and/or some other example(s) herein, wherein a transport protocol is used to transport traffic between the client app and the MEC app, the client app is a Transport Protocol Runtime, “TPR”, entity, the network-related information includes capacity and connection related information, the one or more network parameters are transport protocol parameters, and the adapting comprises: adapting the transport protocol parameters based on the capacity and connection related information.

Example 3 includes the method of example 2 and/or some other example(s) herein, wherein the MEC app comprises another TPR entity arranged to interact with the TPR entity and a server app included in the MEC app or included in another MEC app operated by the MEC server.

Example 4 includes the method of examples 2-3 and/or some other example(s) herein, further comprising: detecting, by the TPR, a trigger event; transmitting a request message to a Radio Network Information, “RNI”, service provided by the MEC server via an RNI Application Programming Interface, “API”, and the receiving comprises receiving the capacity and connection related information from the RNI service via the RNI API.

Example 5 includes the method of example 4 and/or some other example(s) herein, further comprising: transmitting a request message to a Location Service provided by the MEC server via a Location API, and receiving location information of the mobile device from the Location Service via the Location API.

Example 6 includes the method of examples 2-3 and/or some other example(s) herein, wherein, when the client app has subscribed to an RNI service provided by the MEC server, the receiving comprises: receiving the capacity and connection related information from the RNI service via an RNI API when the MEC app detects a trigger event.

Example 7 includes the method of examples 4-6 and/or some other example(s) herein, further comprising: classifying, by the TPR, the trigger event as a congestion event or a non-congestion event based on the capacity and connection related information.

Example 8 includes the method of example 7 and/or some other example(s) herein, wherein, when the trigger event is classified as a congestion event, the adapting comprises one or both of: reducing, by the TPR, a congestion window (CW); or implementing a congestion control algorithm.

Example 9 includes the method of examples 7-8 and/or some other example(s) herein, wherein, when the trigger event is classified as a non-congestion event, the adapting comprises: halting transmission without reducing the CW.

Example 10 includes the method of examples 7-9 and/or some other example(s) herein, wherein the congestion event is a message timeout or receipt of a duplicated acknowledgement, and the non-congestion event is a signal strength measurement at or below a threshold or a channel quality measurement at or below another threshold.

Example 11 includes the method of examples 4-10 and/or some other example(s) herein, further comprising: selecting an interaction pattern based on performance requirements of the client app, wherein the interaction pattern is a request/response pattern or a publish/subscribe pattern.

Example 12 includes the method of example 11 and/or some other example(s) herein, wherein the performance requirements of the client app include service reliability requirements, end-to-end latency requirements, quality of service (QoS) requirements, subscription requirements or restrictions, user equipment (UE) type, and/or other metrics.

Example 13 includes the method of example 1 and/or some other example(s) herein, wherein the client app is an extended In-advance Quality of Service Notification, “e-IQN,” consumer, the network-related information includes e-IQN attributes, and the receiving comprises:

receiving an e-IQN response message from an e-IQN producer.

Example 14 includes the method of example 13 and/or some other example(s) herein, further comprising: sending an e-IQN request to the e-IQN producer including a planned route, the planned route comprising one or more waypoints along the planned route and corresponding expected arrival times for each waypoint of the one or more waypoints, wherein the e-IQN response is based on the e-IQN request.

Example 15 includes the method of examples 13-14 and/or some other example(s) herein, wherein the e-IQN attributes include predicted radio conditions for each waypoint at the corresponding expected arrival times.

Example 16 includes the method of example 15 and/or some other example(s) herein, wherein the e-IQN attributes further include predicted computing resources of edge compute nodes serving each waypoint at the corresponding expected arrival times.

Example 17 includes a method for providing In-advance Quality of Service Notification, “e-IQN,” notifications, the method comprising: receiving, by an e-IQN producer, a first e-IQN request from an e-IQN consumer, the first e-IQN request including one or more waypoints along a planned route and corresponding expected arrival times for each waypoint of the one or more waypoints; sending a second e-IQN request to a Predictive Function (PF) including the one or more waypoints and the corresponding expected arrival times; receiving e-IQN attributes from the PF, the e-IQN attributes including predicted parameters for each waypoint at the corresponding expected arrival times; and sending an e-IQN response to the e-IQN consumer including the e-IQN attributes.

Example 18 includes the method of example 17 and/or some other example(s) herein, wherein the PF is a Radio Access Network, “RAN”, PF, and the predicted parameters are predicted radio conditions for each waypoint at the corresponding expected arrival times.

Example 19 includes the method of example 17 and/or some other example(s) herein, wherein the PF is a cloud PF, and the predicted parameters are predicted edge computing resources for one or more edge compute node deployment areas at or near each waypoint at the corresponding expected arrival times.

Example 20 includes the method of example 17 and/or some other example(s) herein, wherein the PF is a RAN PF, the e-IQN attributes are first e-IQN attributes, the predicted parameters are first predicted parameters, and the method further comprises: sending a third e-IQN request to a cloud PF including the one or more waypoints and the corresponding expected arrival times; and receiving second e-IQN attributes from the cloud PF, the second e-IQN attributes including second predicted parameters for each waypoint at the corresponding expected arrival times.

Example 21 includes the method of example 20 and/or some other example(s) herein, wherein the first predicted parameters are predicted radio conditions for each waypoint at the corresponding expected arrival times, and the second predicted parameters are predicted edge computing resources for each waypoint at the corresponding expected arrival times, and the method further comprises: generating the e-IQN response by concatenating the first and second predicted parameters.

Example 22 includes the method of examples 18-21, wherein the e-IQN consumer is a first e-IQN consumer, the e-IQN request is a first e-IQN request, and the method further comprises: receiving a second e-IQN request from a second e-IQN consumer including edge service deployment geolocations and times of interest; and sending another second e-IQN request to cloud PF.

Example 23 includes the method of examples 17-22, wherein the first e-IQN request comprises a routes data element, the routes data element includes a route information (routeInfo) data element for each waypoint, and the routeInfo data element for each waypoint comprises a location data element including location information for a corresponding waypoint and a time data element including a timestamp for an expected arrival time.

Example 24 includes the method of example 23, wherein the e-IQN response comprises another routes data element, the other routes data element comprises another routeInfo data element for each waypoint, and the other routeInfo data element for each waypoint comprises a location data element includes a reference signal received power (rsrp) data element including a predicted rsrp value for the corresponding waypoint, and a reference signal received quality (rsrq) data element including a predicted rsrq value for the corresponding waypoint.

Example 25 includes the method of example 24, wherein the other routeInfo data element for each waypoint further comprises one or more of: an available processor power data element including an available processing power of an edge compute node closest to the corresponding waypoint; an available memory data element including an amount of available memory resources of the edge compute node closest to the corresponding waypoint; and an available storage data element including an amount of available storage resources of the edge compute node closest to the corresponding waypoint.

Example 26 includes one or more computer readable media comprising instructions, wherein execution of the instructions by processor circuitry is to cause the processor circuitry to perform the method of examples 1-16 and/or examples 17-25. Example 27 includes a computer program comprising the instructions of example 26. Example 28 includes an Application Programming Interface defining functions, methods, variables, data structures, and/or protocols for the computer program of example 27. Example 29 includes an apparatus comprising circuitry loaded with the instructions of example 26. Example 30 includes an apparatus comprising circuitry operable to run the instructions of example 26. Example 31 includes an integrated circuit comprising one or more of the processor circuitry of example 26 and the one or more computer readable media of example 26. Example 32 includes a computing system comprising the one or more computer readable media and the processor circuitry of example 26. Example 33 includes an apparatus comprising means for executing the instructions of example 26. Example 34 includes a signal generated as a result of executing the instructions of example 26. Example 35 includes a data unit generated as a result of executing the instructions of example 26. Example 36 includes the data unit of example 35, wherein the data unit is a datagram, network packet, data frame, data segment, a protocol data unit (PDU), a service data unit (SDU), a message, or a database object. Example 37 includes a signal encoded with the data unit of example 35 or 36. Example 38 includes an electromagnetic signal carrying the instructions of example 26. Example 39 includes an apparatus comprising means for performing the method of examples 1-16 and/or examples 17-25.

Example Z01 includes an apparatus comprising means to perform one or more elements of a method described in or related to any of examples 1-39, or any other method or process described herein. Example Z02 includes one or more non-transitory computer-readable media comprising instructions, wherein execution of the instructions by an electronic device is operable to cause the electronic device to perform one or more elements of a method described in or related to any of examples 1-39, and/or any other method or process described herein. Example Z03 includes a computer program comprising instructions, wherein execution of the program by a processing element is operable to cause the processing element to carry out the method, techniques, or process as described in or related to any of examples 1-39, and/or portions thereof. Example Z04 includes an apparatus comprising logic, modules, or circuitry to perform one or more elements of a method described in or related to any of examples 1-39, and/or any other method or process described herein. Example Z05 includes an apparatus configured to perform one or more elements of a method described in or related to any of examples 1-39, and/or any other method or process described herein. Example Z06 includes a method, technique, or process as described in or related to any of examples 1-39, and/or portions or parts thereof. Example Z07 includes an apparatus comprising: processor circuitry and computer-readable media comprising instructions, wherein the one or more processors are configurable to perform the method, techniques, or process as described in or related to any of examples 1-39, and/or portions thereof. Example Z08 includes a signal as described in or related to any of examples 1-39, and/or portions or parts thereof. Example Z09 includes a datagram, packet, frame, segment, protocol data unit (PDU), or message as described in or related to any of examples 1-39, or portions or parts thereof, and/or otherwise described in the present disclosure. Example Z10 includes a signal encoded with a datagram, packet, frame, segment, PDU, or message as described in or related to any of examples 1-39, or portions or parts thereof, or otherwise described in the present disclosure. Example Z11 includes a signal encoded with data as described in or related to any of examples 1-39, or portions or parts thereof, or otherwise described in the present disclosure. Example Z12 includes an electromagnetic signal carrying computer-readable instructions, wherein execution of the computer-readable instructions by one or more processors is operable or configurable to cause the one or more processors to perform a method, technique, or process as described in or related to any of examples 1-39, or portions thereof. Example Z13 includes an API or specification defining functions, methods, variables, data structures, protocols, etc., defining or involving use of any of examples 1-39 or portions thereof, or otherwise related to any of examples 1-39 or portions thereof. Example Z14, includes a Multi-access Edge Computing (MEC) host executing a service as part of one or more MEC applications instantiated on a virtualization infrastructure, the service being related to any of examples 1-39 or portions thereof, and wherein the MEC host is configured to operate according to a standard from one or more ETSI MEC standards families. Example Z15 includes a signal in a wireless network as shown and described herein. Example Z16 includes a method of communicating in a wireless network as shown and described herein. Example Z17 includes a system for providing wireless communication as shown and described herein. Example Z18 includes a device for providing wireless communication as shown and described herein.

An example implementation is an edge computing system, including respective edge processing devices and nodes to invoke or perform the operations of examples 1-39, or other subject matter described herein. Another example implementation is a client endpoint node, operable to invoke or perform the operations of examples 1-39, or other subject matter described herein. Another example implementation is an aggregation node, network hub node, gateway node, or core data processing node, within or coupled to an edge computing system, operable to invoke or perform the operations of examples 1-39, or other subject matter described herein. Another example implementation is an access point, base station, road-side unit, street-side unit, or on-premise unit, within or coupled to an edge computing system, operable to invoke or perform the operations of examples 1-39, or other subject matter described herein. Another example implementation is an edge provisioning node, service orchestration node, application orchestration node, or multi-tenant management node, within or coupled to an edge computing system, operable to invoke or perform the operations of examples 1-39, or other subject matter described herein.

Another example implementation is an edge node operating an edge provisioning service, application or service orchestration service, virtual machine deployment, container deployment, function deployment, and compute management, within or coupled to an edge computing system, operable to invoke or perform the operations of examples 1-39, or other subject matter described herein. Another example implementation is an edge computing system operable as an edge mesh, as an edge mesh with side car loading, or with mesh-to-mesh communications, operable to invoke or perform the operations of examples 1-39, or other subject matter described herein. Another example implementation is an edge computing system including aspects of network functions, acceleration functions, acceleration hardware, storage hardware, or computation hardware resources, operable to invoke or perform the use cases discussed herein, with use of examples 1-39, or other subject matter described herein. Another example implementation is an edge computing system adapted for supporting client mobility, vehicle-to-vehicle (V2V), vehicle-to-everything (V2X), or vehicle-to-infrastructure (V2I) scenarios, and optionally operating according to ETSI MEC specifications, operable to invoke or perform the use cases discussed herein, with use of examples 1-39, or other subject matter described herein. Another example implementation is an edge computing system adapted for mobile wireless communications, including configurations according to an 3GPP 4G/LTE or 5G network capabilities, operable to invoke or perform the use cases discussed herein, with use of examples 1-39, or other subject matter described herein.

### 6. Terminology

As used herein, the singular forms “a,” “an” and “the” are intended to include plural forms as well, unless the context clearly indicates otherwise. It will be further understood that the terms “comprises” and/or “comprising,” when used in this specification, specific the presence of stated features, integers, steps, operations, elements, and/or components, but do not preclude the presence or addition of one or more other features, integers, steps, operation, elements, components, and/or groups thereof. The phrase “A and/or B” means (A), (B), or (A and B). For the purposes of the present disclosure, the phrase “A, B, and/or C” means (A), (B), (C), (A and B), (A and C), (B and C), or (A, B and C). The description may use the phrases “in an embodiment,” or “In some embodiments,” which may each refer to one or more of the same or different embodiments. Furthermore, the terms “comprising,” “including,” “having,” and the like, as used with respect to embodiments of the present disclosure, are synonymous.

The terms “coupled,” “communicatively coupled,” along with derivatives thereof are used herein. The term “coupled” may mean two or more elements are in direct physical or electrical contact with one another, may mean that two or more elements indirectly contact each other but still cooperate or interact with each other, and/or may mean that one or more other elements are coupled or connected between the elements that are said to be coupled with each other. The term “directly coupled” may mean that two or more elements are in direct contact with one another. The term “communicatively coupled” may mean that two or more elements may be in contact with one another by a means of communication including through a wire or other interconnect connection, through a wireless communication channel or ink, and/or the like.

The term “circuitry” refers to a circuit or system of multiple circuits configured to perform a particular function in an electronic device. The circuit or system of circuits may be part of, or include one or more hardware components, such as a logic circuit, a processor (shared, dedicated, or group) and/or memory (shared, dedicated, or group), an ASIC, a FPGA, programmable logic controller (PLC), SoC, SiP, multi-chip package (MCP), DSP, etc., that are configured to provide the described functionality. In addition, the term “circuitry” may also refer to a combination of one or more hardware elements with the program code used to carry out the functionality of that program code. Some types of circuitry may execute one or more software or firmware programs to provide at least some of the described functionality. Such a combination of hardware elements and program code may be referred to as a particular type of circuitry.

It should be understood that the functional units or capabilities described in this specification may have been referred to or labeled as components or modules, in order to more particularly emphasize their implementation independence. Such components may be embodied by any number of software or hardware forms. For example, a component or module may be implemented as a hardware circuit comprising custom very-large-scale integration (VLSI) circuits or gate arrays, off-the-shelf semiconductors such as logic chips, transistors, or other discrete components. A component or module may also be implemented in programmable hardware devices such as field programmable gate arrays, programmable array logic, programmable logic devices, or the like. Components or modules may also be implemented in software for execution by various types of processors. An identified component or module of executable code may, for instance, comprise one or more physical or logical blocks of computer instructions, which may, for instance, be organized as an object, procedure, or function. Nevertheless, the executables of an identified component or module need not be physically located together but may comprise disparate instructions stored in different locations which, when joined logically together, comprise the component or module and achieve the stated purpose for the component or module.

Indeed, a component or module of executable code may be a single instruction, or many instructions, and may even be distributed over several different code segments, among different programs, and across several memory devices or processing systems. In particular, some aspects of the described process (such as code rewriting and code analysis) may take place on a different processing system (e.g., in a computer in a data center) than that in which the code is deployed (e.g., in a computer embedded in a sensor or robot). Similarly, operational data may be identified and illustrated herein within components or modules and may be embodied in any suitable form and organized within any suitable type of data structure. The operational data may be collected as a single data set or may be distributed over different locations including over different storage devices, and may exist, at least partially, merely as electronic signals on a system or network. The components or modules may be passive or active, including agents operable to perform desired functions.

The term “processor circuitry” as used herein refers to, is part of, or includes circuitry capable of sequentially and automatically carrying out a sequence of arithmetic or logical operations, or recording, storing, and/or transferring digital data. The term “processor circuitry” may refer to one or more application processors, one or more baseband processors, a physical CPU, a single-core processor, a dual-core processor, a triple-core processor, a quad-core processor, and/or any other device capable of executing or otherwise operating computer-executable instructions, such as program code, software modules, and/or functional processes. The terms “application circuitry” and/or “baseband circuitry” may be considered synonymous to, and may be referred to as, “processor circuitry.”

The term “memory” and/or “memory circuitry” as used herein refers to one or more hardware devices for storing data, including RAM, MRAM, PRAM, DRAM, and/or SDRAM, core memory, ROM, magnetic disk storage mediums, optical storage mediums, flash memory devices or other machine readable mediums for storing data. The term “computer-readable medium” may include, but is not limited to, memory, portable or fixed storage devices, optical storage devices, and various other mediums capable of storing, containing or carrying instructions or data.

The term “interface circuitry” as used herein refers to, is part of, or includes circuitry that enables the exchange of information between two or more components or devices. The term “interface circuitry” may refer to one or more hardware interfaces, for example, buses, I/O interfaces, peripheral component interfaces, network interface cards, and/or the like.

The term “element” refers to a unit that is indivisible at a given level of abstraction and has a clearly defined boundary, wherein an element may be any type of entity including, for example, one or more devices, systems, controllers, network elements, modules, etc., or combinations thereof. The term “device” refers to a physical entity embedded inside, or attached to, another physical entity in its vicinity, with capabilities to convey digital information from or to that physical entity. The term “entity” refers to a distinct component of an architecture or device, or information transferred as a payload. The term “controller” refers to an element or entity that has the capability to affect a physical entity, such as by changing its state or causing the physical entity to move.

As used herein, the term “edge computing” encompasses many implementations of distributed computing that move processing activities and resources (e.g., compute, storage, acceleration resources) towards the “edge” of the network, in an effort to reduce latency and increase throughput for endpoint users (client devices, user equipment, etc.). Such edge computing implementations typically involve the offering of such activities and resources in cloud-like services, functions, applications, and subsystems, from one or multiple locations accessible via wireless networks. Thus, the references to an “edge” of a network, cluster, domain, system or computing arrangement used herein are groups or groupings of functional distributed compute elements and, therefore, generally unrelated to “edges” (links or connections) as used in graph theory. Specific arrangements of edge computing applications and services accessible via mobile wireless networks (e.g., cellular and WiFi data networks) may be referred to as “mobile edge computing” or “multi-access edge computing”, which may be referenced by the acronym “MEC”. The usage of “MEC” herein may also refer to a standardized implementation promulgated by the European Telecommunications Standards Institute (ETSI), referred to as “ETSI MEC”. Terminology that is used by the ETSI MEC specification is generally incorporated herein by reference, unless a conflicting definition or usage is provided herein.

As used herein, the term “compute node” or “compute device” refers to an identifiable entity implementing an aspect of edge computing operations, whether part of a larger system, distributed collection of systems, or a standalone apparatus. In some examples, a compute node may be referred to as a “edge node”, “edge device”, “edge system”, whether in operation as a client, server, or intermediate entity. Specific implementations of a compute node may be incorporated into a server, base station, gateway, road side unit, on premise unit, UE or end consuming device, or the like.

The term “computer system” as used herein refers to any type interconnected electronic devices, computer devices, or components thereof. Additionally, the term “computer system” and/or “system” may refer to various components of a computer that are communicatively coupled with one another. Furthermore, the term “computer system” and/or “system” may refer to multiple computer devices and/or multiple computing systems that are communicatively coupled with one another and configured to share computing and/or networking resources.

The term “architecture” as used herein refers to a computer architecture or a network architecture. A “network architecture” is a physical and logical design or arrangement of software and/or hardware elements in a network including communication protocols, interfaces, and media transmission. A “computer architecture” is a physical and logical design or arrangement of software and/or hardware elements in a computing system or platform including technology standards for interacts therebetween.

The term “appliance,” “computer appliance,” or the like, as used herein refers to a computer device or computer system with program code (e.g., software or firmware) that is specifically designed to provide a specific computing resource. A “virtual appliance” is a virtual machine image to be implemented by a hypervisor-equipped device that virtualizes or emulates a computer appliance or otherwise is dedicated to provide a specific computing resource.

The term “user equipment” or “UE” as used herein refers to a device with radio communication capabilities and may describe a remote user of network resources in a communications network. The term “user equipment” or “UE” may be considered synonymous to, and may be referred to as, client, mobile, mobile device, mobile terminal, user terminal, mobile unit, station, mobile station, mobile user, subscriber, user, remote station, access agent, user agent, receiver, radio equipment, reconfigurable radio equipment, reconfigurable mobile device, etc. Furthermore, the term “user equipment” or “UE” may include any type of wireless/wired device or any computing device including a wireless communications interface. The term “station” or “STA” refers to a logical entity that is a singly addressable instance of a medium access control (MAC) and physical layer (PHY) interface to the wireless medium (WM). The term “wireless medium” or WM” refers to the medium used to implement the transfer of protocol data units (PDUs) between peer physical layer (PHY) entities of a wireless local area network (LAN).

The term “network element” as used herein refers to physical or virtualized equipment and/or infrastructure used to provide wired or wireless communication network services. The term “network element” may be considered synonymous to and/or referred to as a networked computer, networking hardware, network equipment, network node, router, switch, hub, bridge, radio network controller, RAN device, RAN node, gateway, server, virtualized VNF, NFVI, and/or the like.

As used herein, the term “access point” or “AP” refers to an entity that contains one station (STA) and provides access to the distribution services, via the wireless medium (WM) for associated STAs. An AP comprises a STA and a distribution system access function (DSAF). As used herein, the term “base station” refers to a network element in a radio access network (RAN), such as a fourth-generation (4G) or fifth-generation (5G) mobile communications network which is responsible for the transmission and reception of radio signals in one or more cells to or from a user equipment (UE). A base station can have an integrated antenna or may be connected to an antenna array by feeder cables. A base station uses specialized digital signal processing and network function hardware. In some examples, the base station may be split into multiple functional blocks operating in software for flexibility, cost, and performance. In some examples, a base station can include an evolved node-B (eNB) or a next generation node-B (gNB). In some examples, the base station may operate or include compute hardware to operate as a compute node. However, in many of the scenarios discussed herein, a RAN base station may be substituted with an access point (e.g., wireless network access point) or other network access hardware.

As used herein, the term “central office” (or CO) indicates an aggregation point for telecommunications infrastructure within an accessible or defined geographical area, often where telecommunication service providers have traditionally located switching equipment for one or multiple types of access networks. The CO can be physically designed to house telecommunications infrastructure equipment or compute, data storage, and network resources. The CO need not, however, be a designated location by a telecommunications service provider. The CO may host any number of compute devices for edge applications and services, or even local implementations of cloud-like services.

The term “cloud computing” or “cloud” refers to a paradigm for enabling network access to a scalable and elastic pool of shareable computing resources with self-service provisioning and administration on-demand and without active management by users. Cloud computing provides cloud computing services (or cloud services), which are one or more capabilities offered via cloud computing that are invoked using a defined interface (e.g., an API or the like). The term “computing resource” or simply “resource” refers to any physical or virtual component, or usage of such components, of limited availability within a computer system or network. Examples of computing resources include usage/access to, for a period of time, servers, processor(s), storage equipment, memory devices, memory areas, networks, electrical power, input/output (peripheral) devices, mechanical devices, network connections (e.g., channels/links, ports, network sockets, etc.), operating systems, virtual machines (VMs), software/applications, computer files, and/or the like. A “hardware resource” may refer to compute, storage, and/or network resources provided by physical hardware element(s). A “virtualized resource” may refer to compute, storage, and/or network resources provided by virtualization infrastructure to an application, device, system, etc. The term “network resource” or “communication resource” may refer to resources that are accessible by computer devices/systems via a communications network. The term “system resources” may refer to any kind of shared entities to provide services, and may include computing and/or network resources. System resources may be considered as a set of coherent functions, network data objects or services, accessible through a server where such system resources reside on a single host or multiple hosts and are clearly identifiable.

The term “workload” refers to an amount of work performed by a computing system, device, entity, etc., during a period of time or at a particular instant of time. A workload may be represented as a benchmark, such as a response time, throughput (e.g., how much work is accomplished over a period of time), and/or the like. Additionally or alternatively, the workload may be represented as a memory workload (e.g., an amount of memory space needed for program execution to store temporary or permanent data and to perform intermediate computations), processor workload (e.g., a number of instructions being executed by a processor during a given period of time or at a particular time instant), an I/O workload (e.g., a number of inputs and outputs or system accesses during a given period of time or at a particular time instant), database workloads (e.g., a number of database queries during a period of time), a network-related workload (e.g., a number of network attachments, a number of mobility updates, a number of radio link failures, a number of handovers, an amount of data to be transferred over an air interface, etc.), and/or the like. Various algorithms may be used to determine a workload and/or workload characteristics, which may be based on any of the aforementioned workload types.

As used herein, the term “cloud service provider” (or CSP) indicates an organization which operates typically large-scale “cloud” resources comprised of centralized, regional, and edge data centers (e.g., as used in the context of the public cloud). In other examples, a CSP may also be referred to as a Cloud Service Operator (CSO). References to “cloud computing” generally refer to computing resources and services offered by a CSP or a CSO, at remote locations with at least some increased latency, distance, or constraints relative to edge computing.

As used herein, the term “data center” refers to a purpose-designed structure that is intended to house multiple high-performance compute and data storage nodes such that a large amount of compute, data storage and network resources are present at a single location. This often entails specialized rack and enclosure systems, suitable heating, cooling, ventilation, security, fire suppression, and power delivery systems. The term may also refer to a compute and data storage node in some contexts. A data center may vary in scale between a centralized or cloud data center (e.g., largest), regional data center, and edge data center (e.g., smallest).

As used herein, the term “access edge layer” indicates the sub-layer of infrastructure edge closest to the end user or device. For example, such layer may be fulfilled by an edge data center deployed at a cellular network site. The access edge layer functions as the front line of the infrastructure edge and may connect to an aggregation edge layer higher in the hierarchy.

As used herein, the term “aggregation edge layer” indicates the layer of infrastructure edge one hop away from the access edge layer. This layer can exist as either a medium-scale data center in a single location or may be formed from multiple interconnected micro data centers to form a hierarchical topology with the access edge to allow for greater collaboration, workload failover, and scalability than access edge alone.

As used herein, the term “network function virtualization” (or NFV) indicates the migration of NFs from embedded services inside proprietary hardware appliances to software-based virtualized NFs (or VNFs) running on standardized CPUs (e.g., within standard x86® and ARM® servers, such as those including Intel® Xeon™ or AMD® Epyc™ or Opteron™ processors) using industry standard virtualization and cloud computing technologies. In some aspects, NFV processing and data storage will occur at the edge data centers that are connected directly to the local cellular site, within the infrastructure edge.

As used herein, the term “virtualized NF” (or VNF) indicates a software-based NF operating on multi-function, multi-purpose compute resources (e.g., x86, ARM processing architecture) which are used by NFV in place of dedicated physical equipment. In some aspects, several VNFs will operate on an edge data center at the infrastructure edge.

As used herein, the term “edge compute node” refers to a real-world, logical, or virtualized implementation of a compute-capable element in the form of a device, gateway, bridge, system or subsystem, component, whether operating in a server, client, endpoint, or peer mode, and whether located at an “edge” of an network or at a connected location further within the network. References to a “node” used herein are generally interchangeable with a “device”, “component”, and “sub-system”; however, references to an “edge computing system” generally refer to a distributed architecture, organization, or collection of multiple nodes and devices, and which is organized to accomplish or offer some aspect of services or resources in an edge computing setting.

The term “Internet of Things” or “IoT” refers to a system of interrelated computing devices, mechanical and digital machines capable of transferring data with little or no human interaction, and may involve technologies such as real-time analytics, machine learning and/or AI, embedded systems, wireless sensor networks, control systems, automation (e.g., smarthome, smart building and/or smart city technologies), and the like. IoT devices are usually low-power devices without heavy compute or storage capabilities. “Edge IoT devices” may be any kind of IoT devices deployed at a network's edge.

As used herein, the term “cluster” refers to a set or grouping of entities as part of an edge computing system (or systems), in the form of physical entities (e.g., different computing systems, networks or network groups), logical entities (e.g., applications, functions, security constructs, containers), and the like. In some locations, a “cluster” is also referred to as a “group” or a “domain”. The membership of cluster may be modified or affected based on conditions or functions, including from dynamic or property-based membership, from network or system management scenarios, or from various example techniques discussed below which may add, modify, or remove an entity in a cluster. Clusters may also include or be associated with multiple layers, levels, or properties, including variations in security features and results based on such layers, levels, or properties.

As used herein, the term “radio technology” refers to technology for wireless transmission and/or reception of electromagnetic radiation for information transfer. The term “radio access technology” or “RAT” refers to the technology used for the underlying physical connection to a radio based communication network. The term “V2X” refers to vehicle to vehicle (V2V), vehicle to infrastructure (V2I), infrastructure to vehicle (I2V), vehicle to network (V2N), and/or network to vehicle (N2V) communications and associated radio access technologies (RATs).

As used herein, the term “communication protocol” (either wired or wireless) refers to a set of standardized rules or instructions implemented by a communication device and/or system to communicate with other devices and/or systems, including instructions for packetizing/depacketizing data, modulating/demodulating signals, implementation of protocols stacks, and/or the like. Examples of wireless communications protocols may be used in various embodiments include a Global System for Mobile Communications (GSM) radio communication technology, a General Packet Radio Service (GPRS) radio communication technology, an Enhanced Data Rates for GSM Evolution (EDGE) radio communication technology, and/or a Third Generation Partnership Project (3GPP) radio communication technology including, for example, 3GPP Fifth Generation (5G) or New Radio (NR), Universal Mobile Telecommunications System (UMTS), Freedom of Multimedia Access (FOMA), Long Term Evolution (LTE), LTE-Advanced (LTE Advanced), LTE Extra, LTE-A Pro, cdmaOne (2G), Code Division Multiple Access 2000 (CDMA 2000), Cellular Digital Packet Data (CDPD), Mobitex, Circuit Switched Data (CSD), High-Speed CSD (HSCSD), Universal Mobile Telecommunications System (UMTS), Wideband Code Division Multiple Access (W-CDM), High Speed Packet Access (HSPA), HSPA Plus (HSPA+), Time Division-Code Division Multiple Access (TD-CDMA), Time Division-Synchronous Code Division Multiple Access (TD-SCDMA), LTE LAA, MuLTEfire, UMTS Terrestrial Radio Access (UTRA), Evolved UTRA (E-UTRA), Evolution-Data Optimized or Evolution-Data Only (EV-DO), Advanced Mobile Phone System (AMPS), Digital AMPS (D-AMPS), Total Access Communication System/Extended Total Access Communication System (TACS/ETACS), Push-to-talk (PTT), Mobile Telephone System (MTS), Improved Mobile Telephone System (IMTS), Advanced Mobile Telephone System (AMTS), Cellular Digital Packet Data (CDPD), DataTAC, Integrated Digital Enhanced Network (iDEN), Personal Digital Cellular (PDC), Personal Handy-phone System (PHS), Wideband Integrated Digital Enhanced Network (WiDEN), iBurst, Unlicensed Mobile Access (UMA), also referred to as also referred to as 3GPP Generic Access Network, or GAN standard), Bluetooth®, Bluetooth Low Energy (BLE), IEEE 802.15.4 based protocols (e.g., IPv6 over Low power Wireless Personal Area Networks (6LoWPAN), WirelessHART, MiWi, Thread, 802.11a, etc.) WiFi-direct, ANT/ANT+, ZigBee, Z-Wave, 3GPP device-to-device (D2D) or Proximity Services (ProSe), Universal Plug and Play (UPnP), Low-Power Wide-Area-Network (LPWAN), Long Range Wide Area Network (LoRA) or LoRaWAN™ developed by Semtech and the LoRa Alliance, Sigfox, Wireless Gigabit Alliance (WiGig) standard, Worldwide Interoperability for Microwave Access (WiMAX), mmWave standards in general (e.g., wireless systems operating at 10-300 GHz and above such as WiGig, IEEE 802.11ad, IEEE 802.11ay, etc.), V2X communication technologies (including C-V2X), Dedicated Short Range Communications (DSRC) communication systems such as Intelligent-Transport-Systems (ITS) including the European ITS-G5, ITS-G5B, ITS-G5C, etc. In addition to the standards listed above, any number of satellite uplink technologies may be used for purposes of the present disclosure including, for example, radios compliant with standards issued by the International Telecommunication Union (ITU), or the ETSI, among others. The examples provided herein are thus understood as being applicable to various other communication technologies, both existing and not yet formulated.

The term “channel” as used herein refers to any transmission medium, either tangible or intangible, which is used to communicate data or a data stream. The term “channel” may be synonymous with and/or equivalent to “communications channel,” “data communications channel,” “transmission channel,” “data transmission channel,” “access channel,” “data access channel,” “link,” “data link,” “carrier,” “radiofrequency carrier,” and/or any other like term denoting a pathway or medium through which data is communicated. Additionally, the term “link” as used herein refers to a connection between two devices through a RAT for the purpose of transmitting and receiving information.

The term “Quality of Service” or “QoS’ refers to a description or measurement of the overall performance of a service (e.g., telephony and/or cellular service, network service, wireless communication/connectivity service, cloud computing service, etc.). In some cases, the QoS may be described or measured from the perspective of the users of that service, and as such, QoS may be the collective effect of service performance that determine the degree of satisfaction of a user of that service. In other cases, QoS refers to traffic prioritization and resource reservation control mechanisms rather than the achieved perception of service quality. In these cases, QoS is the ability to provide different priorities to different applications, users, or data flows, or to guarantee a certain level of performance to a data flow. In either case, QoS is characterized by the combined aspects of performance factors applicable to one or more services such as, for example, service operability performance, service accessibility performance; service retain ability performance; service reliability performance, service integrity performance, and other factors specific to each service. Several related aspects of the service may be considered when quantifying the QoS, including packet loss rates, bit rates, throughput, transmission delay, availability, reliability, jitter, signal strength and/or quality measurements, and/or other measurements such as those discussed herein.

The term “localized network” as used herein may refer to a local network that covers a limited number of connected vehicles in a certain area or region. The term “distributed computing” as used herein may refer to computation resources that are geographically distributed within the vicinity of one or more localized networks' terminations. The term “local data integration platform” as used herein may refer to a platform, device, system, network, or element(s) that integrate local data by utilizing a combination of localized network(s) and distributed computation.

The terms “instantiate,” “instantiation,” and the like as used herein refers to the creation of an instance. An “instance” also refers to a concrete occurrence of an object, which may occur, for example, during execution of program code. The term “information element” refers to a structural element containing one or more fields. The term “field” refers to individual contents of an information element, or a data element that contains content. The term “database object”, “data structure”, or the like may refer to any representation of information that is in the form of an object, attribute-value pair (AVP), key-value pair (KVP), tuple, etc., and may include variables, data structures, functions, methods, classes, database records, database fields, database entities, associations between data and/or database entities (also referred to as a “relation”), blocks and links between blocks in block chain implementations, and/or the like. The term “data element” or “DE” refers to a data type that contains one single data. The term “data frame” or “DF” refers to a data type that contains more than one data element in a predefined order.

As used herein, the term “reliability” refers to the ability of a computer-related component (e.g., software, hardware, or network element/entity) to consistently perform a desired function and/or operate according to a specification. Reliability in the context of network communications (e.g., “network reliability”) may refer to the ability of a network to carry out communication. Network reliability may also be (or be a measure of) the probability of delivering a specified amount of data from a source to a destination (or sink).

The term “application” may refer to a complete and deployable package, environment to achieve a certain function in an operational environment. The term “AI/ML application” or the like may be an application that contains some AI/ML models and application-level descriptions. The term “machine learning” or “ML” refers to the use of computer systems implementing algorithms and/or statistical models to perform specific task(s) without using explicit instructions, but instead relying on patterns and inferences. ML algorithms build or estimate mathematical model(s) (referred to as “ML models” or the like) based on sample data (referred to as “training data,” “model training information,” or the like) in order to make predictions or decisions without being explicitly programmed to perform such tasks. Generally, an ML algorithm is a computer program that learns from experience with respect to some task and some performance measure, and an ML model may be any object or data structure created after an ML algorithm is trained with one or more training datasets. After training, an ML model may be used to make predictions on new datasets. Although the term “ML algorithm” refers to different concepts than the term “ML model,” these terms as discussed herein may be used interchangeably for the purposes of the present disclosure.

The term “ego ITS-S” refers to an ITS-S that is under consideration, the term “ego vehicle” refers to a vehicle embedding an ITS-S being considered, and the term “neighbors” refers to other ITS-Ss different than the ego ITS-S and ego vehicle.

Although many of the previous examples are provided with use of specific cellular/mobile network terminology, including with the use of 4G/5G 3GPP network components (or expected terahertz-based 6G/6G+ technologies), it will be understood these examples may be applied to many other deployments of wide area and local wireless networks, as well as the integration of wired networks (including optical networks and associated fibers, transceivers, etc.). Furthermore, various standards (e.g., 3GPP, ETSI, etc.) may define various message formats, PDUs, containers, frames, etc., as comprising a sequence of optional or mandatory data elements (DEs), data frames (DFs), information elements (IEs), and/or the like. However, it should be understood that the requirements of any particular standard should not limit the embodiments discussed herein, and as such, any combination of containers, frames, DFs, DEs, IEs, values, actions, and/or features are possible in various embodiments, including any combination of containers, DFs, DEs, values, actions, and/or features that are strictly required to be followed in order to conform to such standards or any combination of containers, frames, DFs, DEs, IEs, values, actions, and/or features strongly recommended and/or used with or in the presence/absence of optional elements.

Although these implementations have been described with reference to specific exemplary aspects, it will be evident that various modifications and changes may be made to these aspects without departing from the broader scope of the present disclosure. Many of the arrangements and processes described herein can be used in combination or in parallel implementations to provide greater bandwidth/throughput and to support edge services selections that can be made available to the edge systems being serviced. Accordingly, the specification and drawings are to be regarded in an illustrative rather than a restrictive sense. The accompanying drawings that form a part hereof show, by way of illustration, and not of limitation, specific aspects in which the subject matter may be practiced. The aspects illustrated are described in sufficient detail to enable those skilled in the art to practice the teachings disclosed herein. Other aspects may be utilized and derived therefrom, such that structural and logical substitutions and changes may be made without departing from the scope of this disclosure. This Detailed Description, therefore, is not to be taken in a limiting sense, and the scope of various aspects is defined only by the appended claims, along with the full range of equivalents to which such claims are entitled.

Such aspects of the inventive subject matter may be referred to herein, individually and/or collectively, merely for convenience and without intending to voluntarily limit the scope of this application to any single aspect or inventive concept if more than one is in fact disclosed. Thus, although specific aspects have been illustrated and described herein, it should be appreciated that any arrangement calculated to achieve the same purpose may be substituted for the specific aspects shown. This disclosure is intended to cover any and all adaptations or variations of various aspects. Combinations of the above aspects and other aspects not specifically described herein will be apparent to those of skill in the art upon reviewing the above description.

1-39. (canceled)

40. A mobile device comprising:
memory circuitry to store program code of a client-side application (app) for network congestion control identification and for offloading application tasks; and
processor circuitry connected to the memory circuitry, the processor circuitry is to operate to the client-side app to:
receive network-related information from an edge app operated by an edge compute node, and one or both of:
adapt one or more network parameters based on the received network-related information, or
offload one or more app tasks to the edge compute node based on the network-related information.

41. The mobile device of claim 40, wherein a transport protocol is used to transport traffic between the client app and the edge app, the client app is a Transport Protocol Runtime (TPR) entity, the network-related information includes capacity and connection related information, the one or more network parameters are transport protocol parameters, and the processor circuitry is to operate to the client-side app to:
adapt the transport protocol parameters based on the capacity and connection related information.

42. The mobile device of claim 42, wherein the edge app includes another TPR entity arranged to interact with the TPR entity and a server app included in the edge app or included in another edge app operated by the edge compute node, and the processor circuitry is to operate to the client-side app to:
detect a trigger event;
send a request message to a Radio Network Information (RNI) service provided by the edge compute node via an RNI Application Programming Interface (API); and
receive the capacity and connection related information from the RNI service via the RNI API.

43. The mobile device of claim 43, wherein the processor circuitry is to operate to the client-side app to:
send another request message to a Location Service provided by the edge compute node via a Location API; and
receive location information of the mobile device from the Location Service via the Location API.

44. The mobile device of claim 41, wherein, when the client app has subscribed to an RNI service provided by the edge compute node, the processor circuitry is to operate to the client-side app to:
receive the capacity and connection related information from the RNI service via an RNI API when the edge app detects a trigger event.

45. The mobile device of claim 42, wherein the processor circuitry is to operate to the client-side app to:
classify the trigger event as a congestion event or a non-congestion event based on the capacity and connection related information.

46. The mobile device of claim 45, wherein the processor circuitry is to operate to the client-side app to:
when the trigger event is classified as a congestion event, adapt the one or more network parameters by reduction of a congestion window (CW) or implementation of a congestion control algorithm; and
when the trigger event is classified as a non-congestion event, the adapting includes adapt the one or more network parameters by halting transmission without reducing the CW.

47. The mobile device of claim 45, wherein the congestion event is a message timeout or receipt of a duplicated acknowledgement, and the non-congestion event is a signal strength measurement at or below a threshold or a channel quality measurement at or below another threshold.

48. The mobile device of claim 42, wherein the processor circuitry is to operate to the client-side app to:
select an interaction pattern based on performance requirements of the client app, wherein the interaction pattern is a request/response pattern or a publish/subscribe pattern.

49. The mobile device of claim 48, wherein the performance requirements of the client app include service reliability requirements, end-to-end latency requirements, quality of service (QoS) requirements, subscription requirements or restrictions, user equipment (UE) type, and/or other metrics.

50. The mobile device of claim 40, wherein the client app is an extended In-advance Quality of Service Notification (e-IQN) consumer, the network-related information includes e-IQN attributes, and the processor circuitry is to operate to the client-side app to:
receive an e-IQN response message from an e-IQN producer; and
send an e-IQN request to the e-IQN producer including a planned route, the planned route comprising one or more waypoints along the planned route and corresponding expected arrival times for each waypoint of the one or more waypoints, wherein the e-IQN response is based on the e-IQN request.

51. The mobile device of claim 50, wherein the e-IQN attributes include predicted radio conditions for each waypoint at the corresponding expected arrival times, and predicted computing resources of edge compute nodes serving each waypoint at the corresponding expected arrival times.

52. The mobile device of claim 40, wherein the edge app is a Multi-access Edge Computing (MEC) app and the edge compute node is a MEC server.

53. One or more non-transitory computer readable media (NTCRM) comprising instructions for operating an In-advance Quality of Service Notification (e-IQN) producer to provide e-IQN notifications, wherein execution of the instructions by one or more processors is to cause a compute node to:
receive a first e-IQN request from an e-IQN consumer, the first e-IQN request including one or more waypoints along a planned route and corresponding expected arrival times for each waypoint of the one or more waypoints;
send a second e-IQN request to a Predictive Function (PF) including the one or more waypoints and the corresponding expected arrival times;
receive e-IQN attributes from the PF, the e-IQN attributes including predicted parameters for each waypoint at the corresponding expected arrival times; and
send an e-IQN response to the e-IQN consumer including the e-IQN attributes.

54. The one or more NTCRM of claim 53, wherein the PF is a Radio Access Network (RAN) PF, and the predicted parameters are predicted radio conditions for each waypoint at the corresponding expected arrival times.

55. The one or more NTCRM of claim 54, wherein the e-IQN attributes are first e-IQN attributes, the predicted parameters are first predicted parameters, and execution of the instructions is to cause the compute node to:
send a third e-IQN request to a cloud PF including the one or more waypoints and the corresponding expected arrival times; and
receive second e-IQN attributes from the cloud PF, the second e-IQN attributes including second predicted parameters for each waypoint at the corresponding expected arrival times.

56. The one or more NTCRM of claim 55, wherein the first predicted parameters are predicted radio conditions for each waypoint at the corresponding expected arrival times, and the second predicted parameters are predicted edge computing resources for each waypoint at the corresponding expected arrival times, and execution of the instructions is to cause the compute node to:
generate the e-IQN response by concatenating the first and second predicted parameters.

57. The one or more NTCRM of claim 53, wherein the e-IQN consumer is a first e-IQN consumer, the e-IQN request is a first e-IQN request, and execution of the instructions is to cause the compute node to:
receive a second e-IQN request from a second e-IQN consumer including edge service deployment geolocations and times of interest; and
send another second e-IQN request to a cloud PF.

58. The one or more NTCRM of claim 53, wherein the PF is a cloud PF, and the predicted parameters are predicted edge computing resources for one or more edge compute node deployment areas at or near each waypoint at the corresponding expected arrival times.

59. The one or more NTCRM of claim 53, wherein:
the first e-IQN request includes a routes data element, the routes data element includes a route information (routeInfo) data element for each waypoint, and the routeInfo data element for each waypoint includes a location data element including location information for a corresponding waypoint and a time data element including a timestamp for an expected arrival time;
the e-IQN response includes another routes data element, the other routes data element includes another routeInfo data element for each waypoint, and the other routeInfo data element for each waypoint includes a reference signal received power (RSRP) data element including a predicted RSRP value for the corresponding waypoint and a reference signal received quality (RSRQ) data element including a predicted RSRQ value for the corresponding waypoint, and
the other routeInfo data element for each waypoint includes one or more of an available processor power data element including an available processing power of an edge compute node closest to the corresponding waypoint, an available memory data element including an amount of available memory resources of the edge compute node closest to the corresponding waypoint, and an available storage data element including an amount of available storage resources of the edge compute node closest to the corresponding waypoint.

60. The one or more NTCRM of claim 53, wherein the compute node is an edge compute node, the e-IQN producer is an edge application (app) operated by the edge compute node, and the e-IQN consumer is a client-side app operated by a mobile device.

61. A method for providing In-advance Quality of Service Notification (e-IQN) notifications, the method comprising:
sending, by an e-IQN consumer, a first e-IQN request to an e-IQN producer, the first e-IQN request including one or more waypoints along a planned route and corresponding expected arrival times for each waypoint of the one or more waypoints, wherein the first e-IQN request is to cause a second e-IQN request to be sent to a Predictive Function (PF) including the one or more waypoints and the corresponding expected arrival times; and
receiving, by the e-IQN consumer, an e-IQN response from the e-IQN producer, the e-IQN response including a set of e-IQN attributes, the set of e-IQN attributes being based on the second e-IQN request and the set of e-IQN attributes including predicted parameters for each waypoint at the corresponding expected arrival times.

62. The method of claim 61, wherein:
the PF is a Radio Access Network (RAN) PF and the predicted parameters are predicted radio conditions for each waypoint at the corresponding expected arrival times; or
the PF is a cloud PF and the predicted parameters are predicted edge computing resources for one or more edge compute node deployment areas at or near each waypoint at the corresponding expected arrival times.

63. The method of claim 61, wherein:
the first e-IQN request comprises a routes data element, the routes data element includes a route information (routeInfo) data element for each waypoint, and the routeInfo data element for each waypoint comprises a location data element including location information for a corresponding waypoint and a time data element including a timestamp for an expected arrival time;
the e-IQN response includes another routes data element, the other routes data element includes another routeInfo data element for each waypoint, and the other routeInfo data element for each waypoint includes a reference signal received power (RSRP) data element including a predicted RSRP value for the corresponding waypoint and a reference signal received quality (RSRQ) data element including a predicted RSRQ value for the corresponding waypoint, and
the other routeInfo data element for each waypoint includes one or more of an available processor power data element including an available processing power of an edge compute node closest to the corresponding waypoint, an available memory data element including an amount of available memory resources of the edge compute node closest to the corresponding waypoint, and an available storage data element including an amount of available storage resources of the edge compute node closest to the corresponding waypoint.

64. The method of claim 61, wherein the e-IQN consumer is a client-side application (app) operated by a mobile device, and the e-IQN producer is an edge app operated by an edge compute node.
